(19) United States
(12) Patent Application Publication
(10) Pub. No.: US 2024/0378127 A1
(43) Pub. Date: Nov. 14, 2024

(54) SYSTEMS AND METHODS FOR DATA MONITORING

(71) Applicant: VARONIS SYSTEMS, INC., New York, NY (US)

(72) Inventors: David BASS, Carmei Yoseph (IL); Yakov FAITELSON, New York, NY (US); Ophir KRETZER-KATZIR, Tenafly, NJ (US); Orr KADEC, Haworth, NJ (US)

(73) Assignee: VARONIS SYSTEMS, INC., New York, NY (US)

(21) Appl. No.: 18/690,396

(22) PCT Filed: Dec. 15, 2022
(86) PCT No.: PCT/IL2022/051333

§ 371 Date: Mar. 8, 2024

Related U.S. Application Data
(60) Provisional application No. 63/298,033, filed on Jan. 10, 2022.

(51) Int. Cl. G06F 11/30

(52) U.S. Cl. CPC G06F 11/3079; G06F 2221/2141

(57) ABSTRACT

A system for monitoring data elements, including a data element monitor (DEM), monitoring a multiplicity of data elements, some of which having associated therewith a data representation, each of the multiplicity of data elements including data element content and data element information, and each of the data representations including data representation information corresponding to at least a subset of the data element information, an event notification ascertainer (ENA), ascertaining which of the multiplicity of the data elements being monitored has an event notification associated therewith and a difference reporter, reporting a difference between the data representation information in a data representation associated with one of the multiplicity of data elements being monitored, which has an event notification associated therewith, and corresponding data element information of that one of the multiplicity of the data elements being monitored which has an event notification associated therewith.

### REFERENCE TO RELATED APPLICATIONS

Reference is hereby made to U.S. Provisional Patent Application Ser. No. 63/298,033, filed Jan. 10, 2022 and entitled SYSTEMS AND METHODS FOR DATA MONITORING, the disclosure of which is hereby incorporated by reference and priority of which is hereby claimed.

Reference is additionally made to the following U.S. patents and patent applications, owned by the assignee, the disclosures of which are hereby incorporated by reference:
U.S. Pat. Nos. 7,555,482; 7,606,801; 8,561,146; 8,239,925; 8,438,611; 8,438,612; 8,601,592; 8,578,507; 8,805,884; 8,533,787; 8,909,673; 9,147,180; 9,641,334; 9,680,839; 9,870,480; 11,030,307; and
U.S. Published Patent Application Nos. 2009/0265780 and 2011/0061093.

### FIELD OF THE INVENTION

The present invention relates to systems and methods for monitoring data elements generally.

### BACKGROUND OF THE INVENTION

Various types of systems and methods for monitoring data elements are known in the art.

### SUMMARY OF THE INVENTION

The present invention seeks to provide improved systems and methods for monitoring of data elements.

There is thus provided in accordance with a preferred embodiment of the present invention a system for monitoring data elements, including a data element monitor (DEM), monitoring a multiplicity of data elements, some of which having associated therewith a data representation, each of the multiplicity of data elements including data element content and data element information, and each of the data representations including data representation information corresponding to at least a subset of the data element information, an event notification ascertainer (ENA), ascertaining which of the multiplicity of the data elements being monitored has an event notification associated therewith, and a difference reporter, reporting a difference between the data representation information in a data representation associated with one of the multiplicity of data elements being monitored, which has an event notification associated therewith, and corresponding data element information of that one of the multiplicity of the data elements being monitored, which has an event notification associated therewith.

In accordance with a preferred embodiment of the present invention, the difference reporter is also operative for updating the data representation information associated with the one of the multiplicity of data elements being monitored, which has an event notification associated therewith, to reflect the difference.

In accordance with a preferred embodiment of the present invention, the system includes an output generator operative to present to at least one human user a visually sensible indication of the data representation information of the data representation associated with one of the multiplicity of data elements being monitored, which has an event notification associated therewith. The output generator preferably presents the data representation following an identification by the DEM and the ENA of those of the multiplicity of data elements that have recently undergone a change and accordingly an update by the difference reporter of the data representations, thereby portraying updated data representations including, but not limited to, changes made since the previous execution of the system's elements.

In accordance with a preferred embodiment of the present invention, the data representation information associated with one of the multiplicity of data elements being monitored, which has an event notification associated therewith, is associated with the one of the multiplicity of data elements prior to the event notification.

In accordance with a preferred embodiment of the present invention, the data representation information associated with one of the multiplicity of data elements being monitored, which has an event notification associated therewith, is associated with the one of the multiplicity of data elements subsequent to the event notification, and is generated based on at least one data representation associated with at least one analogous data element. The at least one analogous data element has at least some similarity to the one of the multiplicity of data elements being monitored, which has an event notification associated therewith. The similarity is preferably a similarity in data element content. Additionally, or alternatively, the similarity is a similarity in data element information.

In accordance with a preferred embodiment of the present invention, the system also includes a data representation information generator (DRIG) receiving at least one stored data representation of at least one data element other than that one of the multiplicity of the data elements being monitored, which has an event notification associated therewith, and providing pre-event data representation information to the difference reporter.

The multiplicity of data elements are preferably arranged in a hierarchical data structure. At least one data element other than that one of the multiplicity of the data elements being monitored, which has an event notification associated therewith, has either a parent relationship or a sibling relationship with the other data elements in the hierarchical data structure and the similarity between the data elements in the hierarchical data structure includes either the parent relationship or the sibling relationship.

In accordance with a preferred embodiment of the present invention, the data representation information associated with one of the multiplicity of data elements being monitored, which has an event notification associated therewith, is associated with the one of the multiplicity of data elements subsequent to the event notification, and is generated based on at least one analogous data representation associated with at least one of a multiplicity of data elements other than that one of the multiplicity of the data elements being monitored. The at least one analogous data representation preferably has at least some similarity to the one of the multiplicity of data elements being monitored, which has an event notification associated therewith. The similarity is preferably a similarity in data element information.

Preferably, the difference reporter includes a classification rule applicability determiner for ascertaining whether one or more classification rules are applicable to the content of the data element being monitored, which has an event notification associated therewith.

In accordance with a preferred embodiment of the present invention, the difference reporter includes a comparator, comparing the data representation information stored in the data representation associated with that one of the multiplicity of data elements being monitored, which has an event notification associated therewith, and post-event data element information of the one of the multiplicity of the data elements being monitored, which has an event notification associated therewith, and a comparison notifier, updating the data representation information associated with that one of the multiplicity of data elements being monitored, which has an event notification associated therewith, based on the comparing, to reflect the difference.

In accordance with a preferred embodiment of the present invention, the difference reporter includes a comparator, comparing the data representation information received from the DRIG and post-event data element information of the one of the multiplicity of the data elements being monitored, which has an event notification associated therewith, and a comparison notifier, updating the data representation information associated with that one of the multiplicity of data elements being monitored, which has an event notification associated therewith, based on the comparing, to reflect the difference.

Preferably, the event notification is a notification of an actual access to that one of said multiplicity of said data elements being monitored, which has an event notification associated therewith. Additionally, or alternatively, the event notification is a notification of a change in an access permission to that one of said multiplicity of said data elements being monitored, which has an event notification associated therewith, such as a change in at least one of a read permission, a write permission and a delete permission.

In accordance with a preferred embodiment of the present invention, the event notification is a notification of a change in the data element content of that one of the multiplicity of the data elements being monitored, which has an event notification associated therewith. Additionally, or alternatively, the event notification is a notification of a change in data element information of that one of the multiplicity of the data elements being monitored, which has an event notification associated therewith.

In accordance with a preferred embodiment of the present invention, the multiplicity of data elements includes at least one billion data elements and the DEM, the ENA and the difference reporter are operative to update the multiplicity of data elements in less than one minute.

Preferably, the system also includes a utilization subsystem, employing information contained in updated data representations.

There is also provided in accordance with another preferred embodiment of the present invention, a method for monitoring data elements including monitoring a multiplicity of data elements, some of which having associated therewith a data representation, each of the multiplicity of data elements including data element content and data element information and each of the data representations including data representation information corresponding to at least a subset of the data element information, ascertaining which of the multiplicity of the data elements being monitored has an event notification associated therewith and reporting a difference between the data representation information in a data representation associated with one of the multiplicity of data elements being monitored, which has an event notification associated therewith, and corresponding data element information of that one of the multiplicity of the data elements being monitored which has an event notification associated therewith.

In accordance with a preferred embodiment of the present invention, the method also includes updating the data representation information associated with the one of the multiplicity of data elements being monitored to reflect the difference.

In accordance with a preferred embodiment of the present invention, the method also includes generating output to present to at least one human user a visually sensible indication of the data representation information of the data representation associated with one of the multiplicity of data elements being monitored, which has an event notification associated therewith. The generated output preferably presents the data representation following an identification of those of the multiplicity of data elements that have recently undergone a change and accordingly an update by the difference reporter of the data representations, thereby portraying updated data representations including, but not limited to, changes made since the previous execution of the method.

In accordance with a preferred embodiment of the present invention, the method also includes associating the data representation information associated with one of the multiplicity of data elements being monitored, which has an event notification associated therewith, with the one of the multiplicity of data elements prior to the event notification.

Preferably, the method also includes generating the data representation information based on at least one data representation associated with at least one analogous data element and associating the data representation information, associated with one of the multiplicity of data elements being monitored, which has an event notification associated therewith, with the one of the multiplicity of data elements subsequent to the event notification. Additionally, the analogous data element has at least some similarity to the one of the multiplicity of data elements being monitored, which has an event notification associated therewith. The similarity is preferably a similarity in data element content. Additionally, or alternatively, the similarity is a similarity in data element information.

In accordance with a preferred embodiment of the present invention, the method also includes receiving at least one stored data representation of at least one data element other than that one of the multiplicity of the data elements being monitored, which has an event notification associated therewith, and providing pre-event data representation information to be compared with post-event data element information of that one of the multiplicity of the data elements being monitored, which has an event notification associated therewith.

The multiplicity of data elements are preferably arranged in a hierarchical data structure. At least one data element other than that one of the multiplicity of the data elements being monitored, which has an event notification associated therewith, has either a parent relationship or a sibling relationship with the other data elements in the hierarchical data structure and the similarity between the data elements in the hierarchical data structure includes either the parent relationship or the sibling relationship.

In accordance with a preferred embodiment of the present invention, the method also includes generating the data representation information based on at least one analogous data representation associated with at least one of a multiplicity of data elements other than that one of the multiplicity of the data elements being monitored, which has the event notification associated therewith, and associating the data representation information associated with one of the multiplicity of data elements being monitored, which has an event notification associated therewith, with the one of the multiplicity of data elements being monitored subsequent to the event notification. The at least one analogous data representation preferably has at least some similarity to the one of the multiplicity of data elements being monitored, which has an event notification associated therewith. The similarity is preferably a similarity in data element information.

In accordance with a preferred embodiment of the present invention, the method also includes ascertaining whether one or more classification rules are applicable to the content of the data element being monitored which has an event notification associated therewith.

Preferably, the method also includes comparing the data representation information stored in the data representation associated with that one of the multiplicity of data elements being monitored, which has an event notification associated therewith, and post-event data element information of the one of the multiplicity of the data elements being monitored which has an event notification associated therewith and updating the data representation information associated with that one of the multiplicity of data elements being monitored, which has an event notification associated therewith, based on the comparing, to reflect the difference.

In accordance with a preferred embodiment of the present invention, the method also includes comparing the at least one stored data representation and post-event data element information of the one of the multiplicity of the data elements being monitored, which has an event notification associated therewith, and updating the at least one data representation information associated with that one of the multiplicity of data elements being monitored, which has an event notification associated therewith, based on the comparing, to reflect the difference.

In accordance with a preferred embodiment of the present invention, the event notification is a notification of an actual access to that one of the multiplicity of the data elements being monitored, which has an event notification associated therewith . . . Additionally, or alternatively, the event notification is a notification of a change in an access permission to that one of said multiplicity of said data elements being monitored, which has an event notification associated therewith, such as a change in at least one of a read permission, a write permission and a delete permission.

In accordance with a preferred embodiment of the present invention, the event notification is a notification of a change in the data element content of that one of the multiplicity of the data elements being monitored, which has an event notification associated therewith. Additionally, or alternatively, the event notification is a notification of a change in data element information of that one of the multiplicity of the data elements being monitored, which has an event notification associated therewith.

In accordance with a preferred embodiment of the present invention, the method also includes determining whether a content classification rule is applicable to the data element content of the one of the multiplicity of data elements being monitored, which has an event notification associated therewith.

Preferably, the multiplicity of data elements includes at least one billion data elements and the method is operative to update the multiplicity of data elements in less than one minute.

In accordance with a preferred embodiment of the present invention, the method also includes employing information contained in updated data representations.

### BRIEF DESCRIPTION OF THE DRAWINGS

The present invention will be understood and appreciated more fully from the following detailed description, taken in conjunction with the drawings in which:

FIG. 1A is a simplified functional block diagram of a system for monitoring data elements constructed and operative in accordance with a preferred embodiment of the present invention;

FIG. 1B is a simplified functional block diagram of a portion of the system of FIG. 1A, showing particularly details of a database thereof;

FIG. 2A is a simplified functional block diagram of a system for monitoring data elements constructed and operative in accordance with another preferred embodiment of the present invention;

FIG. 2B is a simplified functional block diagram of a portion of the system of FIG. 2A, showing particularly details of a database thereof;

FIG. 3A is a simplified functional block diagram of a system for monitoring data elements constructed and operative in accordance with yet another preferred embodiment of the present invention whereby the difference reporter provides input to the DRIG;

FIG. 3B is a simplified functional block diagram of a portion of the system of FIG. 3A, showing particularly details of a database thereof;

FIG. 4A is a simplified functional block diagram of a system for monitoring data elements constructed and operative in accordance with still another preferred embodiment of the present invention;

FIG. 4B is a simplified functional block diagram of a portion of the system of FIG. 4A, showing particularly details of a database thereof;

FIG. 5A is a simplified functional block diagram of a system for monitoring data elements constructed and operative in accordance with yet another preferred embodiment of the present invention whereby the difference reporter provides input to the DRIG;

FIG. 5B is a simplified functional block diagram of a portion of the system of FIG. 5A, showing particularly details of a database thereof;

FIG. 6A is a simplified functional block diagram of a system for monitoring data elements constructed and operative in accordance with a further preferred embodiment of the present invention;

FIG. 6B is a simplified functional block diagram of a portion of the system of FIG. 6A, showing particularly details of a database thereof;

FIG. 7A is a simplified functional block diagram of a system for monitoring data elements constructed and operative in accordance with yet a further preferred embodiment of the present invention whereby the difference reporter provides input to the DRIG;

FIG. 7B is a simplified functional block diagram of a portion of the system of FIG. 7A, showing particularly details of a database thereof;

FIG. 8A is a simplified functional block diagram of a system for monitoring data elements constructed and operative in accordance with another preferred embodiment of the present invention;

FIG. 8B is a simplified functional block diagram of a portion of the system of FIG. 8A, showing particularly details of a database thereof;

FIG. 9A is a simplified functional block diagram of a system for monitoring data elements constructed and operative in accordance with yet another preferred embodiment of the present invention whereby the difference reporter provides input to the DRIG;

FIG. 9B is a simplified functional block diagram of a portion of the system of FIG. 9A, showing particularly details of a database thereof;

FIG. 10 is a simplified functional block diagram of a portion of the system of FIGS. 1A & 1B, showing particularly details of a difference reporter thereof;

FIG. 11 is a simplified functional block diagram of a portion of the system of FIGS. 2A-3B, showing particularly details of a difference reporter thereof;

FIG. 12 is a simplified functional block diagram of a portion of the system of FIGS. 4A-5B, showing particularly details of a difference reporter thereof;

FIG. 13 is a simplified functional block diagram of a portion of the system of FIGS. 6A-7B, showing particularly details of a difference reporter thereof;

FIG. 14 is a simplified functional block diagram of a portion of the system of FIGS. 8A-9B, showing particularly details of a difference reporter thereof;

FIG. 15A is a simplified flow chart illustrating operation of the system of FIGS. 1A, 1B & 10 in an exemplary use case;

FIG. 15B is a simplified flow chart showing a portion of the flow chart of FIG. 15A;

FIGS. 16A & 16B together are a simplified flow chart illustrating operation of the system of FIGS. 1A, 1B & 10 in another exemplary use case;

FIGS. 16C & 16D together are a simplified flow chart showing a portion of the flow chart of FIGS. 16A & 16B;

FIGS. 17A & 17B together are a simplified flow chart illustrating operation of the system of FIGS. 2A-3B & 11 in yet another exemplary use case;

FIGS. 17C & 17D together are a simplified flow chart showing a portion of the flow chart of FIGS. 17A & 17B.

FIGS. 18A & 18B together are a simplified flow chart illustrating operation of the system of FIGS. 4A-5B & 12 in still another exemplary use case; and

FIGS. 18C & 18D together are a simplified flow chart showing a portion of the flow chart of FIGS. 18A & 18B.

### DETAILED DESCRIPTION OF PREFERRED EMBODIMENTS

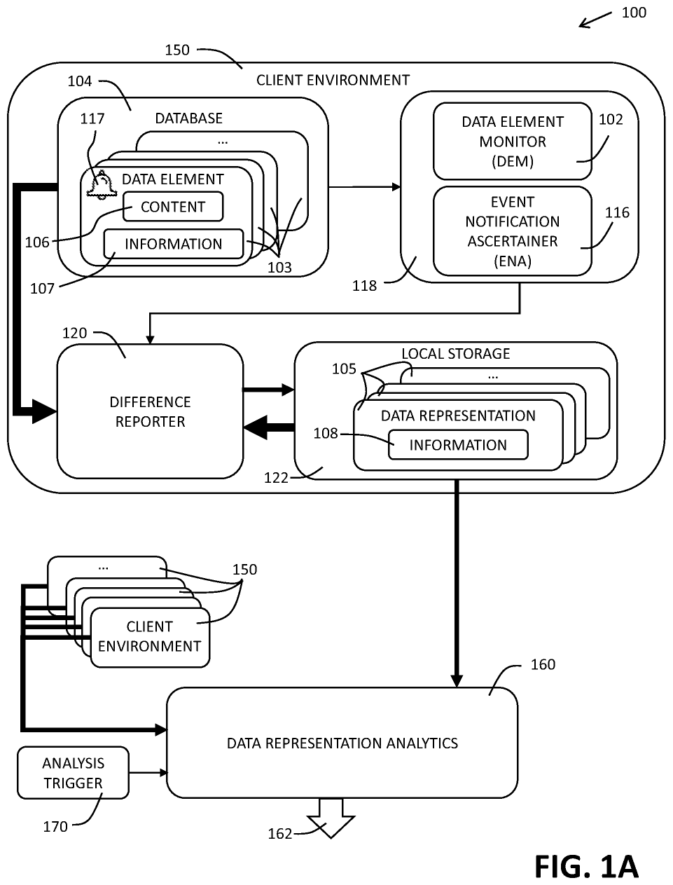

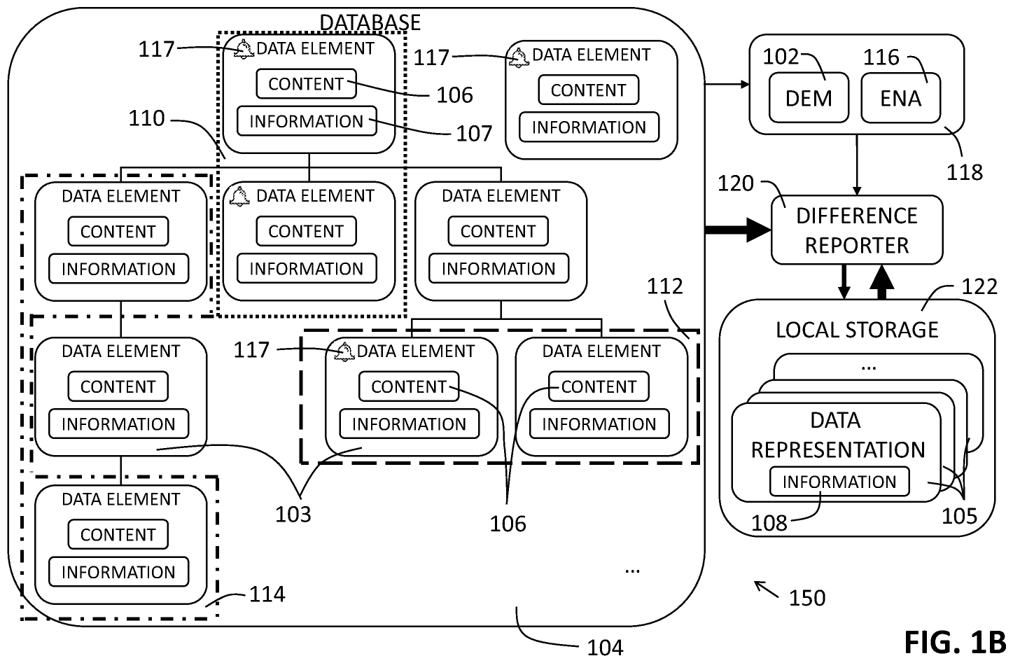

Reference is now made to FIG. 1A, which is a simplified functional block diagram of a system for monitoring data elements, constructed and operative in accordance with a preferred embodiment of the present invention, and to FIG. 1B, which is a simplified functional block diagram of a portion of the system of FIG. 1A, showing particularly details of a database thereof.

As seen in FIGS. 1A & 1B, there is provided a system 100 for monitoring data elements including a data element monitor (DEM) 102, monitoring a multiplicity of data elements 103, typically stored in a data element database 104. In a preferred embodiment of the present invention, in system 100, each of data elements 103 has associated therewith a corresponding stored data representation 105. Preferably each data element 103 includes data element content 106 and data element information 107, and each stored data representation 105 includes data representation information 108, corresponding to at least a subset of data element information 107.

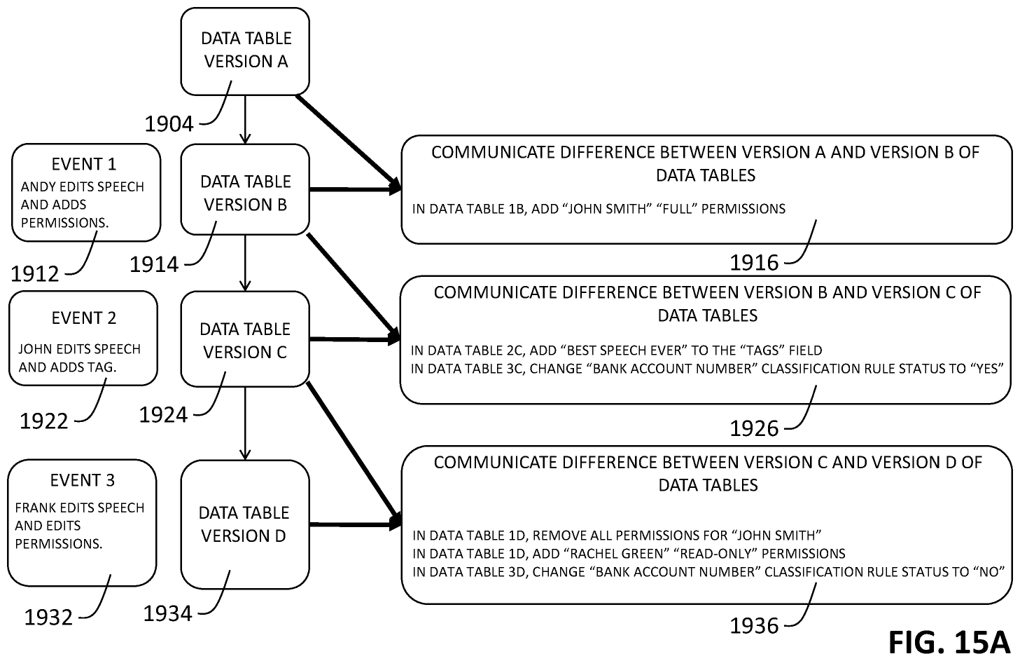

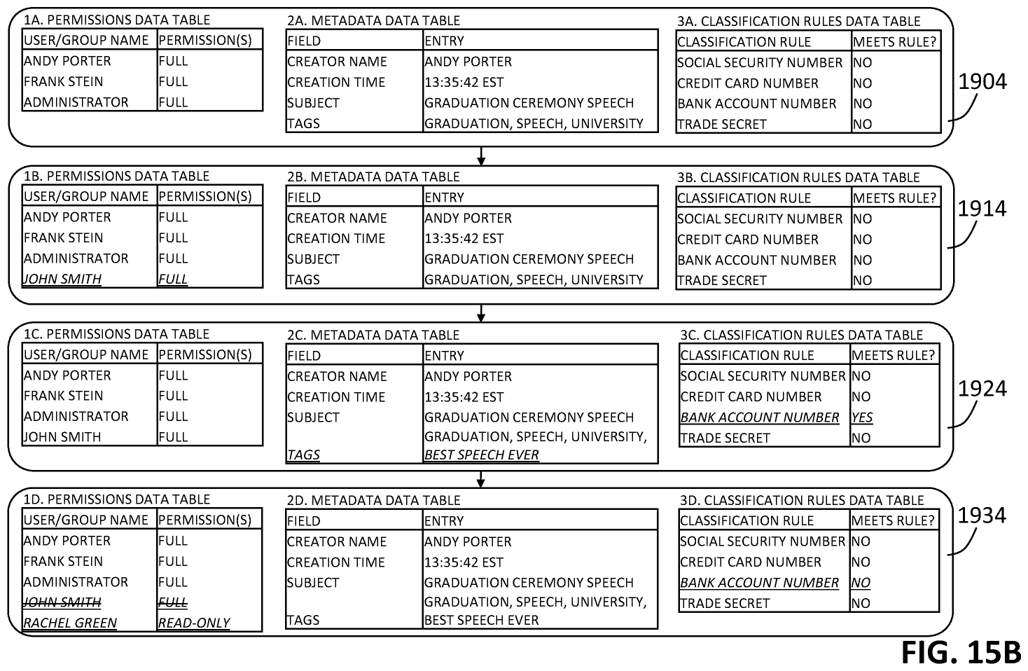

An example of a suitable DEM 102 is described in U.S. Pat. No. 11,030,307. Examples of data elements 103 are described hereinbelow with reference to FIGS. 15A-18D. Examples of a suitable data element database 104 include, inter alia, a

New Technology File System (NTFS), commercially available from Microsoft, a hierarchical database, such as an IBM IMS™, commercially available from IBM, an object-oriented database, such as a commercially available ObjectStore database from IgniteTech, and a document database, such as a database commercially available from MongoDB.

Data element content 106 is typically a raison d'être of data element 103. For example, a data element 103 that is embodied as a text file often includes data element content 106 in the form of text that is displayed when the data element 103 is opened. Similarly, a data element 103 that is embodied as a video file often includes data element content 106 in the form of video and audio media to be displayed when the data element 103 is opened. As an additional example, a data element 103 that is embodied as an image file often includes data element content 106 in the form of a picture that is displayed when the data element 103 is opened.

Data element information 107 and data representation information 108, on the other hand, are typically supporting data associated with data element 103. For example, a data element 103 that is embodied as a file typically includes data element information 107 such as file properties, and the data representation 105 associated with such a data element 103 preferably includes data representation information 108 that is identical to or a subset of the data element information 107 for that data element 103.

Data element information 107 and data representation information 108 may be any suitable information relating to data element 103 and data representation 105, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 103 are preferably editable. More specifically, preferably one or both of data element content 106 and data element information 107 can be changed, either manually, such as by a human user of database 104, or automatically, such as by an operational rule, for example, an auto reinstatement of permissions upon a return of a user from leave. A changing of a data element 103, including a creation or a deletion thereof, is referred to herein as an event. In one embodiment of the present invention, an accessing of a data element 103 constitutes an event. It is appreciated that when a particular data element 103 undergoes an event, data element content 106 and/or data element information 107 of that data element 103 is changed at the event. However, corresponding data representation information 108 is typically not immediately updated upon an event. Therefore, following a typical event for any data element 103, the data element content 106 of that data element 103 includes post-event content and the data element information 107 of that data element 103 includes post-event information, while the data representation information 108 of the stored data representation 105 corresponding to that data element 103 includes pre-event information.

As seen particularly in FIG. 1B, data element database 104 may be any suitable database, but is preferably a hierarchical database in which various data elements 103 may be characterized by relationships of a family-tree type, such as parents and children. Thus, various pairs of data elements 103 may be characterized by a parent-child relationship 110, a sibling relationship 112 or a grandparent-grandchild relationship 114 therebetween. Similarly, various data elements 103 may be related to one another through other relationships known in the art, such as more complex family tree relationships, including, inter alia, nibling relationships and cousin relationships.

System 100 also includes an event notification ascertainer (ENA) 116, ascertaining which of data elements 103 being monitored has an event notification 117 associated therewith. An example of a suitable ENA 116 is an ENA described in U.S. Pat. No. 11,030,307. For simplicity, DEM 102 and ENA 116 are shown in FIGS. 1A & 1B as being part of a single block 118.

Preferably, DEM 102 identifies all data elements 103 that have recently undergone an event, such as, inter alia, a creation or a change as discussed hereinabove, subsequent to a previous output of block 118, and associates each of those data elements 103 with an event notification 117. As a result, all data elements 103 that have undergone a recent event are each associated with an event notification 117, and all data elements 103 that have not undergone a recent event are not associated with an event notification 117. As used herein, a recent event is an event that occurred subsequent to a previous output of block 118 to a difference reporter 120. Examples of events and event notifications 117 are further described hereinbelow with reference to FIGS. 15A-18D.

In a preferred embodiment of the present invention, event notification 117 is at least one of a notification of a change in data element content 106 and a change in data element information 107. A change in data element information 107 may include, inter alia, an actual access to a data element 103; a change in an access permission to a data element 103, such as a change in at least one of a read permission, a write permission and a delete permission; a change in metadata associated with data element 103; and a change in classification rule indications associated with data element 103, such as a change in a rule-based indication of whether or not data element 103 includes sensitive data element content 106.

An output of block 118 provides identification of those data elements 103 stored in data element database 104 which have a recent event notification 117 associated therewith. As used herein, a recent event notification 117 is an event notification 117 that was generated subsequent to a previous output of block 118 to difference reporter 120.

Difference reporter 120 reports, for those data elements 103 stored in data element database 104 having a recent event notification 117 associated therewith, a difference between data element information 107, which is post-event data element information, and corresponding data representation information 108, which is pre-event data representation information. When no data representation information 108 exists for a particular data element 103, for example, when a new data element 103 is created, system 100 typically assigns a default data representation 105 to that data element 103.

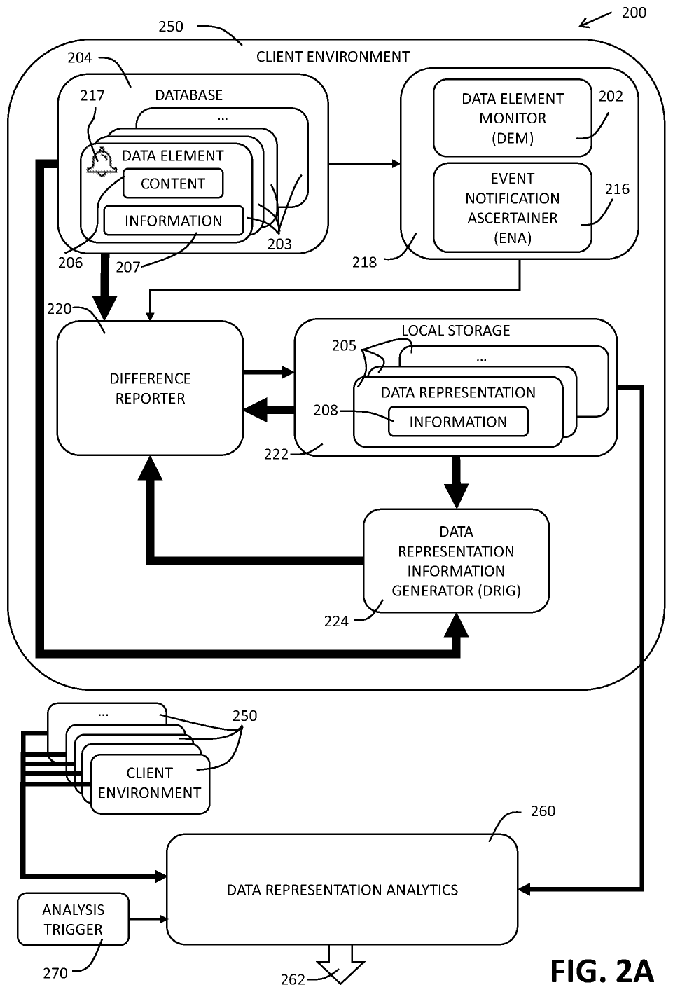

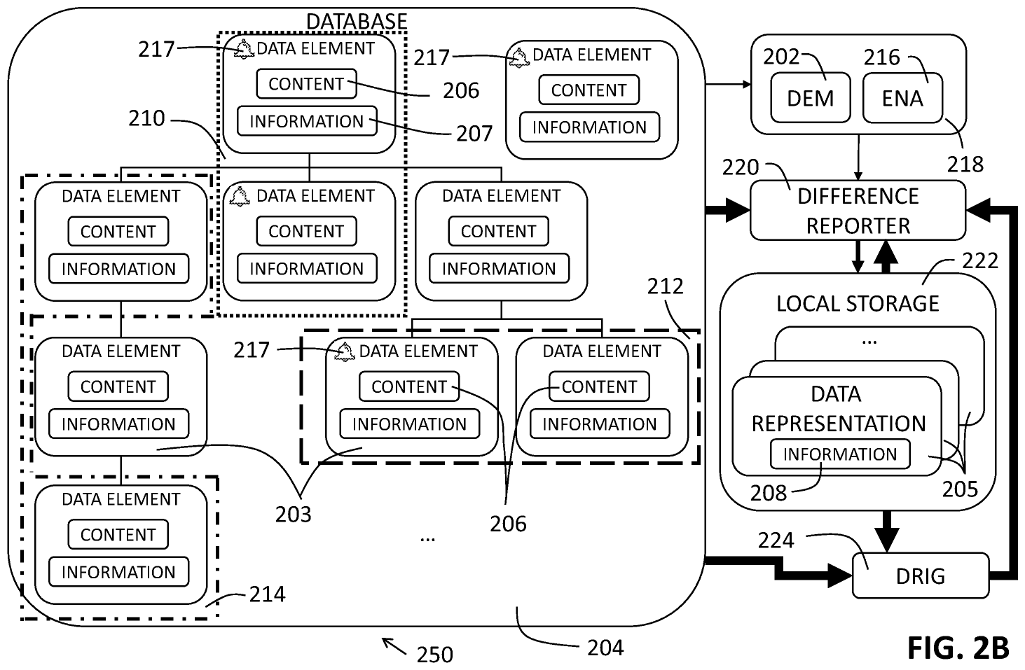

System 100 preferably further includes a local data representation storage 122, which contains stored data representations 105. In the embodiment of FIGS. 1A & 1B, each of data elements 103 has associated therewith a stored data representation 105. Thus, in the embodiment of FIGS. 1A & 1B, each data element 103 being monitored which has an event notification 117 associated therewith has corresponding data representation information 108, which is pre-event data representation information and is contained in a stored data representation 105. Embodiments in which some data elements 103 are not associated with a stored data representation are discussed hereinbelow, with particular reference to FIGS. 2A-9B.

In the embodiment of FIGS. 1A & 1B, data element information 107, which is post-event data element information, and data element content 106, which is post-event data element content, are received by difference reporter 120 from data element database 104. In this embodiment, for each data element 103 having an event notification 117 associated therewith, difference reporter 120 provides to local data representation storage 122 an output which represents a difference between data element information 107, which is post-event data element information, and corresponding data representation information 108, which is pre-event data representation information. This allows data representation 105 to be updated in accordance with the event, preferably by difference reporter 120, without having to transmit the entirety of data element information 107, which is post-event information, to local data representation storage 122.

Preferably, as will be described hereinbelow, difference reporter 120 also includes a classification rule applicability determiner which indicates whether data element content 106 of a data element 103 is subject to any classification rules. As described hereinbelow, in a preferred embodiment of the present invention, the classification rule applicability determiner checks data elements 103 for data element content 106 that is subject to particular rules, such as stringent privacy measures. Examples of classification rules and their applicability are described hereinbelow with reference to FIGS. 15A-18D. Preferably, difference reporter 120 provides classification rules of data elements 103 to local data representation storage 122, but difference reporter 120 does not provide data element content 106 itself to local data representation storage 122.

It is a particular feature of the embodiment described above and shown in FIGS. 1A & 1B that the above-described portions of system 100 are all located in a given physical client environment 150.

System 100 preferably further presents to at least one human user a visually sensible indication of output from difference reporter 120 following an identification by DEM 102 and ENA 116 of those of multiplicity of data elements 103 that have recently undergone a change and accordingly an update by difference reporter 120 of data representations 105. The indication is typically generated upon a user accessing local data representation storage 122, whereupon updated data representations 105 including, but not limited to, changes made since the previous execution of elements within system 100 are accessible to the user and preferably displayed. In a preferred embodiment of the present invention, the indication is presented by an output generator (not shown) included in system 100.

System 100 preferably further includes data representation analytics 160, which preferably accesses the output of data representation storage 122 and data representation storages 122 from multiple client environments 150, which are typically physically remote from each other. As represented in FIG. 1A by an arrow 162, data representation analytics 160 preferably provides notifications and action outputs, such as security alarms, analyses of user behavior and analyses of system behavior.

It is appreciated that in prior art systems having multiple copies of computerized data stored in multiple locations, the prior art system must communicate large amounts of data between data storage locations to ensure that records of data are kept updated, leading to technical problems with speed and cost. In contrast, system 100 preferably communicates between data storage locations only changes made to data records. Thus, system 100 communicates significantly less data than prior art systems, leading to improved technical performance of system 100 relative to prior art systems, such as improved speed and cost. Additionally, system 100 allows users, such as managers and strategists, to access and view up-to-date information as data elements 103 are edited in database 104 by at least one user, ensuring the accuracy of performance reviews or security surveillance monitoring which users have permissions relating to particular ones of data elements 103.

Output of data representation analytics 160 may be automatic or in response to an input from an analysis trigger 170, such as a query. Inputs to data representation analytics 160 from analysis trigger 170 may be manual, such as a user report request, or automatic, such as scheduled time-based queries or rule-based queries. In a preferred embodiment of the present invention, data representation analytics 160 is a utilization subsystem of system 100, and data representation analytics 160 employs data representation information 108 contained in updated data representations 105, which is post-event data representation information.

It is appreciated that system 100 may be operative to monitor enterprise-wide data systems which may include one billion data elements 103. It is further appreciated that system 100 is operative to enable updating of all data elements 103 being monitored in near-real time, typically in less than one minute.

Reference is now made to FIG. 2A, which is a simplified functional block diagram of a system for monitoring data elements, constructed and operative in accordance with another preferred embodiment of the present invention, and to FIG. 2B, which is a simplified functional block diagram of a portion of the system of FIG. 2A, showing particularly details of a database thereof.

As seen in FIGS. 2A & 2B, there is provided a system 200 for monitoring data elements including a data element monitor (DEM) 202, monitoring a multiplicity of data elements 203, typically stored in a data element database 204. In a preferred embodiment of the present invention, some of data elements 203 have associated therewith a corresponding stored data representation 205, while others of data elements 203 do not have associated therewith a corresponding stored data representation 205. Preferably each data element 203 includes data element content 206 and data element information 207, and each stored data representation 205 includes data representation information 208, corresponding to at least a subset of data element information 207.

An example of a suitable DEM 202 is described in U.S. Pat. No. 11,030,307. Examples of data elements 203 are described hereinbelow with reference to FIGS. 15A-18D. Examples of a suitable data element database 204 include, inter alia, a New Technology File System (NTFS), commercially available from Microsoft, a hierarchical database, such as an IBM IMS, commercially available from IBM, a commercially available object-oriented database, such as a commercially available ObjectStore database from IgniteTech, and a document database, such as a database commercially available from MongoDB.

Data element content 206 is typically a raison d'être of data element 203. For example, a data element 203 that is embodied as a text file often includes data element content 206 in the form of text that is displayed when the data element 203 is opened. Similarly, a data element 203 that is embodied as a video file often includes data element content 206 in the form of video and audio media to be displayed when the data element 203 is opened. As an additional example, a data element 203 that is embodied as an image file often includes data element content 206 in the form of a picture that is displayed when the data element 203 is opened.

Data element information 207 and data representation information 208, on the other hand, are typically supporting data associated with data element 203. For example, a data element 203 that is embodied as a file typically includes data element information 207 such as file properties, and the data representation 205 associated with such a data element 203 preferably includes data representation information 208 that is identical to or a subset of the data element information 207 for that data element 203.

Data element information 207 and data representation information 208 may be any suitable information relating to data element 203 and data representation 205, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 203 are preferably editable. More specifically, preferably one or both of data element content 206 and data element information 207 can be changed, either manually, such as by a human user of database 204, or automatically, such as by an operational rule, for example, an auto reinstatement of permissions upon a return of a user from leave. A changing of a data element 203, including a creation or a deletion thereof, is referred to herein as an event. In one embodiment of the present invention, an accessing of a data element 203 constitutes an event. It is appreciated that when a particular data element 203 undergoes an event, data element content 206 and/or data element information 207 of that data element 203 is changed at the event. However, corresponding data representation information 208 is typically not immediately updated upon an event. Therefore, following a typical event for any data element 203, the data element content 206 of that data element 203 includes post-event content and the data element information 207 of that data element 203 includes post-event information, while the data representation information 208 of the stored data representation 205 corresponding to that data element 203, if one exists, includes pre-event information.

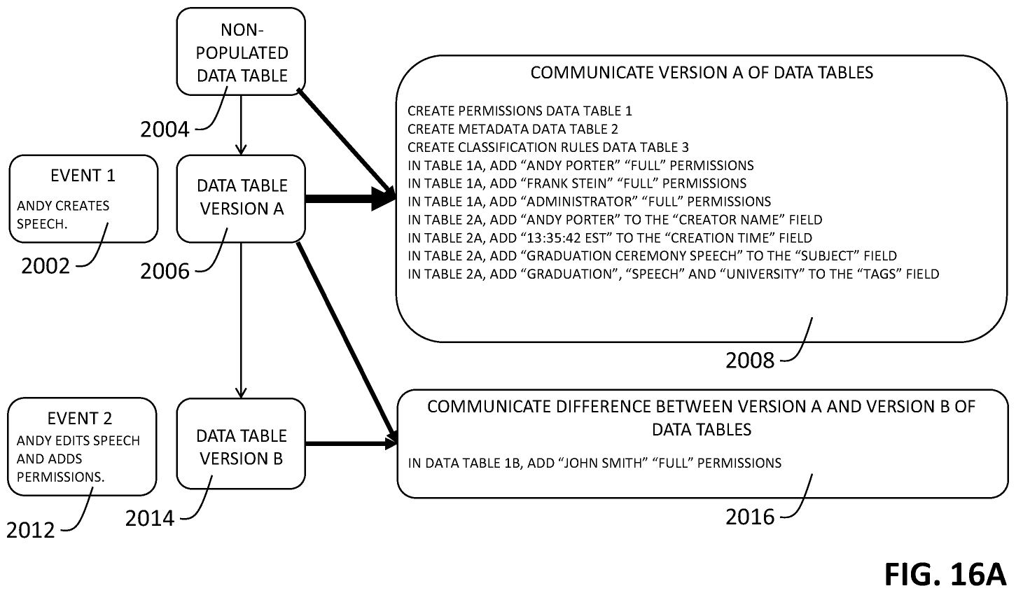

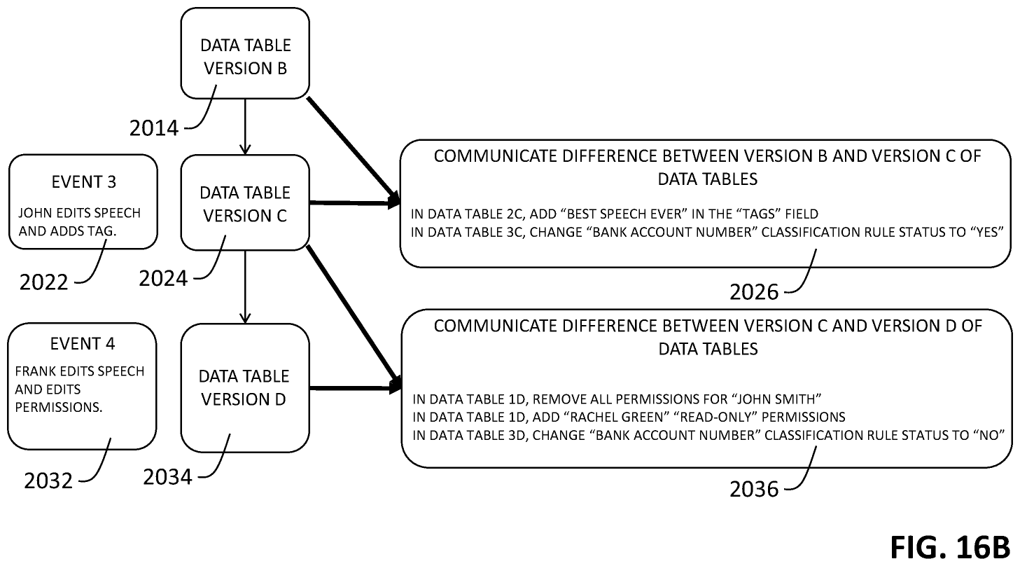

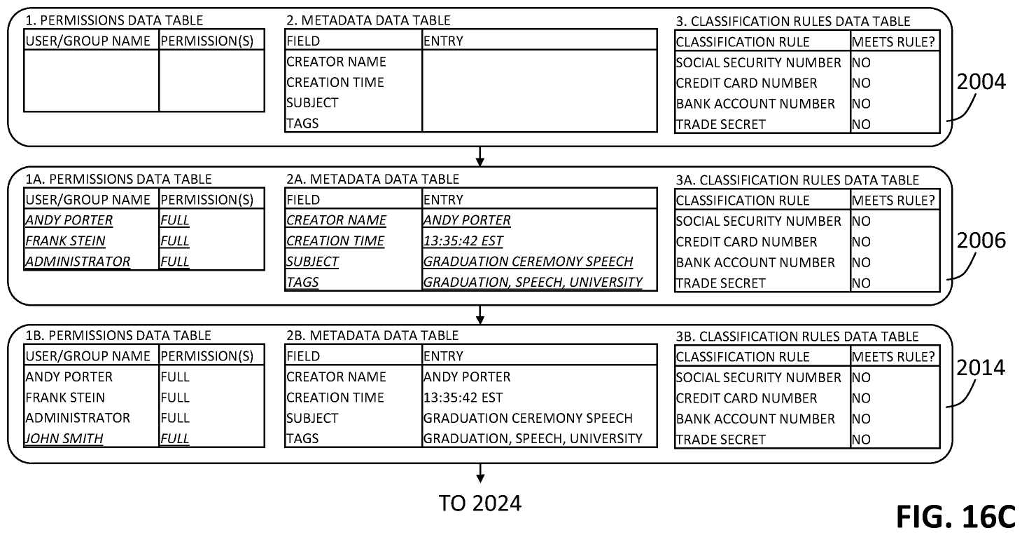

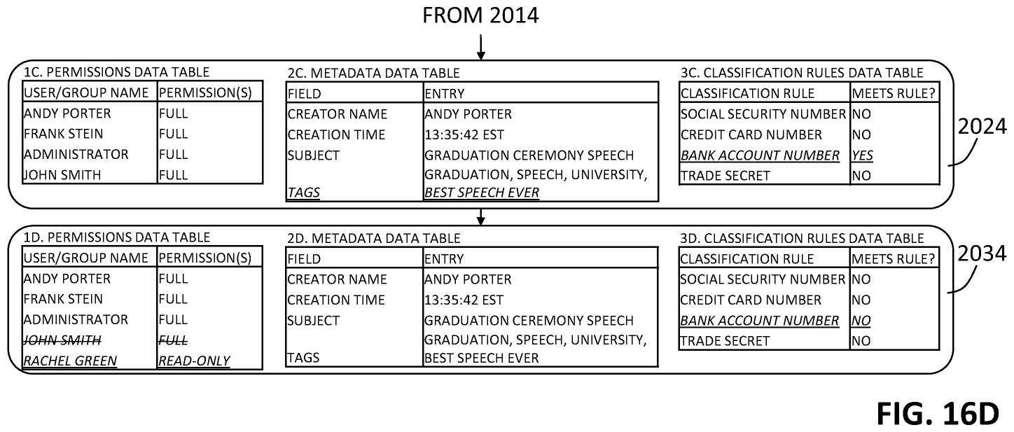

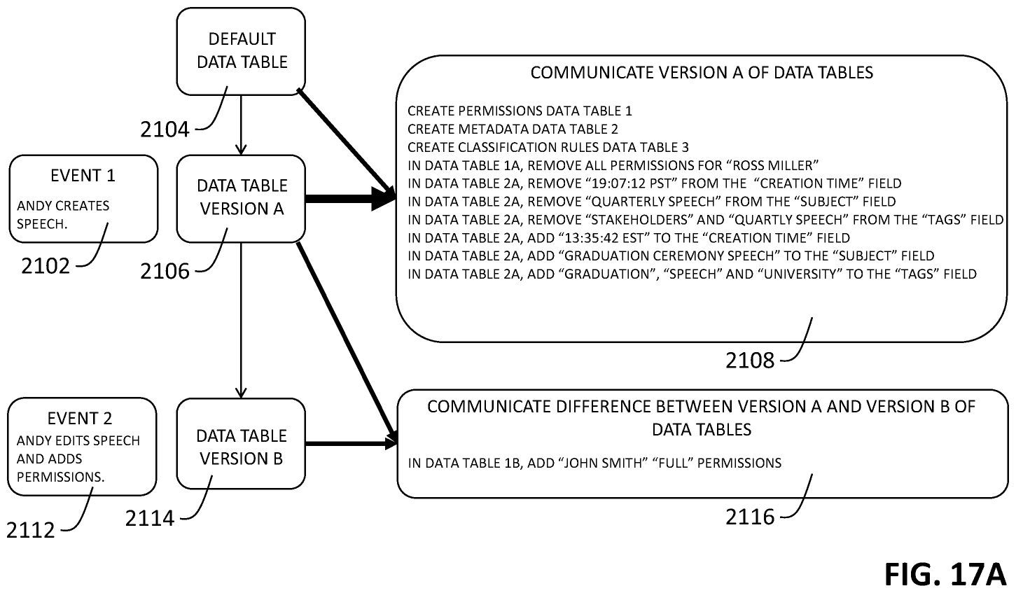

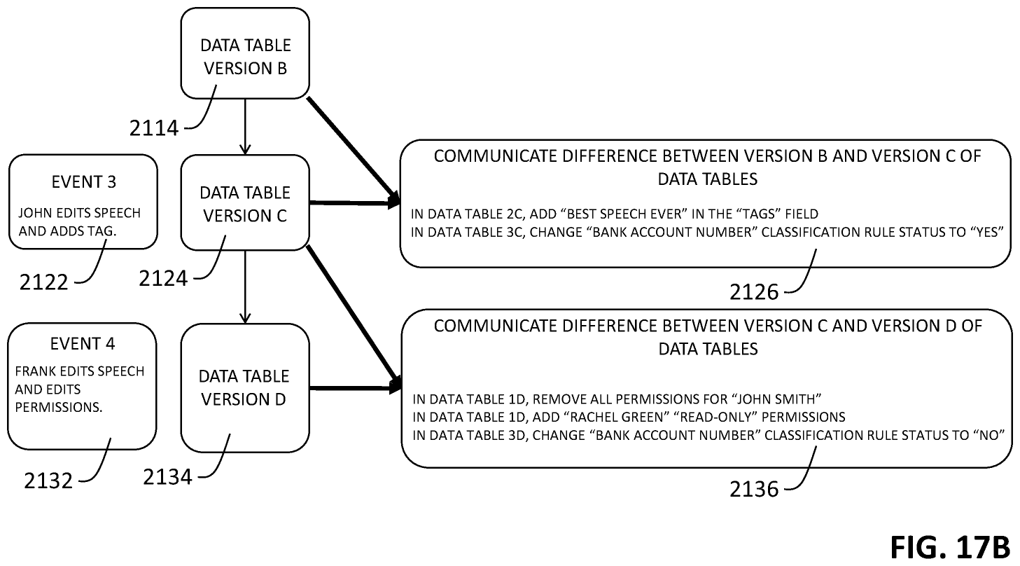

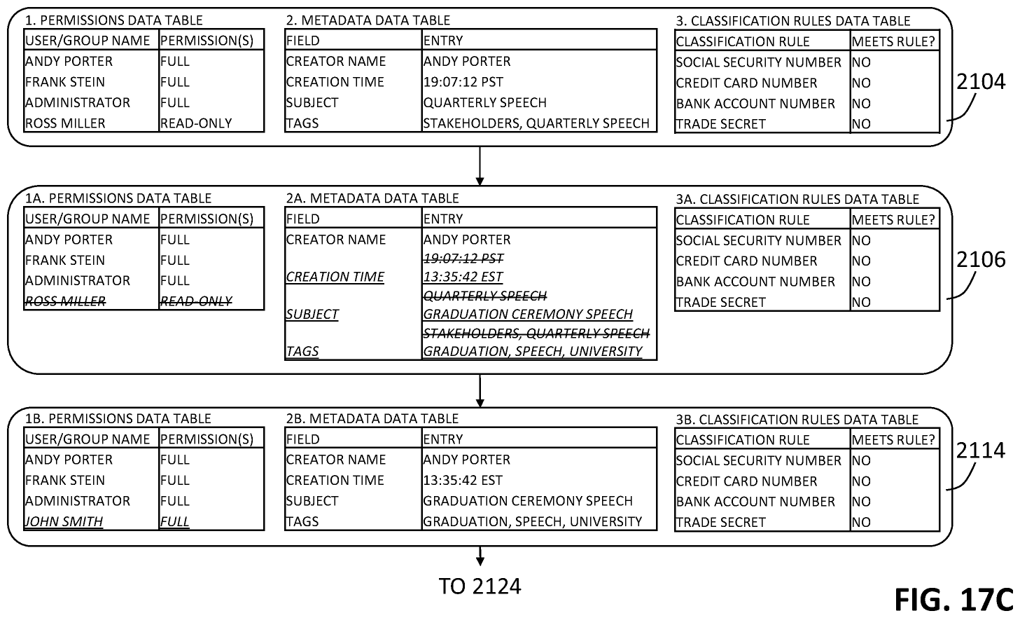

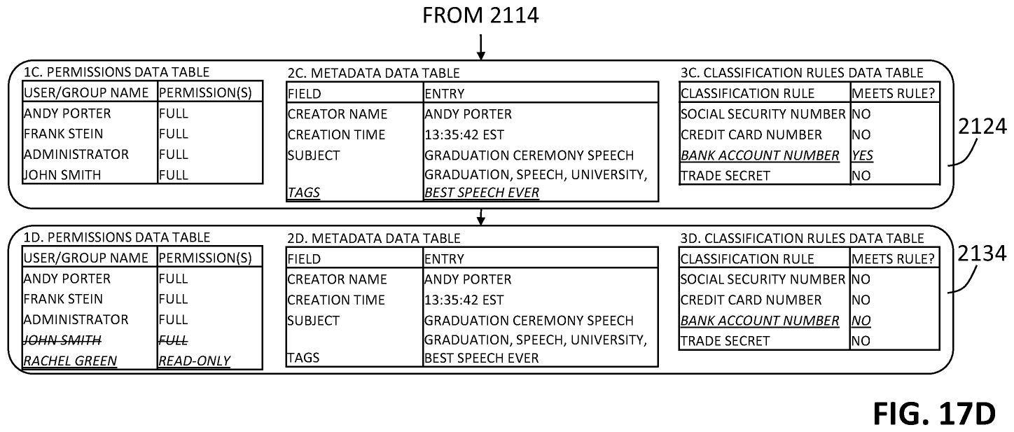

It is appreciated that when no stored data representation 205 exists for a particular data element 203, such as when a new data element 203 is created, system 200 typically assigns a default data representation 205 to that data element 203. In one embodiment of the present invention, the default data representation 205 assigned to such a data element 203 includes blank default data representation information 208, as in the example described hereinbelow with reference to FIG. 16C. In another embodiment of the present invention, the default data representation 205 assigned to such a data element 203 includes data representation information 208 copied from a data representation 205 corresponding to an existing data element 203 that is analogous or similar to the newly created data element 203, as in the example described hereinbelow with reference to FIG. 17C.

As seen particularly in FIG. 2B, data element database 204 may be any suitable database, but is preferably a hierarchical database in which various data elements 203 may be characterized by relationships of a family-tree type, such as parents and children. Thus, various pairs of data elements 203 may be characterized by a parent-child relationship 210, a sibling relationship 212 or a grandparent-grandchild relationship 214 therebetween. Similarly, various data elements 203 may be related to one another through other relationships known in the art, such as more complex family tree relationships including, inter alia, nibling relationships and cousin relationships.

System 200 also includes an event notification ascertainer (ENA) 216, ascertaining which of data elements 203 being monitored has an event notification 217 associated therewith. An example of a suitable ENA 216 is an ENA described in U.S. Pat. No. 11,030,307. For simplicity, DEM 202 and ENA 216 are shown in FIGS. 2A & 2B as being part of a single block 218.

Preferably, DEM 202 identifies all data elements 203 that have recently undergone an event, such as, inter alia, a creation or a change as discussed hereinabove, subsequent to a previous output of block 218, and associates each of those data elements 203 with an event notification 217. As a result, all data elements 203 that have undergone a recent event are each associated with an event notification 217, and all data elements 203 that have not undergone a recent event are not associated with an event notification 217. As used herein, a recent event is an event that occurred subsequent to a previous output of block 218 to a difference reporter 220. Examples of events and event notifications 217 are further described hereinbelow with reference to FIGS. 15A-18D.

In a preferred embodiment of the present invention, event notification 217 is at least one of a notification of a change in data element content 206 and a change in data element information 207. A change in data element information 207 may include, inter alia, an actual access to a data element 203; a change in an access permission to a data element 203, such as a change in at least one of a read permission, a write permission and a delete permission; a change in metadata associated with data element 203; and a change in classification rule indications associated with data element 203, such as a change in a rule-based indication of whether or not data element 203 includes sensitive data element content 206.

The output of block 218 provides identification of those data elements 203 stored in data element database 204 which have a recent event notification 217 associated therewith. As used herein, a recent event notification 217 is an event notification 217 that was generated subsequent to a previous output of block 218 to difference reporter 220.

Difference reporter 220 reports, for those data elements 203 stored in data element database 204 which have a recent event notification 217 associated therewith, a difference between data element information 207, which is post-event data element information, and corresponding data representation information 208, which is pre-event data representation information. As described hereinabove, when no data representation information 208 exists for a particular data element 203, for example, when a new data element 203 is created, system 200 typically assigns a default data representation 205 to that data element 203.

System 200 preferably further includes a local data representation storage 222, which contains stored data representations 205. In the embodiment of FIGS. 2A & 2B, data representation information 208, which is pre-event data representation information, may be located in local data representation storage 222, more particularly in a stored data representation 205 already associated with a corresponding data element 203 being monitored which has an event notification 217 associated therewith. As distinct from the embodiment of FIGS. 1A & 1B, described hereinabove, in the embodiment of FIGS. 2A & 2B, when no stored data representation 205 exists, such as when a new data element 203 is created, a default data representation 205, including default data representation information 208, which represents pre-event data representation information, is preferably received from a data representation information generator (DRIG) 224 and may be based partially or entirely on one or more stored data representations 205 not already associated with the corresponding data element 203 being monitored which has an event notification 217 associated therewith. These stored data representations 205 may be associated, for example, with data elements 203 having a family-tree type relationship with the corresponding data element 203 being monitored which has an event notification 217 associated therewith in hierarchical data base 204, such as a parent-child relationship 210 or a sibling relationship 212.

DRIG 224 preferably receives input from data element database 204. The input received by DRIG 224 preferably includes corresponding data element information 207, which is post-event data element information, for data element 203 stored in data element database 204 which has an event notification 217 associated therewith. Additionally or alternatively, the input received by DRIG 224 includes data element content 206 for data element 203 stored in data element database 204 which has an event notification 217 associated therewith. This then enables DRIG 224 to obtain stored data representations 205, that are associated with other data elements 203 that are related to that data element 203 being monitored which has an event notification 217 associated therewith in hierarchical data base 204, from local data representation storage 222 for use in providing the default data representation information 208.

In a preferred embodiment of the present invention, other data elements 203 that are analogous to and/or related to that data element 203 being monitored which has an event notification 217 associated therewith are associated with data representations 205 which are analogous to that data element 203 being monitored which has an event notification 217 associated therewith. Preferably, the at least one analogous data representation 205 has at least some similarity to that data element 203 being monitored which has an event notification 217 associated therewith. In one embodiment of the present invention, the similarity between the at least one analogous data representation 205 having at least some similarity to that data element 203 being monitored which has an event notification 217 associated therewith, is a similarity in data representation information 208 and that data element 203 being monitored which has an event notification 217 associated therewith. Additionally or alternatively, the similarity between the at least one analogous data representation 205 having at least some similarity to that data element 203 being monitored which has an event notification 217 associated therewith, is a similarity in data element content 206 of the data element 203 with which that data representation 205 is associated and that data element 203 being monitored which has an event notification 217 associated therewith.

For example, as described hereinabove, an analogous data representation 205, stored in data representation storage 222, could be similar to that data element 203 being monitored, which has an event notification 217 associated therewith, in that the analogous data representation 205 and the data element 203 being monitored, which has an event notification 217 associated therewith share a family-tree type relationship. Additionally or alternatively, an analogous data representation 205, stored in data representation storage 222, could be similar to that data element 203 being monitored, which has an event notification 217 associated therewith, in that the analogous data representation 205 and the data element 203 being monitored, which has an event notification 217 associated therewith share, for example, a common data element creator or common keywords. Preferably, the first data representation 205, which is analogous to and/or is related to that data element 203 being monitored which has an event notification 217 associated therewith, found by DRIG 224 is sent to difference reporter 220.

In the embodiment of FIGS. 2A & 2B, data element information 207, which is post-event data element information, and data element content 206, which is post-event data element content, for a corresponding data element 203 being monitored which has an event notification 217 associated therewith, are received by difference reporter 220 from data element database 204. In this embodiment, for each data element 203 having an event notification 217 associated therewith, difference reporter 220 provides to local data representation storage 222 an output which represents a difference between data element information 207, which is post-event data element information, and corresponding data representation information 208, which is pre-event data representation information. This allows data element representation 205 to be updated in accordance with the event, preferably by difference reporter 220, without having to transmit the entirety of post-event information 207 to local data representation storage 222.

Preferably, as will be described hereinbelow, difference reporter 220 also includes a classification rule applicability determiner which indicates whether data element content 206 of data element 203 is subject to any classification rules. As described hereinbelow, in a preferred embodiment of the present invention, the classification rule applicability determiner checks data elements 203 for data element content 206 that is subject to particular rules, such as stringent privacy measures. Examples of classification rules and their applicability are described hereinbelow with reference to FIGS. 15A-18D. Preferably, difference reporter 220 provides classification rules of data elements 203 to local data representation storage 222, but difference reporter 220 does not provide data element content 206 itself to local data representation storage 222.

It is a particular feature of the embodiment described with reference to FIGS. 2A & 2B that the above-described portions of system 200 are all located in a given physical client environment 250.

System 200 preferably further presents to at least one human user a visually sensible indication of output from difference reporter 220 following an identification by DEM 202 and ENA 216 of those of multiplicity of data elements 203 that have recently undergone a change and accordingly an update by difference reporter 220 of data representations 205. The indication is typically generated upon a user accessing local data representation storage 222, whereupon updated data representations 205 including, but not limited to, changes made since the previous execution of elements within system 200 are accessible to the user and preferably displayed. In a preferred embodiment of the present invention, the indication is presented by an output generator (not shown) included in system 200.

System 200 preferably further includes data representation analytics 260, which preferably accesses the outputs of local data representation storage 222 and local data representation storages 222 from multiple client environments 250, which are typically physically remote from each other. As represented in FIG. 2A by an arrow 262, data representation analytics 260 preferably provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to technical problems with speed and cost. In contrast, system 200 preferably communicates between data storage locations only changes made to data records. Thus, system 200 communicates significantly less data than prior art systems, leading to improved technical performance of system 200 relative to prior art systems, such as improved speed and cost. Additionally, system 200 allows users, such as managers and strategists, to access and view up-to-date information as data elements 203 are edited in database 204 by at least one user, ensuring the accuracy of performance reviews or security surveillance monitoring which users have permissions relating to particular ones of data elements 203.

Output of data representation analytics 260 may be automatic or in response to an input from an analysis trigger 270, such as a query. Inputs to data representation analytics 260 from analysis trigger 270 may be manual, such as a user report request, or automatic, such as scheduled time-based queries or rule-based queries.

In a preferred embodiment of the present invention, data representation analytics 260 is a utilization subsystem of system 200, and data representation analytics 260 employs post-event data representation information 208 contained in updated data representations 205.

It is a particular feature of an embodiment of the present invention, exemplified by FIGS. 2A & 2B, that the bandwidth requirements for communication between the local data representation storage 222 of the various client environments 250 and data representation analytics 260 are relatively low, since only differences between data element information 207 and corresponding data representation information 208 are communicated to data representation analytics 260, thereby providing substantially greater latency and lower cost than that of prior art systems, which transmit all data element information and/or data element content for all data elements in a database, whether or not the data elements have been changed.

It is appreciated that system 200 may be operative to monitor enterprise-wide data systems which may include one billion data elements 203. It is further appreciated that system 200 is operative to enable updating of all data elements 203 being monitored in near-real time, typically in less than one minute.

It is appreciated that in the preferred embodiment of FIGS. 1A & 1B, DEM 102 of system 100 identifies data elements 103 which contains data element content 106 and/or data element information 107 that differs from corresponding data representation 105 in local data representation storage 122. Difference reporter 120 then retrieves each of data elements 103 identified by DEM 102 and data representations 105 corresponding thereto. Difference reporter 120 provides a difference between each of data elements 103 identified by DEM 102 and data representations 105 to local data representation storage 122. Local data representation storage 122 is then updated so that each of data representations 105 reflects the changes made to corresponding ones of data elements 103. If a new data element 103 is created, there is no corresponding pre-event data representation 105 for difference reporter 120 to retrieve. In such a case, difference reporter 120 associates the new data element 103 with a blank data representation 105 having blank data representation information 108, and the entirety of data element information 107 necessary to populate blank data representation 105 is communicated local data representation storage 122.

In contrast, the embodiment of FIGS. 2A & 2B includes DRIG 224. Preferably, the embodiment of FIGS. 2A & 2B has the advantage of reduced bandwidth requirement, faster speed and lower cost compared with the embodiment of FIGS. 1A & 1B. In a case where data element 203 has a corresponding data representation 205 prior to an event, the embodiment of FIGS. 2A & 2B functions in the same way as the embodiment of FIGS. 1A & 1B.

Otherwise, in a case where data element 203 does not have a corresponding data representation 205 prior to an event, as described hereinabove, DRIG 224 obtains a data representation 205, which is associated with another data element 203 that is similar to data element 203 which had no corresponding data representation 205 prior to the event. Difference reporter 220 receives data representation 205 from DRIG 224 and provides the difference between that data representation 205 and post-event data element 203 to local data representation storage 222. Thus, data element 203, which had no corresponding data representation 205 prior to the event, does have a data representation 205 following the event, in the form of the data representation 205 provided by DRIG 224, which has been adapted to reflect the data element information 207 of data element 203.

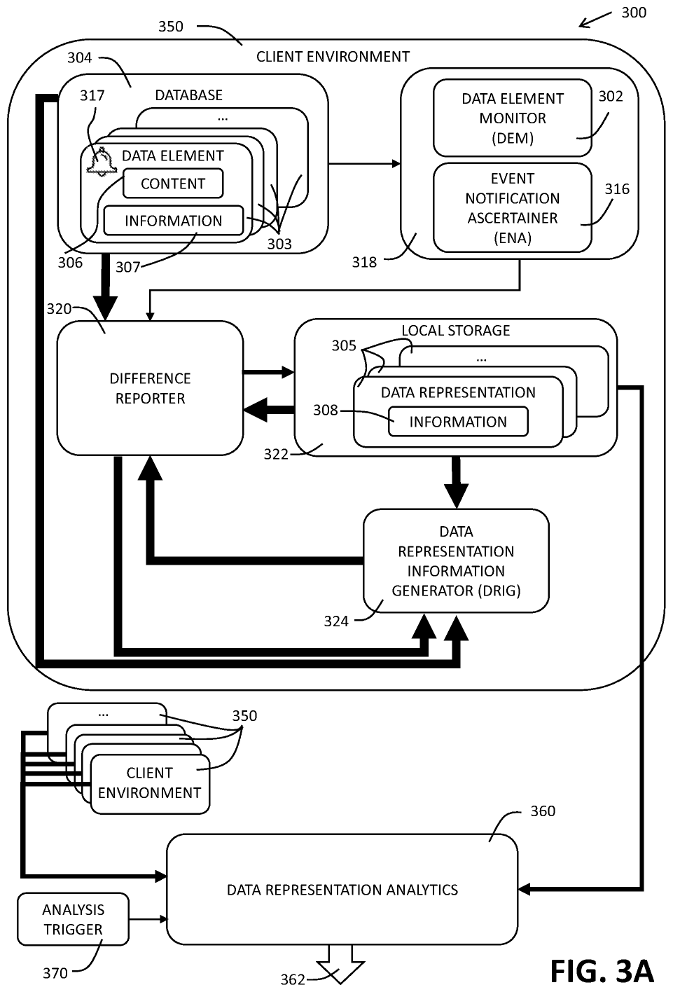

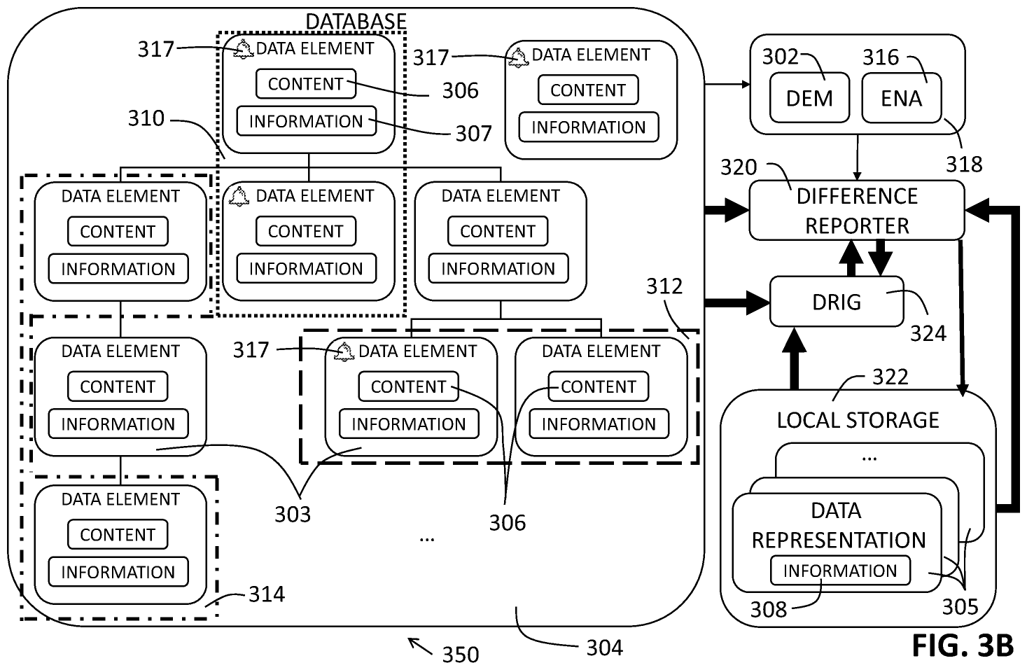

Reference is now made to FIG. 3A, which is a simplified functional block diagram of a system for monitoring data elements, constructed and operative in accordance with yet another preferred embodiment of the present invention, and to FIG. 3B, which is a simplified functional block diagram of a portion of the system of FIG. 3A, showing particularly details of a database thereof.

As seen in FIGS. 3A & 3B, there is provided a system 300 for monitoring data elements including a data element monitor (DEM) 302, monitoring a multiplicity of data elements 303, typically stored in a data element database 304. In a preferred embodiment of the present invention, some of data elements 303 have associated therewith a corresponding stored data representation 305, while others of data elements 303 do not have associated therewith a corresponding stored data representation 305. Preferably each data element 303 includes data element content 306 and data element information 307, and each stored data representation 305 includes data representation information 308, corresponding to at least a subset of data element information 307.

An example of a suitable DEM 302 is described in U.S. Pat. No. 11,030,307. Examples of data elements 303 are described hereinbelow with reference to FIGS. 15A-18D. Examples of a suitable data element database 304 include, inter alia, a New Technology File System (NTFS), commercially available from Microsoft, a hierarchical database, such as an IBM IMS, commercially available from IBM, a commercially available object-oriented database, such as a commercially available ObjectStore database from IgniteTech, and a document database, such as a database commercially available from MongoDB.

Data element content 306 is typically a raison d'être of data element 303. For example, a data element 303 that is embodied as a text file often includes data element content 306 in the form of text that is displayed when the data element 303 is opened. Similarly, a data element 303 that is embodied as a video file often includes data element content 306 in the form of video and audio media to be displayed when the data element 303 is opened. As an additional example, a data element 303 that is embodied as an image file often includes data element content 306 in the form of a picture that is displayed when the data element 303 is opened.

Data element information 307 and data representation information 308, on the other hand, are typically supporting data associated with data element 303. For example, a data element 303 that is embodied as a file typically includes data element information 307 such as file properties, and the data representation 305 associated with such a data element 303 preferably includes data representation information 308 that is identical to or a subset of the data element information 307 for that data element 303.

Data element information 307 and data representation information 308 may be any suitable information relating to data element 303 and data representation 305, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 303 are preferably editable. More specifically, preferably one or both of data element content 306 and data element information 307 can be changed, either manually, such as by a human user of database 304, or automatically, such as by an operational rule, for example, an auto reinstatement of permissions upon a return of a user from leave. A changing of a data element 303, including a creation or a deletion thereof, is referred to herein as an event. In one embodiment of the present invention, an accessing of a data element 303 constitutes an event. It is appreciated that when a particular data element 303 undergoes an event, data element content 306 and/or data element information 307 of that data element 303 is changed at the event. However, corresponding data representation information 308 is typically not immediately updated upon an event. Therefore, following a typical event for any data element 303, the data element content 306 of that data element 303 includes post-event content and the data element information 307 of that data element 303 includes post-event information, while the data representation information 308 of the stored data representation 305 corresponding to that data element 303, if one exists, includes pre-event information.

It is appreciated that when no stored data representation 305 exists for a particular data element 303, such as when a new data element 303 is created, system 300 typically assigns a default data representation 305 to that data element 303. In one embodiment of the present invention, the data representation 305 assigned to such a data element 303 includes blank default data representation information 308, as in the example described hereinbelow with reference to FIG. 16C. In another embodiment of the present invention, the data representation 305 assigned to such a data element 303 includes data representation information 308 copied from a data representation 305 corresponding to an existing data element 303 that is analogous or similar to the newly created data element 303, as in the example described hereinbelow with reference to FIG. 17C.

As seen particularly in FIG. 3B, data element database 304 may be any suitable database, but is preferably a hierarchical database in which various data elements 303 may be characterized by relationships of a family-tree type, such as parents and children. Thus, various pairs of data elements 303 may be characterized by a parent-child relationship 310, a sibling relationship 312 or a grandparent-grandchild relationship 314 therebetween. Similarly, various data elements 303 may be related to one another through other relationships known in the art, such as more complex family tree relationships including, inter alia, nibling relationships and cousin relationships.

System 300 also includes an event notification ascertainer (ENA) 316, ascertaining which of data elements 303 being monitored has an event notification 317 associated therewith. An example of a suitable ENA 316 is an ENA described in U.S. U.S. Pat. No. 11,030,307. For simplicity, DEM 302 and ENA 316 are shown in FIGS. 3A & 3B as being part of a single block 318.

Preferably, DEM 302 identifies all data elements 303 that have recently undergone an event, such as, inter alia, a creation or a change as discussed hereinabove, subsequent to a previous output of block 318, and associates each of those data elements 303 with an event notification 317. As a result, all data elements 303 that have undergone a recent event are each associated with an event notification 317, and all data elements 303 that have not undergone a recent event are not associated with an event notification 317. As used herein, a recent event is an event that occurred subsequent to a previous output of block 318 to a difference reporter 320. Examples of events and event notifications 317 are further described hereinbelow with reference to FIGS. 15A-18D.

In a preferred embodiment of the present invention, event notification 317 is at least one of a notification of a change in data element content 306 and a change in data element information 307. A change in data element information 307 may include, inter alia, an actual access to a data element 303; a change in an access permission to a data element 303, such as a change in at least one of a read permission, a write permission and a delete permission; a change in metadata associated with data element 303; and a change in classification rule indications associated with data element 303, such as a change in a rule-based indication of whether or not data element 303 includes sensitive data element content 306.

The output of block 318 provides identification of those data elements 303 stored in data element database 304 which have a recent event notification 317 associated therewith. As used herein, a recent event notification 317 is an event notification 317 that was generated subsequent to a previous output of block 318 to difference reporter 320.

Difference reporter 320 reports, for those data elements 303 stored in data element database 304 which have a recent event notification 317 associated therewith, a difference between data element information 307, which is post-event data element information, and corresponding data representation information 308, which is pre-event data representation information. As described hereinabove, when no data representation information 308 exists for a particular data element 303, for example, when a new data element 303 is created, system 300 typically assigns a default data representation 305 to that data element 303.

System 300 preferably further includes a local data representation storage 322, which contains stored data representations 305. In the embodiment of FIGS. 3A & 3B, data representation information 308, which is pre-event data representation information, may be located in local data representation storage 322, more particularly in a stored data representation 305 already associated with a corresponding data element 303 being monitored which has an event notification 317 associated therewith. As distinct from the embodiment of FIGS. 1A & 1B, described hereinabove, in the embodiment of FIGS. 3A & 3B, when no stored data representation 305 exists, such as when a new data element 303 is created, a default data representation 305, including default data representation information 308, which represents pre-event data representation information, is preferably received from a data representation information generator (DRIG) 324 and may be based partially or entirely on one or more stored data representations 305 not already associated with the corresponding data element 303 being monitored which has an event notification 317 associated therewith. These stored data representations 305 may be associated, for example, with data elements 303 having a family-tree type relationship with the corresponding data element 303 being monitored which has an event notification 317 associated therewith in hierarchical data base 304, such as a parent-child relationship 310 or a sibling relationship 312.

As distinct from the embodiment of FIGS. 2A & 2B, described hereinabove, DRIG 324 preferably receives input from difference reporter 320. The input received by DRIG 324 preferably includes corresponding data element information 307, which is post-event data element information, for data element 303 stored in data element database 304 which has an event notification 317 associated therewith. Additionally or alternatively, the input received by DRIG 324 includes data element content 306 for data element 303 stored in data element database 304 which has an event notification 317 associated therewith. This then enables DRIG 324 to obtain stored data representations 305, that are associated with other data elements 303 that are related to that data element 303 being monitored which has an event notification 317 associated therewith in hierarchical data base 304, from local data representation storage 322 for use in providing the default data representation information 308.

In a preferred embodiment of the present invention, other data elements 303 that are analogous to and/or related to that data element 303 being monitored which has an event notification 317 associated therewith are associated with data representations 305 which are analogous to that data element 303 being monitored which has an event notification 317 associated therewith. Preferably, the at least one analogous data representation 305 has at least some similarity to that data element 303 being monitored which has an event notification 317 associated therewith. In one embodiment of the present invention, the similarity between the at least one analogous data representation 305 having at least some similarity to that data element 303 being monitored which has an event notification 317 associated therewith, is a similarity in data representation information 308 and that data element 303 being monitored which has an event notification 317 associated therewith. Additionally or alternatively, the similarity between the at least one analogous data representation 305 having at least some similarity to that data element 303 being monitored which has an event notification 317 associated therewith, is a similarity in data element content 306 of the data element 303 with which that data representation 305 is associated and that data element 303 being monitored which has an event notification 317 associated therewith.

For example, as described hereinabove, an analogous data representation 305, stored in data representation storage 322, could be similar to that data element 303 being monitored, which has an event notification 317 associated therewith, in that the analogous data representation 305 and the data element 303 being monitored, which has an event notification 317 associated therewith share a family-tree type relationship. Additionally or alternatively, an analogous data representation 305, stored in data representation storage 322, could be similar to that data element 303 being monitored, which has an event notification 317 associated therewith, in that the analogous data representation 305 and the data element 303 being monitored, which has an event notification 317 associated therewith share, for example, a common data element creator or common keywords. Preferably, the first data representation 305, which is analogous to and/or is related to that data element 303 being monitored which has an event notification 317 associated therewith, found by DRIG 324 is sent to difference reporter 320.

In the embodiment of FIGS. 3A & 3B, data element information 307, which is post-event data element information, and data element content 306, which is post-event data element content, for a corresponding data element 303 being monitored which has an event notification 317 associated therewith, are received by difference reporter 320 from data element database 304. In this embodiment, for each data element 303 having an event notification 317 associated therewith, difference reporter 320 provides to local data representation storage 322 an output which represents a difference between data element information 307, which is post-event data element information, and corresponding data representation information 308, which is pre-event data representation information. This allows data element representation 305 to be updated in accordance with the event, preferably by difference reporter 320, without having to transmit the entirety of post-event information 307 to local data representation storage 322. It is appreciated that additionally or alternatively, DRIG 324 may access database 304 while retrieving similar data element 303 which provides pre-event data representation information 308

Preferably, as will be described hereinbelow, difference reporter 320 also includes a classification rule applicability determiner which indicates whether data element content 306 of data element 303 is subject to any classification rules. As described hereinbelow, in a preferred embodiment of the present invention, the classification rule applicability determiner checks data elements 303 for data element content 306 that is subject to particular rules, such as stringent privacy measures. Examples of classification rules and their applicability are described hereinbelow with reference to FIGS. 15A-18D. Preferably, difference reporter 320 provides classification rules of data elements 303 to local data representation storage 322, but difference reporter 320 does not provide data element content 306 itself to local data representation storage 322.

It is a particular feature of the embodiment described with reference to FIGS. 3A & 3B that the above-described portions of system 300 are all located in a given physical client environment 350.

System 300 preferably further presents to at least one human user a visually sensible indication of output from difference reporter 320 following an identification by DEM 302 and ENA 316 of those of multiplicity of data elements 303 that have recently undergone a change and accordingly an update by difference reporter 320 of data representations 305. The indication is typically generated upon a user accessing local data representation storage 322, whereupon updated data representations 305 including, but not limited to, changes made since the previous execution of elements within system 300 are accessible to the user and preferably displayed. In a preferred embodiment of the present invention, the indication is presented by an output generator (not shown) included in system 300.

System 300 preferably further includes data representation analytics 360, which preferably accesses the outputs of local data representation storage 322 and local data representation storages 322 from multiple client environments 350, which are typically physically remote from each other. As represented in FIG. 3A by an arrow 362, data representation analytics 360 preferably provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to technical problems with speed and cost. In contrast, system 300 preferably communicates between data storage locations only changes made to data records. Thus, system 300 communicates significantly less data than prior art systems, leading to improved technical performance of system 300 relative to prior art systems, such as improved speed and cost. Additionally, system 300 allows users, such as managers and strategists, to access and view up-to-date information as data elements 303 are edited in database 304 by at least one user, ensuring the accuracy of performance reviews or security surveillance monitoring which users have permissions relating to particular ones of data elements 303.

Output of data representation analytics 360 may be automatic or in response to an input from an analysis trigger 370, such as a query. Inputs to data representation analytics 360 from analysis trigger 370 may be manual, such as a user report request, or automatic, such as scheduled time-based queries or rule-based queries.

In a preferred embodiment of the present invention, data representation analytics 360 is a utilization subsystem of system 300, and data representation analytics 360 employs post-event data representation information 308 contained in updated data representations 305.

It is a particular feature of an embodiment of the present invention, exemplified by FIGS. 3A & 3B, that the bandwidth requirements for communication between the local data representation storage 322 of the various client environments 350 and data representation analytics 360 are relatively low, since only differences between data element information 307 and corresponding data representation information 308 are communicated to data representation analytics 360, thereby providing substantially greater latency and lower cost than that of prior art systems, which transmit all data element information and/or data element content for all data elements in a database, whether or not the data elements have been changed.

It is appreciated that system 300 may be operative to monitor enterprise-wide data systems which may include one billion data elements 303. It is further appreciated that system 300 is operative to enable updating of all data elements 303 being monitored in near-real time, typically in less than one minute.

It is appreciated that, as the embodiment of FIGS. 2A & 2B, the embodiment of FIGS. 3A & 3B is distinct from the embodiment of FIGS. 1A & 1B, in that system 300 includes DRIG 324, similar to DRIG 224 of FIGS. 2A & 2B. The embodiments of FIGS. 2A-3B both have the advantage of reduced bandwidth requirement, faster speed and lower cost compared with the embodiment of FIGS. 1A & 1B.

The embodiment of FIGS. 3A & 3B is distinct from the embodiment of FIGS. 2A & 2B in the retrieval of post-event data element 303 by DRIG 324 compared to the retrieval of post-event data element 203 by DRIG 224. In the embodiment of FIGS. 2A & 2B, post-event data element 203 is obtained by DRIG 224 from database 204. In the embodiment of FIGS. 3A & 3B, post-event data element 303 is obtained by DRIG 324 from difference reporter 320, which obtains post-event data element 303 from database 304. DRIG 324 may access database 304 while retrieving similar data element 303 which provides pre-event data representation information 308.

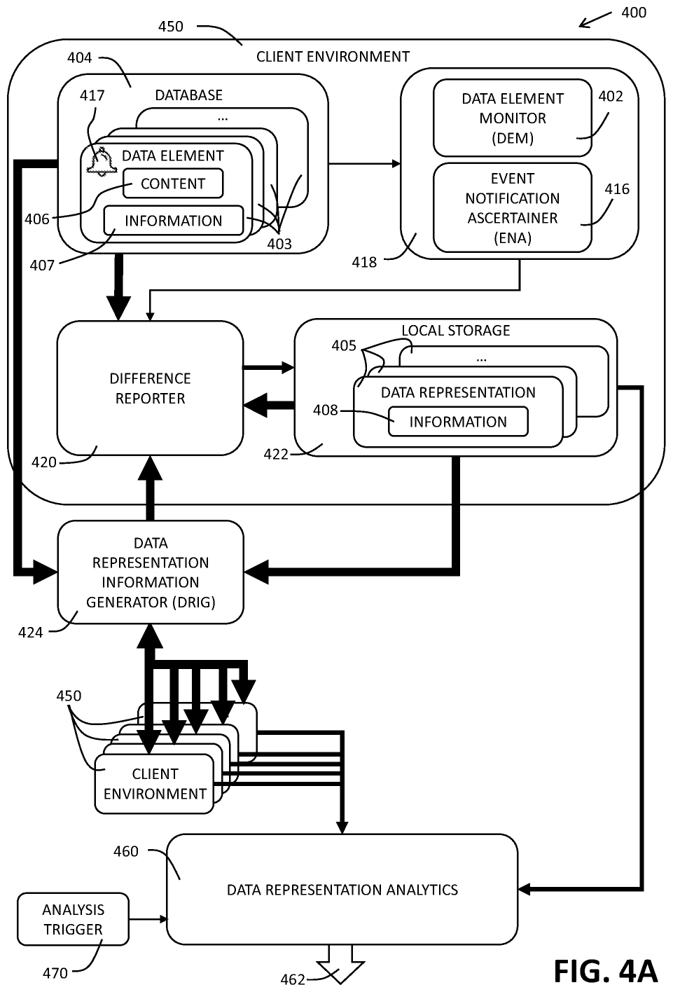

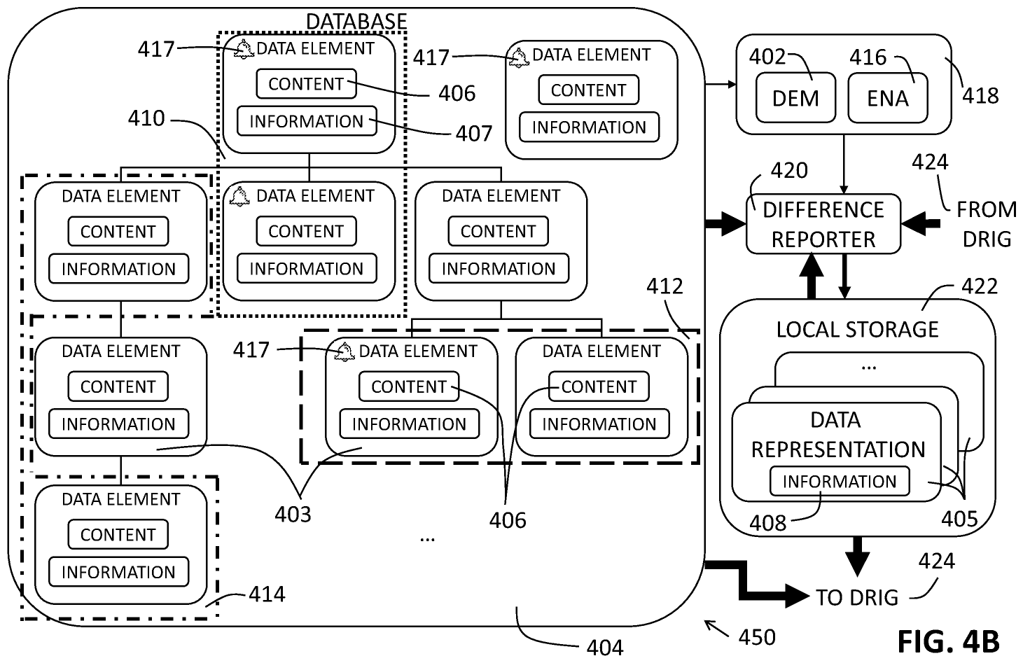

Reference is now made to FIG. 4A, which is a simplified functional block diagram of a system for monitoring data elements, constructed and operative in accordance with still another preferred embodiment of the present invention, and to FIG. 4B, which is a simplified functional block diagram of a portion of the system of FIG. 4A, showing particularly details of a database thereof.

As seen in FIGS. 4A & 4B, there is provided a system 400 for monitoring data elements including a data element monitor (DEM) 402, monitoring a multiplicity of data elements 403, typically stored in a data element database 404. In a preferred embodiment of the present invention, some of data elements 403 have associated therewith a corresponding stored data representation 405, while others of data elements 403 do not have associated therewith a corresponding stored data representation 405. Preferably each data element 403 includes data element content 406 and data element information 407, and each stored data representation 405 includes data representation information 408, corresponding to at least a subset of data element information 407.

An example of a suitable DEM 402 is described in U.S. Pat. No. 11,030,307. Examples of data elements 403 are described hereinbelow with reference to FIGS. 15A-18D. Examples of a suitable data element database 404 include, inter alia, a New Technology File System (NTFS), commercially available from Microsoft, a Hierarchical database, such as an IBM IMS, commercially available from IBM, a commercially available object-oriented database, such as a commercially available ObjectStore database from IgniteTech, and a document database, such as a database commercially available from MongoDB.

Data element content 406 is typically a raison d'être of a data element. For example, a data element 403 that is embodied as a text file often includes data element content 406 in the form of text that is displayed when the data element 403 is opened. Similarly, a data element 403 that is embodied as a video file often includes data element content 406 in the form of video and audio media to be displayed when the data element 403 is opened. As an additional example, a data element 403 that is embodied as an image file often includes data element content 406 in the form of a picture that is displayed when the data element 403 is opened.

Data element information 407 and data representation information 408, on the other hand, are typically supporting data associated with data element 403. For example, a data element 403 that is embodied as a file typically includes data element information 407 such as file properties, and the data representation 405 associated with such a data element 403 preferably includes data representation information 408 that is identical to or a subset of the data element information 407 for that data element 403.

Data element information 407 and data representation information 408 may be any suitable information relating to data element 403 and data representation 405, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 403 are preferably editable. More specifically, preferably one or both of data element content 406 and data element information 407 can be changed, either manually, such as by a human user of database 404, or automatically, such as by an operational rule, for example, an auto reinstatement of permissions upon a return of a user from leave. A changing of a data element 403, including a creation or a deletion thereof, is referred to herein as an event. In one embodiment of the present invention, an accessing of a data element 403 constitutes an event. It is appreciated that when a particular data element 403 undergoes an event, data element content 406 and/or data element information 407 of that data element 403 is changed at the event. However, corresponding data representation information 408 is typically not immediately updated upon an event. Therefore, following a typical event for any data element 403, the data element content 406 of that data element 403 includes post-event content and the data element information 407 of that data element 403 includes post-event information, while the data representation information 408 of the stored data representation 405 corresponding to that data element 403, if one exists, includes pre-event information.

It is appreciated that when no stored data representation 405 exists for a particular data element 403, such as when a new data element 403 is created, system 400 typically assigns a default data representation 405 to that data element 403. In one embodiment of the present invention, the default data representation 405 assigned to such a data element 403 includes blank default data representation information 408, as in the example described hereinbelow with reference to FIG. 16C. In another embodiment of the present invention, the default data representation 405 assigned to such a data element 403 includes data representation information 408 copied from a data representation 405 corresponding to an existing data element 403 that is analogous or similar to the newly created data element 403, as in the example described hereinbelow with reference to FIG. 17C.

As seen particularly in FIG. 4B, data element database 404 may be any suitable database, but is preferably a hierarchical database in which various data elements 403 may be characterized by relationships of a family-tree type, such as parents and children. Thus, various pairs of data elements 403 may be characterized by a parent-child relationship 410, a sibling relationship 412 or a grandparent-grandchild relationship 414 therebetween. Similarly, various data elements 403 may be related to one another through other relationships known in the art, such as more complex family tree relationships, including, inter alia, nibling relationships and cousin relationships.

System 400 also includes an event notification ascertainer (ENA) 416, ascertaining which of data elements 403 being monitored has an event notification 417 associated therewith. An example of a suitable ENA 416 is an ENA described in U.S. Pat. No. 11,030,307. For simplicity, DEM 402 and ENA 416 are shown in FIGS. 4A & 4B as being part of a single block 418.

Preferably, DEM 402 identifies all data elements 403 that have recently undergone an event, such as, inter alia, a creation or a change as discussed hereinabove, subsequent to a previous output of block 418, and associates each of those data elements 403 with an event notification 417. As a result, all data elements 403 that have undergone a recent event are each associated with an event notification 417, and all data elements 403 that have not undergone a recent event are not associated with an event notification 417. As used herein, a recent event is an event that occurred subsequent to a previous output of block 418 to a difference reporter 420. Examples of events and event notifications 417 are further described hereinbelow with reference to FIGS. 15A-18D.

In a preferred embodiment of the present invention, event notification 417 is at least one of a notification of a change in data element content 406 and a change in data element information 407. A change in data element information 407 may include, inter alia, an actual access to a data element 403; a change in an access permission to a data element 403, such as a change in at least one of a read permission, a write permission and a delete permission; a change in metadata associated with data element 403; and a change in classification rule indications associated with data element 403, such as a change in a rule-based indication of whether or not data element 403 includes sensitive data element content 406.

The output of block 418 provides identification of those data elements 403 stored in data element database 404 which have a recent event notification 417 associated therewith. As used herein, a recent event notification 417 is an event notification 417 that was generated subsequent to a previous output of block 418 to difference reporter 420.

Difference reporter 420 reports, for those data elements 403 stored in data element database 404 which have a recent event notification 417 associated therewith, a difference between data element information 407, which is post-event data element information, and corresponding data representation information 408, which is pre-event data representation information. As described hereinabove, when no data representation information 408 exists for a particular data element 403, for example, when a new data element 403 is created, system 400 typically assigns a default data representation 405 to that data element 403.

System 400 preferably further includes a local data representation storage 422, which contains stored data representations 405. In the embodiment of FIGS. 4A & 4B, data representation information 408, which is pre-event data representation information, may be located in local data representation storage 422, more particularly in a stored data representation 405 already associated with a corresponding data element 403 being monitored which has an event notification 417 associated therewith.

As distinct from the embodiment of FIGS. 1A & 1B, described above, in the embodiment of FIGS. 4A & 4B, when no stored data representation 405 exists, such as when a new data element 403 is created, a default data representation 405, including default data representation information 408, which represents pre-event data representation information, is preferably received from a data representation information generator (DRIG) 424 and may be partially or entirely based on one or more stored data representations 405 not already associated with the corresponding data element 403 being monitored which has an event notification 417 associated therewith. These stored data representations 405 may be associated, for example, with data elements 403 having a family-tree type relationship with the corresponding data element 403 being monitored which has an event notification 417 associated therewith in a hierarchical data base 404, such as a parent-child relationship 410 or a sibling relationship 412.

DRIG 424 preferably receives input from data element database 404. The input received by DRIG 424 preferably includes corresponding data element information 407, which is post-event data element information, for data element 403 stored in data element database 404 which has an event notification 417 associated therewith. Additionally or alternatively, the input received by DRIG 424 includes data element content 406 for data element 403 stored in data element database 404 which has an event notification 417 associated therewith. This then enables DRIG 424 to obtain stored data representations 405, that are associated with other data elements 403 that are related to that data element 403 being monitored which has an event notification 417 associated therewith in hierarchical data base 404, from local data representation storage 422 for use in providing the default data representation information 408. As distinct from the embodiments of FIGS. 2A-3B, DRIG 424 is located outside of a physical client environment, here designated by reference numeral 450, and typically communicates with local data representation storages 422 from multiple client environments 450, which are typically physically remote from each other. DRIG 424 thus may generate, using the data element 403 being monitored which has an event notification 417 associated therewith received from database 404, default data representation information 408 which represents pre-event data representation information, based on data representations 405 from analogous data elements 403 stored in various different databases 404 at various client environments 450. Default data representation information 408 which represents pre-event data representation information can also be based on analogous data representations 405 stored in various different local storages 422 at various client environments 450.

In a preferred embodiment of the present invention, other data elements 403 that are analogous to and/or related to that data element 403 being monitored which has an event notification 417 associated therewith are associated with data representations 405 which are analogous to that data element 403 being monitored which has an event notification 417 associated therewith. Preferably, the at least one analogous data representation 405 has at least some similarity to that data element 403 being monitored which has an event notification 417 associated therewith. In one embodiment of the present invention, the similarity between the at least one analogous data representation 405 having at least some similarity to that data element 403 being monitored which has an event notification 417 associated therewith, is a similarity in data representation information 408 and that data element 403 being monitored which has an event notification 417 associated therewith. Additionally or alternatively, the similarity between the at least one analogous data representation 405 having at least some similarity to that data element 403 being monitored which has an event notification 417 associated therewith, is a similarity in data element content 406 of the data element 403 with which that data representation 405 is associated and that data element 403 being monitored which has an event notification 417 associated therewith.

For example, as described hereinabove, an analogous data representation 405, stored in data representation storage 422, could be similar to that data element 403 being monitored, which has an event notification 417 associated therewith, in that the analogous data representation 405 and the data element 403 being monitored, which has an event notification 417 associated therewith share a family-tree type relationship. Additionally or alternatively, an analogous data representation 405, stored in data representation storage 422, could be similar to that data element 403 being monitored, which has an event notification 417 associated therewith, in that the analogous data representation 405 and the data element 403 being monitored, which has an event notification 417 associated therewith share, for example, a common data element creator or common keywords. Preferably, the first data representation 405, which is analogous to and/or is related to that data element 403 being monitored which has an event notification 417 associated therewith, found by DRIG 424 is sent to difference reporter 420.

In the embodiment of FIGS. 4A & 4B, data element information 407, which is post-event data element information, and data element content 406, which is post-event data element content, are received by difference reporter 420 from data element database 404. In this embodiment, for each data element 403 having an event notification 417 associated therewith, difference reporter 420 provides to local data representation storage 422 an output which represents a difference between data element information 407, which is post-event data element information, and corresponding data representation information 408, which is pre-event data representation information. This allows data element representation 405 to be updated in accordance with the event, preferably by difference reporter 420, without having to transmit the entirety of post-event information 407 to local data representation storage 422.

Preferably, as will be described hereinbelow, difference reporter 420 also includes a classification rule applicability determiner which indicates whether data element content 406 of data element 403 is subject to any classification rules. As described hereinbelow, in a preferred embodiment of the present invention, the classification rule applicability determiner checks data elements 403 for data element content 406 that is subject to particular rules, such as stringent privacy measures. Examples of classification rules and their applicability are described hereinbelow with reference to FIGS. 15A-18D. Preferably, difference reporter 420 provides classification rules of data elements 403 to local data representation storage 422, but difference reporter 420 does not provide data element content 406 itself to local data representation storage 422.

System 400 preferably further presents to at least one human user a visually sensible indication of output from difference reporter 420 following an identification by DEM 402 and ENA 416 of those of multiplicity of data elements 403 that have recently undergone a change and accordingly an update by difference reporter 420 of data representations 405. The indication is typically generated upon a user accessing local data representation storage 422, whereupon updated data representations 405 including, but not limited to, changes made since the previous execution of elements within system 400 are accessible to the user and preferably displayed. In a preferred embodiment of the present invention, the indication is presented by an output generator (not shown) included in system 400.

System 400 preferably further includes data representation analytics 460, which preferably accesses the outputs of data representation storage 422 and data representation storages 422 from multiple client environments 450, which are typically physically remote from each other. As represented in FIG. 4A by an arrow 462, data representation analytics 460 preferably provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to problems with speed and cost. In contrast, system 400 preferably communicates between data storage locations only changes made to data records. Thus, system 400 communicates significantly less data than prior art systems, leading to improved technical performance of system 400 relative to prior art systems, such as improved speed and cost. Additionally, system 400 allows users, such as managers and strategists, to access and view up-to-date information as data elements 403 are edited in database 404 by at least one user, ensuring the accuracy of performance reviews or security surveillance monitoring which users have permissions relating to particular ones of data elements 403.

Output of data representation analytics 460 may be automatic or in response to an input from an analysis trigger 470, such as a query. Inputs to data representation analytics 460 from analysis trigger 470 may be manual, such as a user report request, or automatic, such as scheduled time-based queries or rule-based queries.

In a preferred embodiment of the present invention, data representation analytics 460 is a utilization subsystem of system 400, and data representation analytics 460 employs post-event data representation information 408 contained in updated data representations 405.

It is a particular feature of an embodiment of the present invention, exemplified by FIGS. 4A & 4B, that the bandwidth requirements for communication between the various client environments 450 and data representation analytics 460 are relatively low, since only differences between data element information 407 and data representation information 408 are communicated by local data representation storage 422 to data representation analytics 460, thereby providing substantially greater latency and lower cost than that of prior art systems, which transmit all data element information and/or data element content for all data elements in a database, whether or not the data elements have been changed.

It is appreciated that system 400 may be operative to monitor enterprise-wide data systems which may include one billion data elements 403. It is further appreciated that system 400 is operative to enable updating of all data elements 403 being monitored in near-real time, typically in less than one minute.

It is appreciated that, unlike the embodiments of FIGS. 1A-3B, the embodiment of FIGS. 4A & 4B includes DRIG 424, which is located outside of local client environment 450, and which accesses data representation storages 422 in other client environments 450. Similarly to the embodiments of FIGS. 2A-3B, the embodiment of FIGS. 4A & 4B differs from the embodiment of FIGS. 1A & 1B in the inclusion of DRIG 424 in system 400. The embodiments of FIGS. 2A-4B have the advantage of reduced bandwidth requirement, faster speed and lower cost compared with the embodiment of FIGS. 1A & 1B.

The embodiment of FIGS. 4A & 4B is similar to the embodiment of FIGS. 2A & 2B while distinct from the embodiment of FIGS. 3A & 3B in the retrieval of post-event data element 403 by DRIG 424. Namely, post-event data element 403 is obtained by DRIG 424 from database 404.

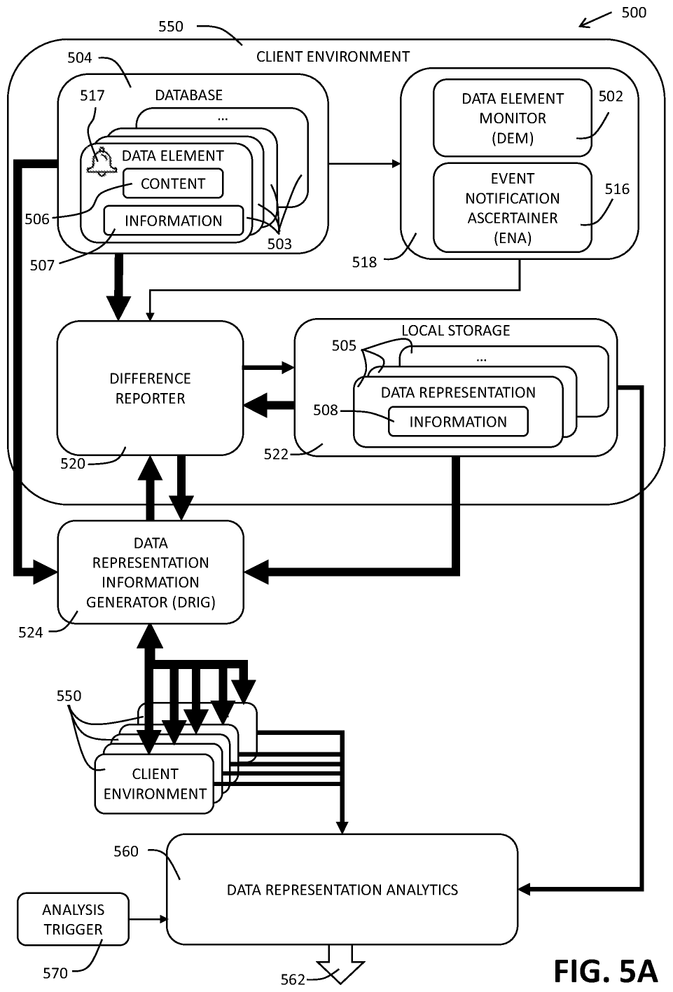

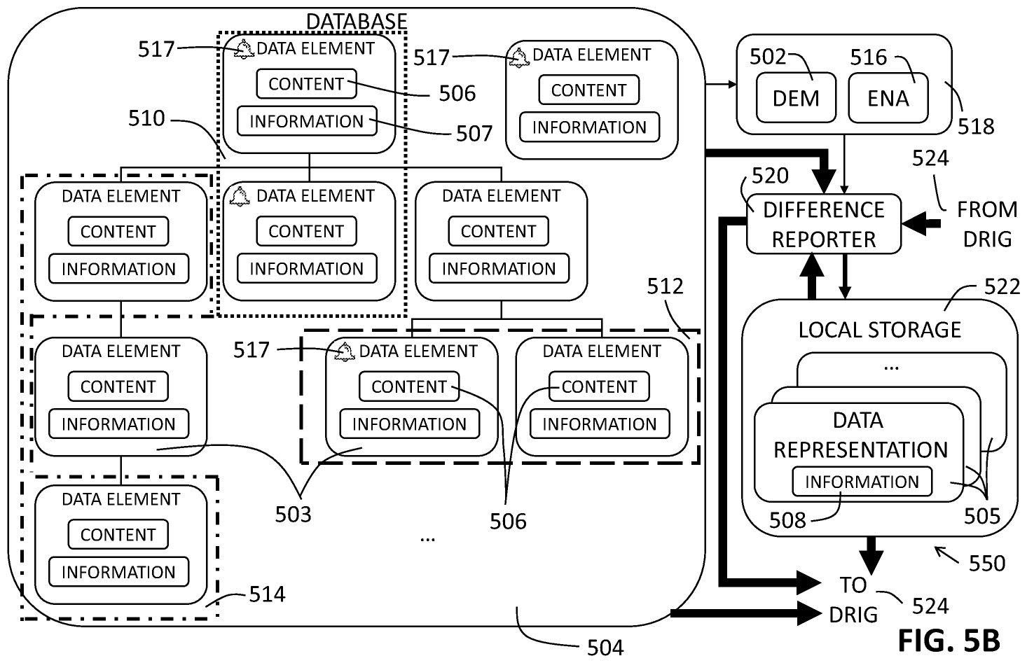

Reference is now made to FIG. 5A, which is a simplified functional block diagram of a system for monitoring data elements, constructed and operative in accordance with yet still another preferred embodiment of the present invention, and to FIG. 5B, which is a simplified functional block diagram of a portion of the system of FIG. 5A, showing particularly details of a database thereof.

As seen in FIGS. 5A & 5B, there is provided a system 500 for monitoring data elements including a data element monitor (DEM) 502, monitoring a multiplicity of data elements 503, typically stored in a data element database 504. In a preferred embodiment of the present invention, some of data elements 503 have associated therewith a corresponding stored data representation 505, while others of data elements 503 do not have associated therewith a corresponding stored data representation 505. Preferably each data element 503 includes data element content 506 and data element information 507, and each stored data representation 505 includes data representation information 508, corresponding to at least a subset of data element information 507.

An example of a suitable DEM 502 is described in U.S. Pat. No. 11,030,307. Examples of data elements 503 are described hereinbelow with reference to FIGS. 15A-18D. Examples of a suitable data element database 504 include, inter alia, a New Technology File System (NTFS), commercially available from Microsoft, a Hierarchical database, such as an IBM IMS, commercially available from IBM, a commercially available object-oriented database, such as a commercially available ObjectStore database from IgniteTech, and a document database, such as a database commercially available from MongoDB.

Data element content 506 is typically a raison d'être of a data element. For example, a data element 503 that is embodied as a text file often includes data element content 506 in the form of text that is displayed when the data element 503 is opened. Similarly, a data element 503 that is embodied as a video file often includes data element content 506 in the form of video and audio media to be displayed when the data element 503 is opened. As an additional example, a data element 503 that is embodied as an image file often includes data element content 506 in the form of a picture that is displayed when the data element 503 is opened.

Data element information 507 and data representation information 508, on the other hand, are typically supporting data associated with data element 503. For example, a data element 503 that is embodied as a file typically includes data element information 507 such as file properties, and the data representation 505 associated with such a data element 503 preferably includes data representation information 508 that is identical to or a subset of the data element information 507 for that data element 503.

Data element information 507 and data representation information 508 may be any suitable information relating to data element 503 and data representation 505, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 503 are preferably editable. More specifically, preferably one or both of data element content 506 and data element information 507 can be changed, either manually, such as by a human user of database 504, or automatically, such as by an operational rule, for example, an auto reinstatement of permissions upon a return of a user from leave. A changing of a data element 503, including a creation or a deletion thereof, is referred to herein as an event. In one embodiment of the present invention, an accessing of a data element 503 constitutes an event. It is appreciated that when a particular data element 503 undergoes an event, data element content 506 and/or data element information 507 of that data element 503 is changed at the event. However, corresponding data representation information 508 is typically not immediately updated upon an event. Therefore, following a typical event for any data element 503, the data element content 506 of that data element 503 includes post-event content and the data element information 507 of that data element 503 includes post-event information, while the data representation information 508 of the stored data representation 505 corresponding to that data element 503, if one exists, includes pre-event information.

It is appreciated that when no stored data representation 505 exists for a particular data element 503, such as when a new data element 503 is created, system 500 typically assigns a default data representation 505 to that data element 503. In one embodiment of the present invention, the default data representation 505 assigned to such a data element 503 includes blank default data representation information 508, as in the example described hereinbelow with reference to FIG. 16C. In another embodiment of the present invention, the default data representation 505 assigned to such a data element 503 includes data representation information 508 copied from a data representation 505 corresponding to an existing data element 503 that is analogous or similar to the newly created data element 503, as in the example described hereinbelow with reference to FIG. 17C.

As seen particularly in FIG. 5B, data element database 504 may be any suitable database, but is preferably a hierarchical database in which various data elements 503 may be characterized by relationships of a family-tree type, such as parents and children. Thus, various pairs of data elements 503 may be characterized by a parent-child relationship 510, a sibling relationship 512 or a grandparent-grandchild relationship 514 therebetween. Similarly, various data elements 503 may be related to one another through other relationships known in the art, such as more complex family tree relationships, including, inter alia, nibling relationships and cousin relationships.

System 500 also includes an event notification ascertainer (ENA) 516, ascertaining which of data elements 503 being monitored has an event notification 517 associated therewith. An example of a suitable ENA 516 is an ENA described in U.S. Pat. No. 11,030,307. For simplicity, DEM 502 and ENA 516 are shown in FIGS. 5A & 5B as being part of a single block 518.

Preferably, DEM 502 identifies all data elements 503 that have recently undergone an event, such as, inter alia, a creation or a change as discussed hereinabove, subsequent to a previous output of block 518, and associates each of those data elements 503 with an event notification 517. As a result, all data elements 503 that have undergone a recent event are each associated with an event notification 517, and all data elements 503 that have not undergone a recent event are not associated with an event notification 517. As used herein, a recent event is an event that occurred subsequent to a previous output of block 518 to a difference reporter 520. Examples of events and event notifications 517 are further described hereinbelow with reference to FIGS. 15A-18D.

In a preferred embodiment of the present invention, event notification 517 is at least one of a notification of a change in data element content 506 and a change in data element information 507. A change in data element information 507 may include, inter alia, an actual access to a data element 503; a change in an access permission to a data element 503, such as a change in at least one of a read permission, a write permission and a delete permission; a change in metadata associated with data element 503; and a change in classification rule indications associated with data element 503, such as a change in a rule-based indication of whether or not data element 503 includes sensitive data element content 506.

The output of block 518 provides identification of those data elements 503 stored in data element database 504 which have a recent event notification 517 associated therewith. As used herein, a recent event notification 517 is an event notification 517 that was generated subsequent to a previous output of block 518 to difference reporter 520.

Difference reporter 520 reports, for those data elements 503 stored in data element database 504 which have a recent event notification 517 associated therewith, a difference between data element information 507, which is post-event data element information, and corresponding data representation information 508, which is pre-event data representation information. As described hereinabove, when no data representation information 508 exists for a particular data element 503, for example, when a new data element 503 is created, system 500 typically assigns a default data representation 505 to that data element 503.

System 500 preferably further includes a local data representation storage 522, which contains stored data representations 505. In the embodiment of FIGS. 5A & 5B, data representation information 508, which is pre-event data representation information, may be located in local data representation storage 522, more particularly in a stored data representation 505 already associated with a corresponding data element 503 being monitored which has an event notification 517 associated therewith.

As distinct from the embodiment of FIGS. 1A & 1B, described above, in the embodiment of FIGS. 5A & 5B, when no stored data representation 505 exists, such as when a new data element 503 is created, a default data representation 505, including default data representation information 508, which represents pre-event data representation information, is preferably received from a data representation information generator (DRIG) 524 and may be partially or entirely based on one or more stored data representations 505 not already associated with the corresponding data element 503 being monitored which has an event notification 517 associated therewith. These stored data representations 505 may be associated, for example, with data elements 503 having a family-tree type relationship with the corresponding data element 503 being monitored which has an event notification 517 associated therewith in a hierarchical data base 504, such as a parent-child relationship 510 or a sibling relationship 512.

As distinct from the embodiments of FIGS. 2A, 2B, 4A & 4B, described hereinabove, DRIG 524 preferably receives input from difference reporter 520. The input received by DRIG 524 preferably includes corresponding data element information 507, which is post-event data element information, for data element 503 stored in data element database 504 which has an event notification 517 associated therewith. Additionally or alternatively, the input received by DRIG 524 includes data element content 506 for data element 503 stored in data element database 504 which has an event notification 517 associated therewith. This then enables DRIG 524 to obtain stored data representations 505, that are associated with other data elements 503 that are related to that data element 503 being monitored which has an event notification 517 associated therewith in hierarchical data base 504, from local data representation storage 522 for use in providing the default data representation information 508.

As distinct from the embodiments of FIGS. 2A-3B, DRIG 524 is located outside of a physical client environment, here designated by reference numeral 550, and typically communicates with local data representation storages 522 from multiple client environments 550, which are typically physically remote from each other. DRIG 524 thus may generate, using the data element 503 being monitored which has an event notification 517 associated therewith received from difference reporter 520, default data representation information 508 which represents pre-event data representation information, based on data representations 505 from analogous data elements 503 stored in various different databases 504 at various client environments 550. Default data representation information 508 which represents pre-event data representation information can also be based on analogous data representations 505 stored in various different local storages 522 at various client environments 550.

In a preferred embodiment of the present invention, other data elements 503 that are analogous to and/or related to that data element 503 being monitored which has an event notification 517 associated therewith are associated with data representations 505 which are analogous to that data element 503 being monitored which has an event notification 517 associated therewith. Preferably, the at least one analogous data representation 505 has at least some similarity to that data element 503 being monitored which has an event notification 517 associated therewith. In one embodiment of the present invention, the similarity between the at least one analogous data representation 505 having at least some similarity to that data element 503 being monitored which has an event notification 517 associated therewith, is a similarity in data representation information 508 and that data element 503 being monitored which has an event notification 517 associated therewith. Additionally or alternatively, the similarity between the at least one analogous data representation 505 having at least some similarity to that data element 503 being monitored which has an event notification 517 associated therewith, is a similarity in data element content 506 of the data element 503 with which that data representation 505 is associated and that data element 503 being monitored which has an event notification 517 associated therewith.

For example, as described hereinabove, an analogous data representation 505, stored in data representation storage 522, could be similar to that data element 503 being monitored, which has an event notification 517 associated therewith, in that the analogous data representation 505 and the data element 503 being monitored, which has an event notification 517 associated therewith share a family-tree type relationship. Additionally or alternatively, an analogous data representation 505, stored in data representation storage 522, could be similar to that data element 503 being monitored, which has an event notification 517 associated therewith, in that the analogous data representation 505 and the data element 503 being monitored, which has an event notification 517 associated therewith share, for example, a common data element creator or common keywords. Preferably, the first data representation 505, which is analogous to and/or is related to that data element 503 being monitored which has an event notification 517 associated therewith, found by DRIG 524 is sent to difference reporter 520.

In the embodiment of FIGS. 5A & 5B, data element information 507, which is post-event data element information, and data element content 506, which is post-event data element content, are received by difference reporter 520 from data element database 504. In this embodiment, for each data element 503 having an event notification 517 associated therewith, difference reporter 520 provides to local data representation storage 522 an output which represents a difference between data element information 507, which is post-event data element information, and corresponding data representation information 508, which is pre-event data representation information. This allows data element representation 505 to be updated in accordance with the event, preferably by difference reporter 520, without having to transmit the entirety of post-event information 507 to local data representation storage 522. It is appreciated that additionally or alternatively, DRIG 524 may access database 504 while retrieving similar data element 503 which provides pre-event data representation information 508.

Preferably, as will be described hereinbelow, difference reporter 520 also includes a classification rule applicability determiner which indicates whether data element content 506 of data element 503 is subject to any classification rules. As described hereinbelow, in a preferred embodiment of the present invention, the classification rule applicability determiner checks data elements 503 for data element content 506 that is subject to particular rules, such as stringent privacy measures. Examples of classification rules and their applicability are described hereinbelow with reference to FIGS. 15A-18D. Preferably, difference reporter 520 provides classification rules of data elements 503 to local data representation storage 522, but difference reporter 520 does not provide data element content 506 itself to local data representation storage 522.

System 500 preferably further presents to at least one human user a visually sensible indication of output from difference reporter 520 following an identification by DEM 502 and ENA 516 of those of multiplicity of data elements 503 that have recently undergone a change and accordingly an update by difference reporter 520 of data representations 505. The indication is typically generated upon a user accessing local data representation storage 522, whereupon updated data representations 505 including, but not limited to, changes made since the previous execution of elements within system 500 are accessible to the user and preferably displayed. In a preferred embodiment of the present invention, the indication is presented by an output generator (not shown) included in system 500.

System 500 preferably further includes data representation analytics 560, which preferably accesses the outputs of data representation storage 522 and data representation storages 522 from multiple client environments 550, which are typically physically remote from each other. As represented in FIG. 5A by an arrow 562, data representation analytics 560 preferably provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to problems with speed and cost. In contrast, system 500 preferably communicates between data storage locations only changes made to data records. Thus, system 500 communicates significantly less data than prior art systems, leading to improved technical performance of system 500 relative to prior art systems, such as improved speed and cost. Additionally, system 500 allows users, such as managers and strategists, to access and view up-to-date information as data elements 503 are edited in database 504 by at least one user, ensuring the accuracy of performance reviews or security surveillance monitoring which users have permissions relating to particular ones of data elements 503.

Output of data representation analytics 560 may be automatic or in response to an input from an analysis trigger 570, such as a query. Inputs to data representation analytics 560 from analysis trigger 570 may be manual, such as a user report request, or automatic, such as scheduled time-based queries or rule-based queries.

In a preferred embodiment of the present invention, data representation analytics 560 is a utilization subsystem of system 500, and data representation analytics 560 employs post-event data representation information 508 contained in updated data representations 505.

It is a particular feature of an embodiment of the present invention, exemplified by FIGS. 5A & 5B, that the bandwidth requirements for communication between the various client environments 550 and data representation analytics 560 are relatively low, since only differences between data element information 507 and data representation information 508 are communicated by local data representation storage 522 to data representation analytics 560, thereby providing substantially greater latency and lower cost than that of prior art systems, which transmit all data element information and/or data element content for all data elements in a database, whether or not the data elements have been changed.

It is appreciated that system 500 may be operative to monitor enterprise-wide data systems which may include one billion data elements 503. It is further appreciated that system 500 is operative to enable updating of all data elements 503 being monitored in near-real time, typically in less than one minute.

It is appreciated that, as distinct from the embodiments of FIGS. 1A-3B, the embodiment of FIGS. 5A & 5B includes DRIG 524, which is located outside of local client environment 550, and has access to data representation storages 522 in other client environments 550. As in the embodiments of FIGS. 2A-4B, the embodiment of FIGS. 5A & 5B is distinct from the embodiment of FIGS. 1A & 1B due to the inclusion of DRIG 524. The embodiments of FIGS. 2A-5B have the advantage of reduced bandwidth requirement, faster speed and lower cost compared with the embodiment of FIGS. 1A & 1B.

The embodiment of FIGS. 5A & 5B is similar to the embodiment of FIGS. 3A & 3B, while distinct from the embodiments of FIGS. 2A, 2B, 4A & 4B, in the retrieval of post-event data element 503 by DRIG 524. Namely, post-event data element 503 is obtained by DRIG 524 from difference reporter 520, which obtains post-event data element 503 from database 504. DRIG 524 may access database 504 while retrieving similar data element 503 which provides pre-event data representation information 508.

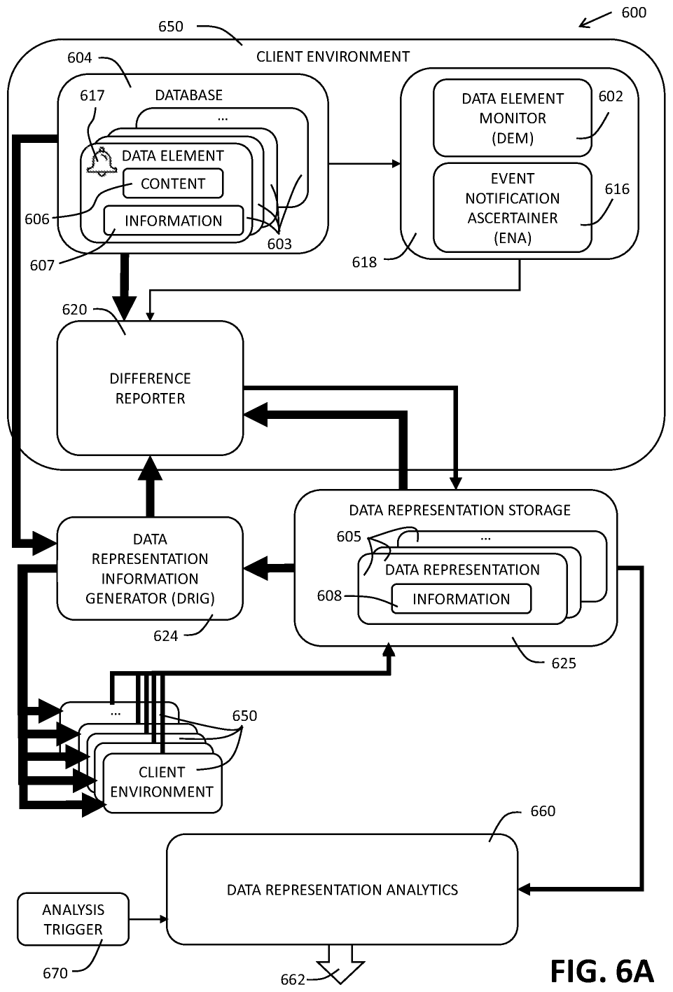

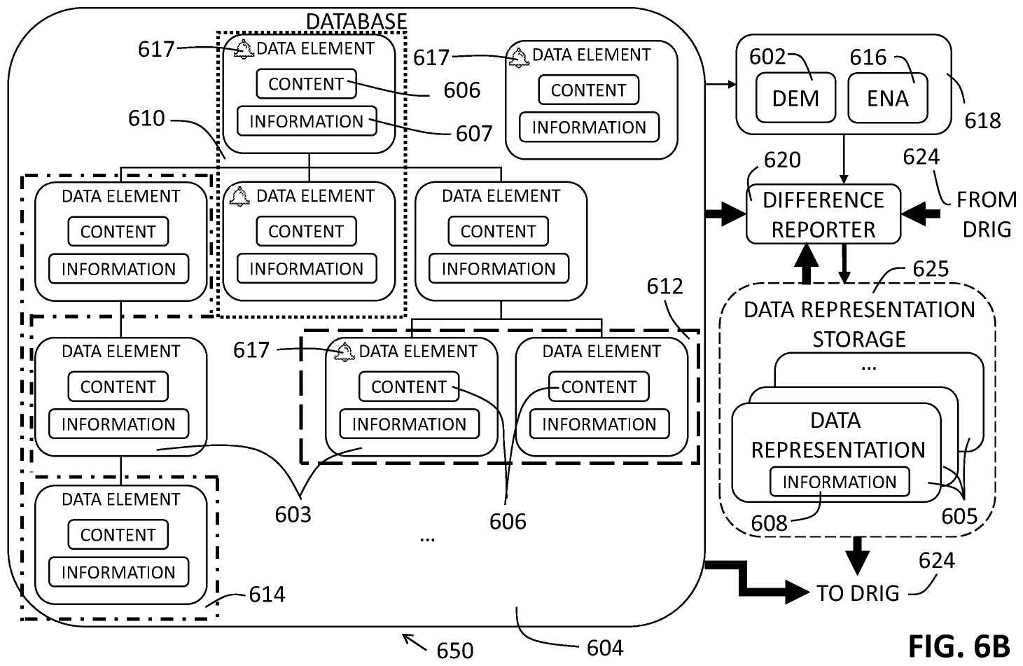

Reference is now made to FIG. 6A, which is a simplified functional block diagram of a system for monitoring data elements, constructed and operative in accordance with still another preferred embodiment of the present invention, and to FIG. 6B, which is a simplified functional block diagram of a portion of the system of FIG. 6A, showing particularly details of a database thereof.

As seen in FIGS. 6A & 6B, there is provided a system 600 for monitoring data elements including a data element monitor (DEM) 602, monitoring a multiplicity of data elements 603, typically stored in a data element database 604. In a preferred embodiment of the present invention, some of data elements 603 have associated therewith a corresponding stored data representation 605, while others of data elements 603 do not have associated therewith a corresponding stored data representation 605. Preferably each data element 603 includes data element content 606 and data element information 607, and each stored data representation 605 includes data representation information 608, corresponding to at least a subset of data element information 607.

An example of a suitable DEM 602 is described in U.S. Pat. No. 11,030,307. Examples of data elements 603 are described hereinbelow with reference to FIGS. 15A-18D. Examples of a suitable data element database 604 include, inter alia, a New Technology File System (NTFS), commercially available from Microsoft, a Hierarchical database, such as an IBM IMS, commercially available from IBM, a commercially available object-oriented database, such as a commercially available ObjectStore database from IgniteTech, and a document database, such as a database commercially available from MongoDB.

Data element content 606 is typically a raison d'être of a data element. For example, a data element 603 that is embodied as a text file often includes data element content 606 in the form of text that is displayed when the data element 603 is opened. Similarly, a data element 603 that is embodied as a video file often includes data element content 606 in the form of video and audio media to be displayed when the data element 603 is opened. As an additional example, a data element 603 that is embodied as an image file often includes data element content 606 in the form of a picture that is displayed when the data element 603 is opened.

Data element information 607 and data representation information 608, on the other hand, are typically supporting data associated with data element 603. For example, a data element 603 that is embodied as a file typically includes data element information 607 such as file properties, and the data element representation 605 associated with such a data element 603 preferably includes data representation information 608 that is identical to or a subset of the data element information 607 for that data element 603.

Data element information 607 and data representation information 608 may be any suitable information relating to data element 603 and data representation 605, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 603 are preferably editable. More specifically, preferably one or both of data element content 606 and data element information 607 can be changed, either manually, such as by a human user of database 604, or automatically, such as by an operational rule, for example, an auto reinstatement of permissions upon a return of a user from leave. A changing of a data element 603, including a creation or a deletion thereof, is referred to herein as an event. In one embodiment of the present invention, an accessing of a data element 603 constitutes an event. It is appreciated that when a particular data element 603 undergoes an event, data element content 606 and/or data element information 607 of that data element 603 is changed at the event. However, corresponding data representation information 608 is typically not immediately updated upon an event. Therefore, following a typical event for any data element 603, the data element content 606 of that data element 603 includes post-event content and the data element information 607 of that data element 603 includes post-event information, while the data representation information 608 of the stored data representation 605 corresponding to that data element 603, if one exists, includes pre-event information.

It is appreciated that when no stored data representation 605 exists for a particular data element 603, such as when a new data element 603 is created, system 600 typically assigns a default data representation 605 to that data element 603. In one embodiment of the present invention, the default data representation 605 assigned to such a data element 603 includes blank default data representation information 608, as in the example described hereinbelow with reference to FIG. 16C. In another embodiment of the present invention, the default data representation 605 assigned to such a data element 603 includes data representation information 608 copied from a data representation 605 corresponding to an existing data element 603 that is analogous or similar to the newly created data element 603, as in the example described hereinbelow with reference to FIG. 17C.

As seen particularly in FIG. 6B, data element database 604 may be any suitable database, but is preferably a hierarchical database in which various data elements 603 may be characterized by relationships of a family-tree type, such as parents and children. Thus, various pairs of data elements 603 may be characterized by a parent-child relationship 610, a sibling relationship 612 or a grandparent-grandchild relationship 614 therebetween. Similarly, various data elements 603 may be related to one another through other relationships known in the art, such as more complex family tree relationships, including, inter alia, nibling relationships and cousin relationships.

System 600 also includes an event notification ascertainer (ENA) 616, ascertaining which of data elements 603 being monitored has an event notification 617 associated therewith. An example of a suitable ENA 616 is an ENA described in U.S. U.S. Pat. No. 11,030,307. For simplicity, DEM 602 and ENA 616 are shown in FIGS. 6A & 6B as being part of a single block 618.

Preferably, DEM 602 identifies all data elements 603 that have recently undergone an event, such as, inter alia, a creation or a change as discussed hereinabove, subsequent to a previous output of block 618, and associates each of those data elements 603 with an event notification 617. As a result, all data elements 603 that have undergone a recent event are each associated with an event notification 617, and all data elements 603 that have not undergone a recent event are not associated with an event notification 617. As used herein, a recent event is an event that occurred subsequent to a previous output of block 618 to a difference reporter 620. Examples of events and event notifications 617 are further described hereinbelow with reference to FIGS. 15A-18D.

In a preferred embodiment of the present invention, event notification 617 is at least one of a notification of a change in data element content 606 and a change in data element information 607. A change in data element information 607 may include, inter alia, an actual access to a data element 603; a change in an access permission to a data element 603, such as a change in at least one of a read permission, a write permission and a delete permission; a change in metadata associated with data element 603; and a change in classification rule indications associated with data element 603, such as a change in a rule-based indication of whether or not data element 603 includes sensitive data element content 606.

An output of block 618 provides identification of those data elements 603 stored in data element database 604 which have a recent event notification 617 associated therewith. As used herein, a recent event notification 617 is an event notification 617 that was generated subsequent to a previous output of block 618 to difference reporter 620.

Difference reporter 620 reports, for those data elements 603 stored in data element database 604 which have a recent event notification 617 associated therewith, a difference between data element information 607, which is post-event data element information, and corresponding data representation information 608, which is pre-event data representation information. As described hereinabove, when no data representation information 608 exists for a particular data element 603, for example, when a new data element 603 is created, system 600 typically Assigns a default data representation 605 to that data element 603.

In the embodiment of FIGS. 6A & 6B, data representation information 608, which is pre-event data representation information, may be in a stored data representation 605 already associated with a corresponding data element 603 being monitored which has an event notification 617 associated therewith.

As distinct from the embodiment of FIGS. 1A & 1B, described above, in the embodiment of FIGS. 6A & 6B, when no stored data representation 605 exists, such as when a new data element 603 is created, a default data representation 605, including default data representation information 608, which represents pre-event data representation information, is preferably received by difference reporter 620 from a data representation information generator (DRIG) 624 and may be partially or entirely based on one or more stored data representations 605 not already associated with the corresponding data element 603 being monitored which has an event notification 617 associated therewith. These stored data representations 605 may be associated, for example, with data elements 603 having a family-tree type relationship with the corresponding data element 603 being monitored which has an event notification 617 associated therewith in a hierarchical data base 604, such as a parent-child relationship 610 or a sibling relationship 612.

DRIG 624 preferably receives input from data element database 604. The input received by DRIG 624 preferably includes corresponding data element information 607, which is post-event data element information, for data element 603 stored in data element database 604 which has an event notification 617 associated therewith. Additionally or alternatively, the input received by DRIG 624 includes data element content 606 for data element 603 stored in data element database 604 which has an event notification 617 associated therewith. This then enables DRIG 624 to obtain stored data representations 605, that are associated with other data elements 603 that are related to that data element 603 being monitored which has an event notification 617 associated therewith in hierarchical data base 604, from a non-local data representation storage 625 for use in providing the default data representation information 608.

In a preferred embodiment of the present invention, other data elements 603 that are analogous to and/or related to that data element 603 being monitored which has an event notification 617 associated therewith are associated with data representations 605 which are analogous to that data element 603 being monitored which has an event notification 617 associated therewith. Preferably, the at least one analogous data representation 605 has at least some similarity to that data element 603 being monitored which has an event notification 617 associated therewith. In one embodiment of the present invention, the similarity between the at least one analogous data representation 605 having at least some similarity to that data element 603 being monitored which has an event notification 617 associated therewith, is a similarity in data representation information 608 and that data element 603 being monitored which has an event notification 617 associated therewith. Additionally or alternatively, the similarity between the at least one analogous data representation 605 having at least some similarity to that data element 603 being monitored which has an event notification 617 associated therewith, is a similarity in data element content 606 of the data element 603 with which that data representation 605 is associated and that data element 603 being monitored which has an event notification 617 associated therewith.

For example, as described hereinabove, an analogous data representation 605, stored in data representation storage 625, could be similar to that data element 603 being monitored, which has an event notification 617 associated therewith, in that the analogous data representation 605 and the data element 603 being monitored, which has an event notification 617 associated therewith a family-tree type relationship. Additionally or alternatively, an analogous data representation 605, stored in data representation storage 625, could be similar to that data element 603 being monitored, which has an event notification 617 associated therewith, in that the analogous data representation 605 and the data element 603 being monitored, which has an event notification 617 associated therewith share, for example, a common data element creator or common keywords. Preferably, the first data representation 605, which is analogous to and/or is related to that data element 603 being monitored which has an event notification 617 associated therewith, found by DRIG 624 is sent to difference reporter 620.

As distinct from the embodiments of FIGS. 2A-3B, DRIG 624 is located outside of a physical client environment, here designated by reference numeral 650.

As distinct from the embodiments of FIGS. 1A-5B, DRIG 624 preferably communicates with data representation storage 625, which preferably includes stored data representations 605 from database 604 and from other databases 604 which may be at various other client environments 650. When no previous data representation information 608 exists for a data element 603, DRIG 624 typically generates a default data representation 605, including default data representation information 608, which represents pre-event data representation information, based on data representations 605 from analogous data elements 603 stored in various different databases 604 at various client environments 650. Alternatively, DRIG 624 may provide difference reporter 620 with a blank default data representation 605, including blank data representation information 608.

In the embodiment of FIGS. 6A & 6B, data element information 607, which is post-event data element information, and data element content 606, which is post-event data element content, are received by difference reporter 620 from data element database 604. In this embodiment, for each data element 603 having an event notification 617 associated therewith, difference reporter 620 provides to data representation storage 625 an output which represents a difference between data element information 607, which is post-event data element information, and corresponding data representation information 608, which is pre-event data representation information, received from data representation storage 625, or default data representation information 608 received from DRIG 624. This allows data element representation 605 in data representation storage 625 to be updated in accordance with the event, preferably by difference reporter 620, without having to transmit the entirety of post-event information 607 to data representation storage 625.

It is noted that unlike the embodiments of FIGS. 1A-5B, in the embodiment of FIGS. 6A & 6B, there is no local data representation storage at client environment 650. It is appreciated that data representation storage 625 is outlined in dashed lines in FIG. 6B, indicating that data representation storage 625 is preferably not included in local client environment 650.

Preferably, as will be described hereinbelow, difference reporter 620 also includes a classification rule applicability determiner which indicates whether data element content 606 of data element 603 is subject to any classification rules. As described hereinbelow, in a preferred embodiment of the present invention, the classification rule applicability determiner checks data elements 603 for data element content 606 that is subject to particular rules, such as stringent privacy measures. Examples of classification rules and their applicability are described hereinbelow with reference to FIGS. 15A-18D. Preferably, difference reporter 620 provides classification rules of data elements 603 to local data representation storage 622, but difference reporter 620 does not provide data element content 606 itself to local data representation storage 622.

System 600 preferably further presents to at least one human user a visually sensible indication of output from difference reporter 620 following an identification by DEM 602 and ENA 616 of those of multiplicity of data elements 603 that have recently undergone a change and accordingly an update by difference reporter 620 of data representations 605. The indication is typically generated upon a user accessing data representation storage 625, whereupon updated data representations 605 including, but not limited to, changes made since the previous execution of elements within system 600 are accessible to the user and preferably displayed. In a preferred embodiment of the present invention, the indication is presented by an output generator (not shown) included in system 600.

System 600 preferably further includes data representation analytics 660, which preferably accesses the outputs of collective data representation storage 625. As represented in FIG. 6A by an arrow 662, data representation analytics 660 provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to problems with speed and cost. In contrast, system 600 preferably communicates between data storage locations only changes made to data records. Thus, system 600 communicates significantly less data than prior art systems, leading to improved technical performance of system 600 relative to prior art systems, such as improved speed and cost. Additionally, system 600 allows users, such as managers and strategists, to access and view up-to-date information as data elements 603 are edited in database 604 by at least one user, ensuring the accuracy of performance reviews or security surveillance monitoring which users have permissions relating to particular ones of data elements 603.

Output of data representation analytics 660 may be automatic or in response to an input from an analysis trigger 670, such as a query. Inputs to data representation analytics 660 from analysis trigger 670 may be manual, such as a user report request, or automatic, such as scheduled time-based queries or rule-based queries.

In a preferred embodiment of the present invention, data representation analytics 660 is a utilization subsystem of system 600, and data representation analytics 660 employs post-event data representation information 608 contained in updated data representations 605.

It is a particular feature of an embodiment of the present invention, exemplified by FIGS. 6A & 6B, that the bandwidth requirements for communication between the various client environments 650 and data representation analytics 660 are relatively low, since only differences in data element information 607 and data representation information 608 are communicated, thereby providing substantially greater latency and lower cost than that of prior art systems, which transmit all data element information and/or data element content for all data elements in a database, whether or not the data elements have been changed.

It is appreciated that system 600 may be operative to monitor enterprise-wide data systems which may include one billion data elements 603. It is further appreciated that system 600 is operative to enable updating of all data elements 603 being monitored in near-real time, typically in less than one minute.

It is appreciated that, as distinct from the embodiments of FIGS. 1A-5B, the embodiment of FIGS. 6A & 6B contains no local data representation storage inside the local client environment 650. Instead, system 600 updates data representation storage 625 located outside of local client environment 650.

The embodiment of FIGS. 6A & 6B is similar to the embodiments of FIGS. 4A-5B as it contains DRIG 624 located outside of local client environment 650, and with access to data representation storages 622 in other client environments 650. As in the embodiments of FIGS. 2A-5B, the embodiment of FIGS. 6A & 6B is distinct from the embodiment of FIGS. 1A & 1B due to the inclusion of DRIG 624. The embodiments of FIGS. 2A-6B have the advantage of reduced bandwidth requirement, faster speed and lower cost compared with the embodiment of FIGS. 1A & 1B.

The embodiment of FIGS. 6A & 6B is similar to the embodiments of FIGS. 2A, 2B, 4A & 4B while distinct from the embodiments of FIGS. 3A, 3B, 5A & 5B regarding the retrieval of post-event data element 603 by DRIG 624. Namely, post-event data element 603 is obtained by DRIG 624 from database 604, whereas in the embodiments of FIGS. 3A, 3B, 5A & 5B, respective post-event data element 303 or 503 is obtained by respective DRIG 324 or 524 from respective difference reporter 320 or 520, which obtains respective post-event data element 303 or 503 from respective database 304 or 504.

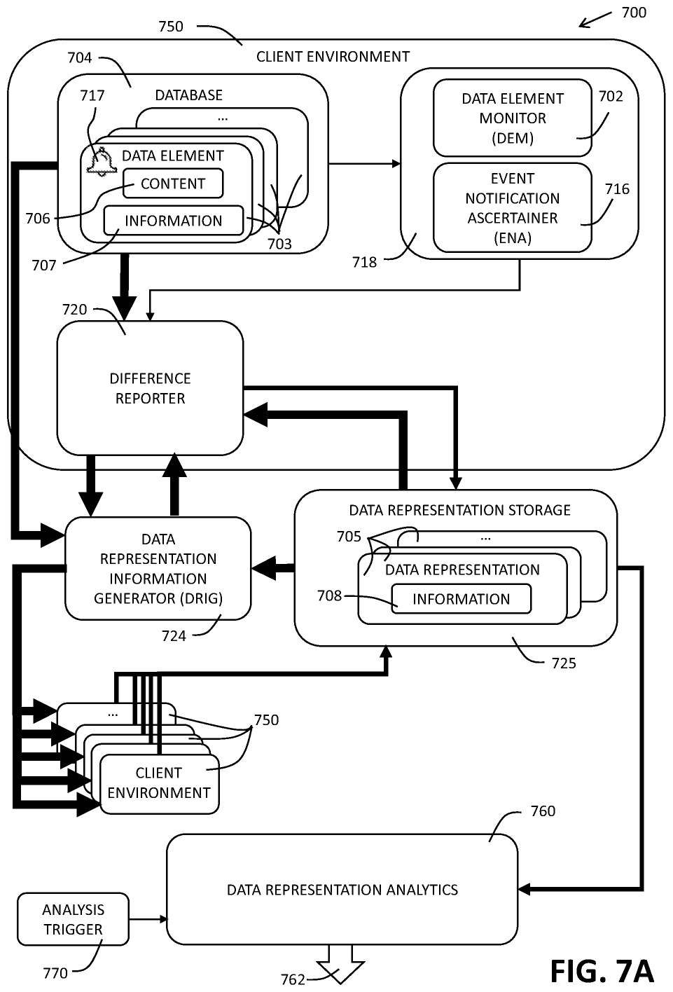

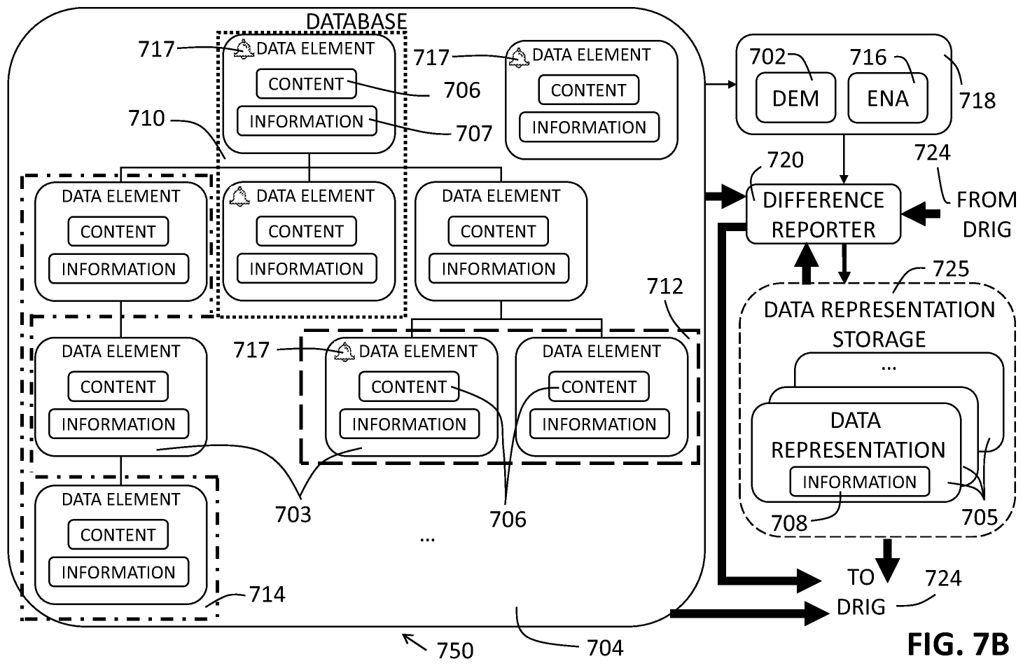

Reference is now made to FIG. 7A, which is a simplified functional block diagram of a system for monitoring data elements, constructed and operative in accordance with still another preferred embodiment of the present invention, and to FIG. 7B, which is a simplified functional block diagram of a portion of the system of FIG. 7A, showing particularly details of a database thereof.

As seen in FIGS. 7A & 7B, there is provided a system 700 for monitoring data elements including a data element monitor (DEM) 702, monitoring a multiplicity of data elements 703, typically stored in a data element database 704. In a preferred embodiment of the present invention, some of data elements 703 have associated therewith a corresponding stored data representation 705, while others of data elements 703 do not have associated therewith a corresponding stored data representation 705. Preferably each data element 703 includes data element content 706 and data element information 707, and each stored data representation 705 includes data representation information 708, corresponding to at least a subset of data element information 707.

An example of a suitable DEM 702 is described in U.S. Pat. No. 11,030,307. Examples of data elements 703 are described hereinbelow with reference to FIGS. 15A-18D. Examples of a suitable data element database 704 include, inter alia, a New Technology File System (NTFS), commercially available from Microsoft, a Hierarchical database, such as an IBM IMS, commercially available from IBM, a commercially available object-oriented database, such as a commercially available ObjectStore database from IgniteTech, and a document database, such as a database commercially available from MongoDB.

Data element content 706 is typically a raison d'être of a data element. For example, a data element 703 that is embodied as a text file often includes data element content 706 in the form of text that is displayed when the data element 703 is opened. Similarly, a data element 703 that is embodied as a video file often includes data element content 706 in the form of video and audio media to be displayed when the data element 703 is opened. As an additional example, a data element 703 that is embodied as an image file often includes data element content 706 in the form of a picture that is displayed when the data element 703 is opened.

Data element information 707 and data representation information 708, on the other hand, are typically supporting data associated with data element 703. For example, a data element 703 that is embodied as a file typically includes data element information 707 such as file properties, and the data element representation 705 associated with such a data element 703 preferably includes data representation information 708 that is identical to or a subset of the data element information 707 for that data element 703.

Data element information 707 and data representation information 708 may be any suitable information relating to data element 703 and data representation 705, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 703 are preferably editable. More specifically, preferably one or both of data element content 706 and data element information 707 can be changed, either manually, such as by a human user of database 704, or automatically, such as by an operational rule, for example, an auto reinstatement of permissions upon a return of a user from leave. A changing of a data element 703, including a creation or a deletion thereof, is referred to herein as an event. In one embodiment of the present invention, an accessing of a data element 703 constitutes an event. It is appreciated that when a particular data element 703 undergoes an event, data element content 706 and/or data element information 707 of that data element 703 is changed at the event. However, corresponding data representation information 708 is typically not immediately updated upon an event. Therefore, following a typical event for any data element 703, the data element content 706 of that data element 703 includes post-event content and the data element information 707 of that data element 703 includes post-event information, while the data representation information 708 of the stored data representation 705 corresponding to that data element 703, if one exists, includes pre-event information.

It is appreciated that when no stored data representation 705 exists for a particular data element 703, such as when a new data element 703 is created, system 700 typically assigns a default data representation 705 to that data element 703. In one embodiment of the present invention, the default data representation 705 assigned to such a data element 703 includes blank default data representation information 708, as in the example described hereinbelow with reference to FIG. 16C. In another embodiment of the present invention, the default data representation 705 assigned to such a data element 703 includes data representation information 708 copied from a data representation 705 corresponding to an existing data element 703 that is analogous or similar to the newly created data element 703, as in the example described hereinbelow with reference to FIG. 17C.

As seen particularly in FIG. 7B, data element database 704 may be any suitable database, but is preferably a hierarchical database in which various data elements 703 may be characterized by relationships of a family-tree type, such as parents and children. Thus, various pairs of data elements 703 may be characterized by a parent-child relationship 710, a sibling relationship 712 or a grandparent-grandchild relationship 714 therebetween. Similarly, various data elements 703 may be related to one another through other relationships known in the art, such as more complex family tree relationships, including, inter alia, nibling relationships and cousin relationships.

System 700 also includes an event notification ascertainer (ENA) 716, ascertaining which of data elements 703 being monitored has an event notification 717 associated therewith. An example of a suitable ENA 716 is an ENA described in U.S. Pat. No. 11,030,307. For simplicity, DEM 702 and ENA 716 are shown in FIGS. 7A & 7B as being part of a single block 718.

Preferably, DEM 702 identifies all data elements 703 that have recently undergone an event, such as, inter alia, a creation or a change as discussed hereinabove, subsequent to a previous output of block 718, and associates each of those data elements 703 with an event notification 717. As a result, all data elements 703 that have undergone a recent event are each associated with an event notification 717, and all data elements 703 that have not undergone a recent event are not associated with an event notification 717. As used herein, a recent event is an event that occurred subsequent to a previous output of block 718 to a difference reporter 720. Examples of events and event notifications 717 are further described hereinbelow with reference to FIGS. 15A-18D.

In a preferred embodiment of the present invention, event notification 717 is at least one of a notification of a change in data element content 706 and a change in data element information 707. A change in data element information 707 may include, inter alia, an actual access to a data element 703; a change in an access permission to a data element 703, such as a change in at least one of a read permission, a write permission and a delete permission; a change in metadata associated with data element 703; and a change in classification rule indications associated with data element 703, such as a change in a rule-based indication of whether or not data element 703 includes sensitive data element content 706.

An output of block 718 provides identification of those data elements 703 stored in data element database 704 which have a recent event notification 717 associated therewith. As used herein, a recent event notification 717 is an event notification 717 that was generated subsequent to a previous output of block 718 to difference reporter 720.

Difference reporter 720 reports, for those data elements 703 stored in data element database 704 which have a recent event notification 717 associated therewith, a difference between data element information 707, which is post-event data element information, and corresponding data representation information 708, which is pre-event data representation information. As described hereinabove, when no data representation information 708 exists for a particular data element 703, for example, when a new data element 703 is created, system 700 typically assigns a default data representation 705 to that data element 703.

In the embodiment of FIGS. 7A & 7B, data representation information 708, which is pre-event data representation information, may be in a stored data representation 705 already associated with a corresponding data element 703 being monitored which has an event notification 717 associated therewith.

As distinct from the embodiment of FIGS. 1A & 1B, described above, in the embodiment of FIGS. 7A & 7B, when no stored data representation 705 exists, such as when a new data element 703 is created, a default data representation 705, including default data representation information 708, which represents pre-event data representation information, is preferably received by difference reporter 720 from a data representation information generator (DRIG) 724 and may be partially or entirely based on one or more stored data representations 705 not already associated with the corresponding data element 703 being monitored which has an event notification 717 associated therewith. These stored data representations 705 may be associated, for example, with data elements 703 having a family-tree type relationship with the corresponding data element 703 being monitored which has an event notification 717 associated therewith in a hierarchical data base 704, such as a parent-child relationship 710 or a sibling relationship 712.

DRIG 724 preferably receives input from difference reporter 720. The input received by DRIG 724 preferably includes corresponding data element information 707, which is post-event data element information, for data element 703 stored in data element database 704 which has an event notification 717 associated therewith. Additionally or alternatively, the input received by DRIG 724 includes data element content 706 for data element 703 stored in data element database 704 which has an event notification 717 associated therewith. This then enables DRIG 724 to obtain stored data representations 705, that are associated with other data elements 703 that are analogous to and/or related to that data element 703 being monitored which has an event notification 717 associated therewith in hierarchical data base 704, from a non-local data representation storage 725 for use in providing the default data representation information 708.

In a preferred embodiment of the present invention, other data elements 703 that are analogous to and/or related to that data element 703 being monitored which has an event notification 717 associated therewith are associated with data representations 705 which are analogous to that data element 703 being monitored which has an event notification 717 associated therewith. Preferably, the at least one analogous data representation 705 has at least some similarity to that data element 703 being monitored which has an event notification 717 associated therewith. In one embodiment of the present invention, the similarity between the at least one analogous data representation 705 having at least some similarity to that data element 703 being monitored which has an event notification 717 associated therewith, is a similarity in data representation information 708 and that data element 703 being monitored which has an event notification 717 associated therewith. Additionally or alternatively, the similarity between the at least one analogous data representation 705 having at least some similarity to that data element 703 being monitored which has an event notification 717 associated therewith, is a similarity in data element content 706 of the data element 703 with which that data representation 705 is associated and that data element 703 being monitored which has an event notification 717 associated therewith.

For example, as described hereinabove, an analogous data representation 705, stored in data representation storage 725, could be similar to that data element 703 being monitored, which has an event notification 717 associated therewith, in that the analogous data representation 705 and the data element 703 being monitored, which has an event notification 717 associated therewith a family-tree type relationship. Additionally or alternatively, an analogous data representation 705, stored in data representation storage 725, could be similar to that data element 703 being monitored, which has an event notification 717 associated therewith, in that the analogous data representation 705 and the data element 703 being monitored, which has an event notification 717 associated therewith share, for example, a common data element creator or common keywords. Preferably, the first data representation 705, which is analogous to and/or is related to that data element 703 being monitored which has an event notification 717 associated therewith, found by DRIG 724 is sent to difference reporter 720.

As distinct from the embodiments of FIGS. 2A-3B, DRIG 724 is located outside of a physical client environment, here designated by reference numeral 750.

As distinct from the embodiments of FIGS. 1A-5B, DRIG 724 preferably communicates with data representation storage 725, which preferably includes stored data representations 705 from database 704 and from other databases 704 which may be at various other client environments 750. When no previous data representation information 708 exists for a data element 703, DRIG 724 typically generates a default data representation 705, including default data representation information 708, which represents pre-event data representation information, based on data representations 705 from analogous data elements 703 stored in various different databases 704 at various client environments 750. Alternatively, DRIG 724 may provide difference reporter 720 with a blank default data representation 705, including blank data representation information 708.

In the embodiment of FIGS. 7A & 7B, data element information 707, which is post-event data element information, and data element content 706, which is post-event data element content, are received by difference reporter 720 from data element database 704. In this embodiment, for each data element 703 having an event notification 717 associated therewith, difference reporter 720 provides to data representation storage 725 an output which represents a difference between data element information 707, which is post-event data element information, and corresponding data representation information 708, which is pre-event data representation information, received from data representation storage 725, or default data representation information 708 received from DRIG 724. This allows data element representation 705 in data representation storage 725 to be updated in accordance with the event, preferably by difference reporter 720, without having to transmit the entirety of post-event information 707 to data representation storage 725. It is appreciated that additionally or alternatively, DRIG 724 may access database 704 while retrieving similar data element 703 which is associated with default data representation information 708.

It is noted that unlike the embodiments of FIGS. 1A-5B, in the embodiment of FIGS. 7A & 7B, there preferably is no local data representation storage at client environment 750. It is appreciated that data representation storage 725 is outlined in dashed lines in FIG. 7B, indicating that data representation storage 725 is preferably not included in local client environment 750.

Preferably, as will be described hereinbelow, difference reporter 720 also includes a classification rule applicability determiner which indicates whether data element content 706 of data element 703 is subject to any classification rules. As described hereinbelow, in a preferred embodiment of the present invention, the classification rule applicability determiner checks data elements 703 for data element content 706 that is subject to particular rules, such as stringent privacy measures. Examples of classification rules and their applicability are described hereinbelow with reference to FIGS. 15A-18D. Preferably, difference reporter 720 provides classification rules of data elements 703 to local data representation storage 722, but difference reporter 720 does not provide data element content 706 itself to local data representation storage 722.

System 700 preferably further presents to at least one human user a visually sensible indication of output from difference reporter 720 following an identification by DEM 702 and ENA 716 of those of multiplicity of data elements 703 that have recently undergone a change and accordingly an update by difference reporter 720 of data representations 705. The indication is typically generated upon a user accessing data representation storage 725, whereupon updated data representations 705 including, but not limited to, changes made since the previous execution of elements within system 700 are accessible to the user and preferably displayed. In a preferred embodiment of the present invention, the indication is presented by an output generator (not shown) included in system 700.

System 700 preferably further includes data representation analytics 760, which preferably accesses the outputs of collective data representation storage 725. As represented in FIG. 7A by an arrow 762, data representation analytics 760 provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to problems with speed and cost. In contrast, system 700 preferably communicates between data storage locations only changes made to data records. Thus, system 700 communicates significantly less data than prior art systems, leading to improved technical performance of system 700 relative to prior art systems, such as improved speed and cost. Additionally, system 700 allows users, such as managers and strategists, to access and view up-to-date information as data elements 703 are edited in database 704 by at least one user, ensuring the accuracy of performance reviews or security surveillance monitoring which users have permissions relating to particular ones of data elements 703.

Output of data representation analytics 760 may be automatic or in response to an input from an analysis trigger 770, such as a query. Inputs to data representation analytics 760 from analysis trigger 770 may be manual, such as a user report request, or automatic, such as scheduled time-based queries or rule-based queries.

In a preferred embodiment of the present invention, data representation analytics 760 is a utilization subsystem of system 700, and data representation analytics 760 employs post-event data representation information 708 contained in updated data representations 705.

It is a particular feature of an embodiment of the present invention, exemplified by FIGS. 7A & 7B, that the bandwidth requirements for communication between the various client environments 750 and data representation analytics 760 are relatively low, since only differences in data element information 707 and data representation information 708 are communicated, thereby providing substantially greater latency and lower cost than that of prior art systems, which transmit all data element information and/or data element content for all data elements in a database, whether or not the data elements have been changed.

It is appreciated that system 700 may be operative to monitor enterprise-wide data systems which may include one billion data elements 703. It is further appreciated that system 700 is operative to enable updating of all data elements 703 being monitored in near-real time, typically in less than one minute.

It is appreciated that, as distinct from the embodiments of FIGS. 1A-5B, the embodiment of FIGS. 7A & 7B contains no local data representation storage inside local client environment 750. Similarly to the embodiment of FIGS. 6A & 6B, system 700 updates data representation storage 725 located outside of the local client environment 750.

The embodiment of FIGS. 7A & 7B is similar to the embodiments of FIGS. 4A-6B in that the embodiment of FIGS. 7A & 7B includes DRIG 724 located outside of local client environment 750. As in the embodiments of FIGS. 2A-6B, the embodiment of FIGS. 7A & 7B is distinct from the embodiment of FIGS. 1A & 1B due to the inclusion of DRIG 724. The embodiments of FIGS. 2A-7B have the advantage of reduced bandwidth requirement, faster speed and lower cost compared with the embodiment of FIGS. 1A & 1B.

The embodiment of FIGS. 7A & 7B is similar to the embodiments of FIGS. 3A, 3B, 5A & 5B while distinct from the embodiments of FIGS. 2A, 2B, 4A, 4B, 6A & 6B in the retrieval of post-event data element 703 by DRIG 724. Namely, post-event data element 703 is obtained by DRIG 724 from difference reporter 720, which itself obtains post-event data element 703 from database 704. DRIG 724 may access database 704 while retrieving similar data element 703 which provides pre-event data representation information 708.

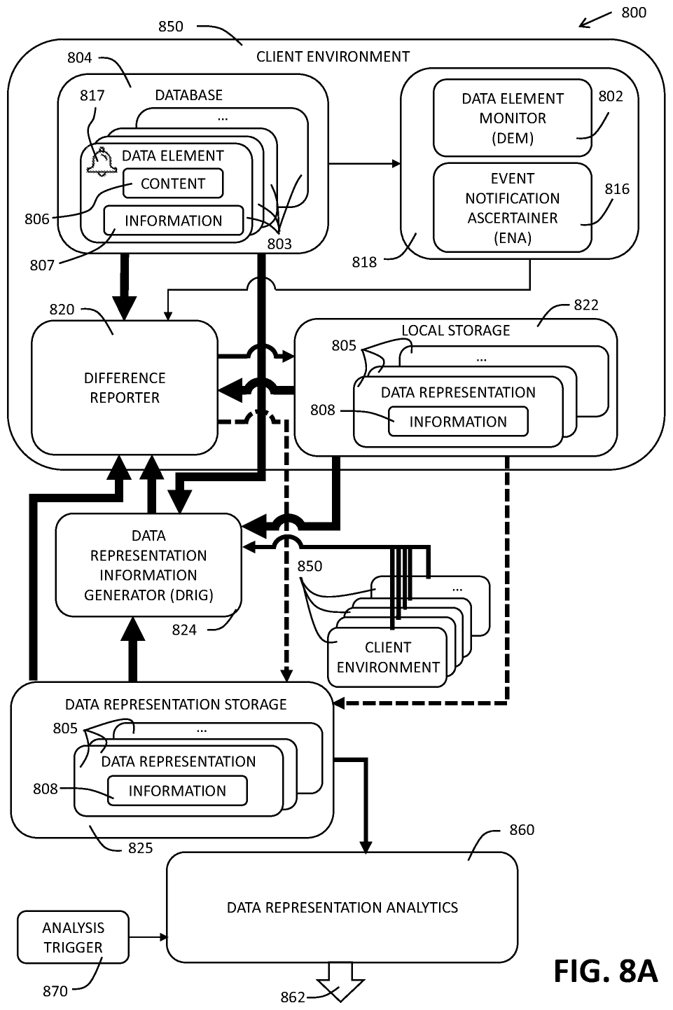

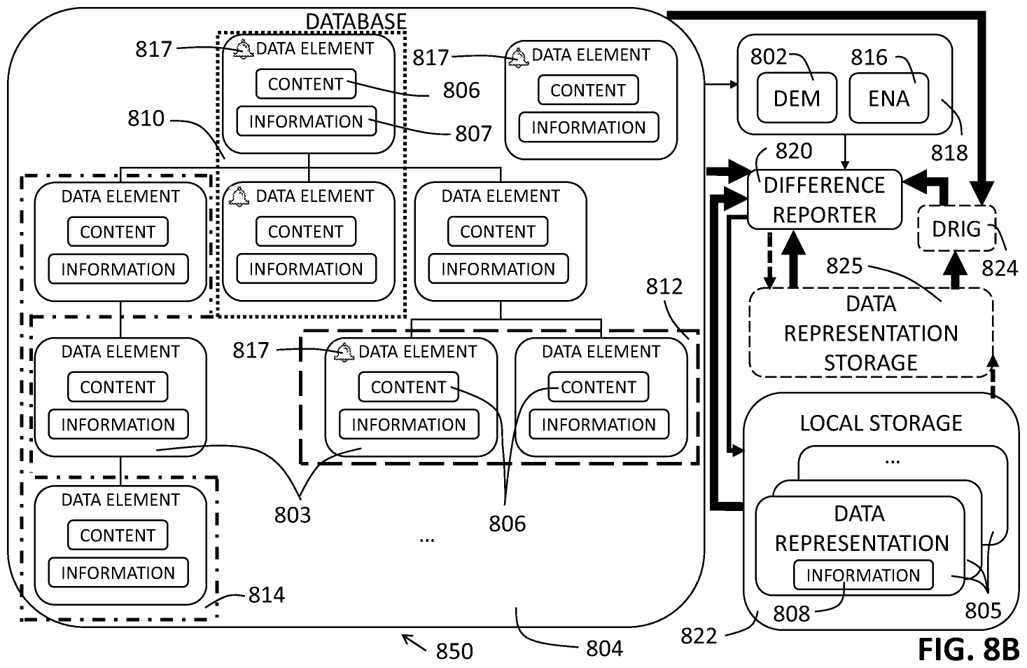

Reference is now made to FIG. 8A, which is a simplified functional block diagram of a system for monitoring data elements, constructed and operative in accordance with a further preferred embodiment of the present invention, and to FIG. 8B, which is a simplified functional block diagram of a portion of the system of FIG. 8A, showing particularly details of a database thereof.

As seen in FIGS. 8A & 8B, there is provided a system 800 for monitoring data elements including a data element monitor (DEM) 802, monitoring a multiplicity of data elements 803, typically stored in a data element database 804. In a preferred embodiment of the present invention, some of data elements 803 have associated therewith a corresponding stored data representation 805, while others of data elements 803 do not have associated therewith a corresponding stored data representation 805. Preferably, each data element 803 includes data element content 806 and data element information 807, and each stored data representation 805 includes data representation information 808, corresponding to at least a subset of data element information 807.

An example of a suitable DEM 802 is described in U.S. Pat. No. 11,030,307. Examples of data elements 803 are described hereinbelow with reference to FIGS. 15A-18D. Examples of a suitable data element database 404 include, inter alia, a New Technology File System (NTFS), commercially available from Microsoft, a Hierarchical database, such as an IBM IMS, commercially available from IBM, a commercially available object-oriented database, such as a commercially available ObjectStore database from IgniteTech, and a document database, such as a database commercially available from MongoDB.

Data element content 806 is typically a raison d'être of a data element. For example, a data element 803 that is embodied as a text file often includes data element content 806 in the form of text that is displayed when the data element 803 is opened. Similarly, a data element 803 that is embodied as a video file often includes data element content 806 in the form of video and audio media to be displayed when the data element 803 is opened. As an additional example, a data element 803 that is embodied as an image file often includes data element content 806 in the form of a picture that is displayed when the data element 803 is opened.

Data element information 807 and data representation information 808, on the other hand, are typically supporting data associated with data element 803. For example, a data element 803 that is embodied as a file typically includes data element information 807 such as file properties, and the data element representation 805 associated with such a data element 803 preferably includes data representation information 808 that is identical to or a subset of the data element information 807 for that data element 803.

Data element information 807 and data representation information 808 may be any suitable information relating to data element 803 and data representation 805, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 803 are preferably editable. More specifically, preferably one or both of data element content 806 and data element information 807 can be changed, cither manually, such as by a human user of database 804, or automatically, such as by an operational rule, for example, an auto reinstatement of permissions upon a return of a user from leave. A changing of a data element 803, including a creation or a deletion thereof, is referred to herein as an event. In one embodiment of the present invention, an accessing of a data element 803 constitutes an event. It is appreciated that when a particular data element 803 undergoes an event, data element content 806 and/or data element information 807 of that data element 803 is changed at the event. However, corresponding data representation information 808 is typically not immediately updated upon an event. Therefore, following a typical event for any data element 803, the data element content 806 of that data element 803 includes post-event content and the data element information 807 includes post-event information, while the data representation information 808 of the stored data representation 805 corresponding to that data element 803, if one exists, includes pre-event information.

It is appreciated that when no stored data representation 805 exists for a particular data element 803, such as when a new data element 803 is created, system 800 typically assigns a default data representation 805 to that data element 803. In one embodiment of the present invention, the default data representation 805 assigned to such a data element 803 includes blank default data representation information 808, as in the example described hereinbelow with reference to FIG. 16C. In another embodiment of the present invention, the default data representation 805 assigned to such a data element 803 includes data representation information 808 copied from a data representation 805 corresponding to an existed data element 803 that is analogous or similar to the newly created data element 803, as in the example described hereinbelow with reference to FIG. 17C.

As seen particularly in FIG. 8B, data element database 804 may be any suitable database, but is preferably a hierarchical database in which various data elements 803 may be characterized by relationships of a family-tree type, such as parents and children. Thus, various pairs of data elements 803 may be characterized by a parent-child relationship 810, a sibling relationship 812 or a grandparent-grandchild relationship 814 therebetween. Similarly, various data elements 803 may be related to one another through other relationships known in the art, such as more complex family tree relationships, including, inter alia, nibling relationships and cousin relationships.

System 800 also includes an event notification ascertainer (ENA) 816, ascertaining which of data elements 803 being monitored has an event notification 817 associated therewith. An example of a suitable ENA 816 is an ENA described in U.S. Pat. No. 11,030,307. For simplicity, DEM 802 and ENA 816 are shown in FIGS. 8A & 8B as being part of a single block 818.

Preferably, DEM 802 identifies all data elements 803 that have recently undergone an event, such as, inter alia, a creation or a change as discussed hereinabove, subsequent to a previous output of block 818, and associates each of those data elements 803 with an event notification 817. As a result, all data elements 803 that have undergone a recent event are each associated with an event notification 817, and all data elements 803 that have not undergone a recent event are not associated with an event notification 817. As used herein, a recent event is an event that occurred subsequent to a previous output of block 818 to a difference reporter 820. Examples of events and event notifications 817 are further described hereinbelow with reference to FIGS. 15A-18D.

In a preferred embodiment of the present invention, event notification 817 is at least one of a notification of a change in data element content 806 and a change in data element information 807. A change in data element information 807 may include, inter alia, an actual access to a data element 803; a change in an access permission to a data element 803, such as a change in at least one of a read permission, a write permission and a delete permission; a change in metadata associated with data element 803; and a change in classification rule indications associated with data element 803, such as a change in a rule-based indication of whether or not data element 803 includes sensitive data element content 806.

An output of block 818 provides identification of those data elements 803 stored in data element database 804 which have a recent event notification 817 associated therewith. As used herein, a recent event notification 817 is an event notification 817 that was generated subsequent to a previous output of block 818 to difference reporter 820.

Difference reporter 820 reports, for those data elements 803 stored in data element database 804 which have a recent event notification 817 associated therewith, a difference between data element information 807, which is post-event data element information, and corresponding data representation information 808, which is pre-event data representation information. As described hereinabove, when no data representation information 808 exists for a particular data element 803, for example, when a new data element 803 is created, system 800 typically assigns a default data representation 805 to that data element 803.

System 800 preferably further includes a local data representation storage 822, which contains stored data representations 805. In the embodiment of FIGS. 8A & 8B, data representation information 808, which is pre-event data representation information, may be located in local data representation storage 822, more particularly in a stored data representation 805 already associated with a corresponding data element 803 being monitored which has an event notification 817 associated therewith.

In the embodiment of FIGS. 8A & 8B, data element information 807, which is post-event data element information, and data element content 806, which is post-event data element content, are received by difference reporter 820 from data element database 804. In this embodiment, for each data element 803 having an event notification 817 associated therewith, difference reporter 820 provides to local data representation storage 822 an output which represents a difference between data element information 807, which is post-event data element information, and corresponding data representation information 808, which is pre-event data representation information, received from local data representation storage 822 or a collective data representation storage 825, or default data representation information 808 received from a Data Representation Information Generator (DRIG) 824. This allows data element representation 805 to be updated in accordance with the event, preferably by difference reporter 820, without having to transmit the entirety of post-event information 807 to local data representation storage 822. In an alternative embodiment of the present invention, difference reporter 820 provides to collective data representation storage 825 an output which represents a difference between data element information 807, which is post-event data element information, and corresponding data representation information 808, which is pre-event data representation information. Both embodiments are indicated by dashed arrows on FIGS. 8A & 8B.

As distinct from the embodiment of FIGS. 1A & 1B, described above, in the embodiment of FIGS. 8A & 8B, when no stored data representation 805 exists, such as when a new data element 803 is created, a default data representation 805, including default data representation information 808, which represents pre-event data representation information, is preferably received from DRIG 824 and may be partially or entirely based on one or more stored data representations 805 not already associated with the corresponding data element 803 being monitored which has an event notification 817 associated therewith. These stored data representations 805 may be associated, for example, with data elements 803 having a family-tree type relationship with the corresponding data element 803 being monitored which has an event notification 817 associated therewith in a hierarchical data base 804, such as a parent-child relationship 810 or a sibling relationship 812.

DRIG 824 preferably receives input from data element database 804. The input received by DRIG 824 preferably includes corresponding data element information 807, which is post-event data element information, for data element 803 stored in data element database 804 which has an event notification 817 associated therewith. Additionally or alternatively, the input received by DRIG 824 includes data element content 806 for data element 803 stored in data element database 804 which has an event notification 817 associated therewith. This then enables DRIG 824 to obtain stored data representations 805, that are associated with other data elements 803 that are related to that data element 803 being monitored which has an event notification 817 associated therewith in hierarchical data base 804, from local data representation storage 822 and/or data representation storage 825 for use in providing the default data representation information 808, as described hereinbelow.

In a preferred embodiment of the present invention, other data elements 803 that are analogous to and/or related to that data element 803 being monitored which has an event notification 817 associated therewith are associated with data representations 805 which are analogous to that data element 803 being monitored which has an event notification 817 associated therewith. Preferably, the at least one analogous data representation 805 has at least some similarity to that data element 803 being monitored which has an event notification 817 associated therewith. In one embodiment of the present invention, the similarity between the at least one analogous data representation 805 having at least some similarity to that data element 803 being monitored which has an event notification 817 associated therewith, is a similarity in data representation information 808 and that data element 803 being monitored which has an event notification 817 associated therewith. Additionally or alternatively, the similarity between the at least one analogous data representation 805 having at least some similarity to that data element 803 being monitored which has an event notification 817 associated therewith, is a similarity in data element content 806 of the data element 803 with which that data representation 805 is associated and that data element 803 being monitored which has an event notification 817 associated therewith.

For example, as described hereinabove, an analogous data representation 805, stored in data representation storage 825, could be similar to that data element 803 being monitored, which has an event notification 817 associated therewith, in that the analogous data representation 805 and the data element 803 being monitored, which has an event notification 817 associated therewith a family-tree type relationship. Additionally or alternatively, an analogous data representation 805, stored in local data representation storage 822 and/or in other client environments 850 and/or in data representation storage 825, could be similar to that data element 803 being monitored, which has an event notification 817 associated therewith, in that the analogous data representation 805 and the data element 803 being monitored, which has an event notification 817 associated therewith share, for example, a common data element creator or common keywords. Preferably, the first data representation 805, which is analogous to and/or is related to that data element 803 being monitored which has an event notification 817 associated therewith, found by DRIG 824 is sent to difference reporter 820.

As distinct from the embodiments of FIGS. 2A-3B, DRIG 824 is located outside of a physical client environment, here designated by reference numeral 850, and communicates with data representation storage 825 relating to multiple client environments 850, which are typically physically remote from each other. When no previous data representation information 808 exists for a data element 803, DRIG 824 typically generates a default data representation 805, including default data representation information 808, which represents pre-event data representation information, based on data representations 805 from analogous data elements 803 stored in local data representation storage 822 and/or data representation storage 825 related to various client environments 850. Alternatively, DRIG 824 may provide difference reporter 820 with a blank default data representation 805, including blank data representation information 808. It is appreciated that DRIG 824 is outlined in dashed lines in FIG. 8B, indicating that DRIG 824 is preferably not included in local client environment 850.

As distinct from the embodiments of FIGS. 1A-5B, DRIG 824 preferably communicates with collective data representation storage 825, which preferably includes stored data representations 805 corresponding to data elements 803 from database 804 and from other databases 804 which may be at various client environments 850. Preferably, for data elements 803 stored in database 804 having an event notification 817 associated therewith, collective data representation storage 825 receives an input from difference reporter 820 of a difference between data element information 807, which is post-event data element information, and corresponding data representation information 808, which is pre-event data representation information. Collective data representation storage 825 also receives inputs from difference reporters 820 at different client environments 850 of a difference between data element information 807, which is post-event data element information, and corresponding data representation information 808, which is pre-event data representation information, for data representations 805 stored in corresponding data representation storage 825 at such other client environments 850. It is appreciated that data representation storage 825 is outlined in dashed lines in FIG. 8B, indicating that data representation storage 825 is preferably not included in local client environment 850.

As distinct from the embodiments of FIGS. 6A-7B, in the embodiment of FIGS. 8A & 8B, there is provided local data representation storage 822 at client environment 850. Local data representation storage 822 provides an output, preferably representing a periodic transfer of changes occurring in the contents of local data representation storage 822, to collective data representation storage 825. In a preferred embodiment of the present invention, local data representation storage 822 outputs to collective data representation storage 825 only changes to data representation information 808 which occurred subsequent to a previous output from local data representation storage 822 to collective data representation storage 825.

Preferably, as will be described hereinbelow, difference reporter 820 also includes a classification rule applicability determiner which indicates whether data element content 806 of data element 803 is subject to any classification rules. As described hereinbelow, in a preferred embodiment of the present invention, the classification rule applicability determiner checks data elements 803 for data element content 806 that is subject to particular rules, such as stringent privacy measures. Examples of classification rules and their applicability are described hereinbelow with reference to FIGS. 15A-18D. Preferably, difference reporter 820 provides classification rules of data elements 803 to local data representation storage 822, but difference reporter 820 does not provide data element content 806 itself to local data representation storage 822.

System 800 preferably further presents to at least one human user a visually sensible indication of output from difference reporter 820 following an identification by DEM 802 and ENA 816 of those of multiplicity of data elements 803 that have recently undergone a change and accordingly an update by difference reporter 820 of data representations 805. The indication is typically generated upon a user accessing local data representation storage 822 or data representation storage 825, whereupon updated data representations 805 including, but not limited to, changes made since the previous execution of elements within system 800 are accessible to the user and preferably displayed. In a preferred embodiment of the present invention, the indication is presented by an output generator (not shown) included in system 800.

System 800 preferably further includes data representation analytics 860, which preferably accesses the output of collective data representation storage 825. As represented in FIG. 8A by an arrow 862, data representation analytics 860 provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to problems with speed and cost. In contrast, system 800 preferably communicates between data storage locations only changes made to data records. Thus, system 800 communicates significantly less data than prior art systems, leading to improved technical performance of system 800 relative to prior art systems, such as improved speed and cost. Additionally, system 800 allows users, such as managers and strategists, to access and view up-to-date information as data elements 803 are edited in database 804 by at least one user, ensuring the accuracy of performance reviews or security surveillance monitoring which users have permissions relating to particular ones of data elements 803.

Output of data representation analytics 860 may be automatic or in response to an input from an analysis trigger 870, such as a query. Inputs to data representation analytics 860 from analysis trigger 870 may be manual, such as a user report request, or automatic, such as scheduled time-based queries or rule-based queries.

In a preferred embodiment of the present invention, data representation analytics 860 is a utilization subsystem of system 800, and data representation analytics 860 employs post-event data representation information 808 contained in updated data representations 805.

It is a particular feature of an embodiment of the present invention, exemplified by FIGS. 8A & 8B, that the bandwidth requirements for communication between the various client environments 850 and data representation storage 825 are relatively low, due to the fact that only the differences between data element information 807 and corresponding data representation information 808 are communicated, thereby providing greater latency and lower cost than that of prior art systems, which transmit all data element information and/or data element content for all data elements in a database, whether or not the data elements have been changed.

It is appreciated that system 800 may be operative to monitor enterprise-wide data systems which may include one billion data elements 803. It is further appreciated that system 800 is operative to enable updating of all data elements 803 being monitored in near-real time, typically in less than one minute.

It is appreciated that similarly to the embodiments of FIGS. 1A-5B, the embodiment of FIGS. 8A & 8B contains local data representation storage 822 inside local client environment 850. However, similarly to the embodiments of FIGS. 6A-7B, the embodiment of FIGS. 8A & 8B also includes data representation storage 825 located outside of local client environment 850. System 800 updates both local data representation storage 822 and data representation storage 825. The embodiment of FIGS. 8A & 8B is similar to the embodiments of FIGS. 4A-7B in that the embodiment of FIGS. 8A & 8B includes DRIG 824, which is located outside of local client environment 850, and which accesses data representation storages 822 in other client environments 850.

As in the embodiments of FIGS. 2A-7B, the embodiment of FIGS. 8A & 8B is distinct from the embodiment of FIGS. 1A & 1B due to the inclusion of DRIG 824. The embodiments of FIGS. 2A-8B have the advantage of reduced bandwidth requirement, faster speed and lower cost compared with the embodiment of FIGS. 1A & 1B.

The embodiment of FIGS. 8A & 8B is similar to the embodiments FIGS. 2A, 2B, 4A, 4B, 6A & 6B while distinct from the embodiments of FIGS. 3A, 3B, 5A, 5B, 7A & 7B in the retrieval of post-event data element 803 by DRIG 824. Namely, post-event data element 803 is obtained by DRIG 824 from database 804.

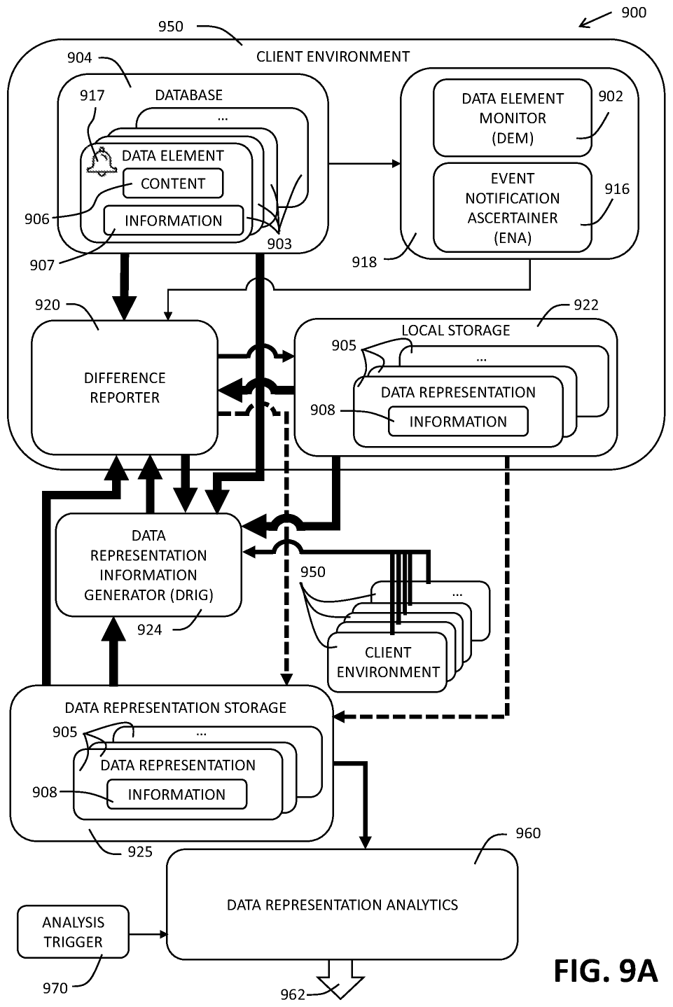

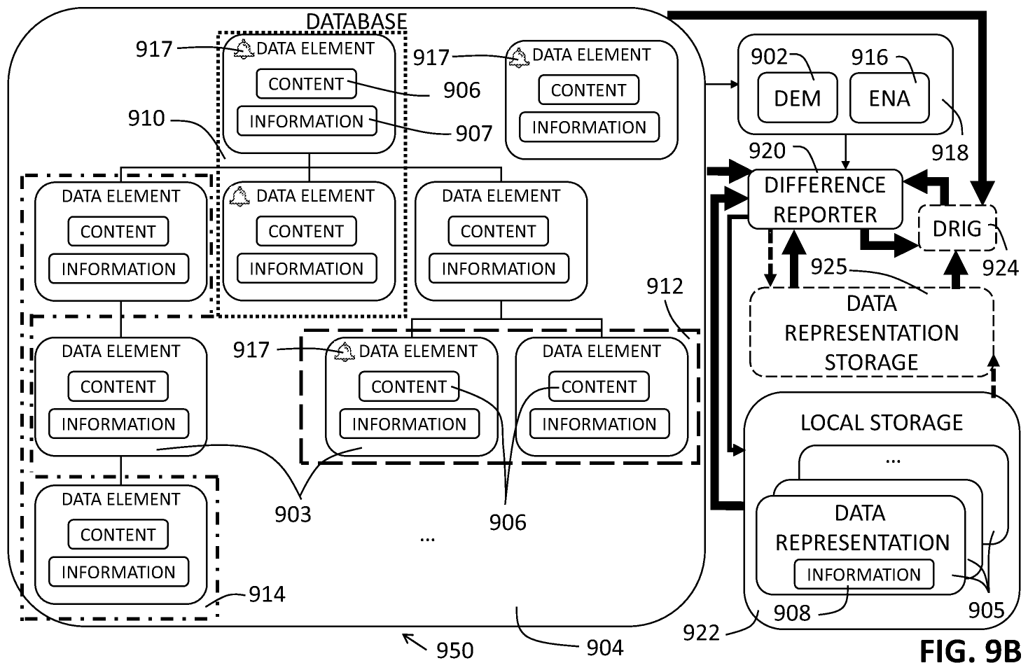

Reference is now made to FIG. 9A, which is a simplified functional block diagram of a system for monitoring data elements, constructed and operative in accordance with a further preferred embodiment of the present invention, and to FIG. 9B, which is a simplified functional block diagram of a portion of the system of FIG. 9A, showing particularly details of a database thereof.

As seen in FIGS. 9A & 9B, there is provided a system 900 for monitoring data elements including a data element monitor (DEM) 902, monitoring a multiplicity of data elements 903, typically stored in a data element database 904. In a preferred embodiment of the present invention, some of data elements 903 have associated therewith a corresponding stored data representation 905, while others of data elements 903 do not have associated therewith a corresponding stored data representation 905. Preferably, each data element 903 includes data element content 906 and data element information 907, and each stored data representation 905 includes data representation information 908, corresponding to at least a subset of data element information 907.

An example of a suitable DEM 902 is described in U.S. Pat. No. 11,030,307. Examples of data elements 903 are described hereinbelow with reference to FIGS. 15A-18D. Examples of a suitable data element database 404 include, inter alia, a New Technology File System (NTFS), commercially available from Microsoft, a Hierarchical database, such as an IBM IMS, commercially available from IBM, a commercially available object-oriented database, such as a commercially available ObjectStore database from IgniteTech, and a document database, such as a database commercially available from MongoDB.

Data element content 906 is typically a raison d'être of a data element. For example, a data element 903 that is embodied as a text file often includes data element content 906 in the form of text that is displayed when the data element 903 is opened. Similarly, a data element 903 that is embodied as a video file often includes data element content 906 in the form of video and audio media to be displayed when the data element 903 is opened. As an additional example, a data element 903 that is embodied as an image file often includes data element content 906 in the form of a picture that is displayed when the data element 903 is opened.

Data element information 907 and data representation information 908, on the other hand, are typically supporting data associated with data element 903. For example, a data element 903 that is embodied as a file typically includes data element information 907 such as file properties, and the data element representation 905 associated with such a data element 903 preferably includes data representation information 908 that is identical to or a subset of the data element information 907 for that data element 903.

Data element information 907 and data representation information 908 may be any suitable information relating to data element 903 and data representation 905, respectively, including, inter alia, permissions, including a list of users and permission types thereof; metadata, such as, inter alia, a data element name, a data element creation time, a data element creation location, a data element access time, a data element access location, a data element modification time, a data element modification location, a data element size, at least one data element tag, a name of a user that created a data element, a name of a user that modified a data element, a preferred program associated with a data element, a data element storage location, a data element artist, a data element track number, a data element resolution, at least one data element software requirement; and classification rules, which are discussed hereinbelow with reference to FIGS. 15A-18D.

Data elements 903 are preferably editable. More specifically, preferably one or both of data element content 906 and data element information 907 can be changed, either manually, such as by a human user of database 904, or automatically, such as by an operational rule, for example, an auto reinstatement of permissions upon a return of a user from leave. A changing of a data element 903, including a creation or a deletion thereof, is referred to herein as an event. In one embodiment of the present invention, an accessing of a data element 903 constitutes an event. It is appreciated that when a particular data element 903 undergoes an event, data element content 906 and/or data element information 907 of that data element 903 is changed at the event. However, corresponding data representation information 908 is typically not immediately updated upon an event. Therefore, following a typical event for any data element 903, the data element content 906 of that data element 903 includes post-event content and the data element information 907 includes post-event information, while the data representation information 908 of the stored data representation 905 corresponding to that data element 903, if one exists, includes pre-event information.

It is appreciated that when no stored data representation 905 exists for a particular data element 903, such as when a new data element 903 is created, system 900 typically assigns a default data representation 905 to that data element 903. In one embodiment of the present invention, the default data representation 905 assigned to such a data element 903 includes blank default data representation information 908, as in the example described hereinbelow with reference to FIG. 16C. In another embodiment of the present invention, the default data representation 905 assigned to such a data element 903 includes data representation information 908 copied from a data representation 905 corresponding to an existing data element 903 analogous or similar to the newly created data element 903, as in the example described hereinbelow with reference to FIG. 17C.

As seen particularly in FIG. 9B, data element database 904 may be any suitable database, but is preferably a hierarchical database in which various data elements 903 may be characterized by relationships of a family-tree type, such as parents and children. Thus, various pairs of data elements 903 may be characterized by a parent-child relationship 910, a sibling relationship 912 or a grandparent-grandchild relationship 914 therebetween. Similarly, various data elements 903 may be related to one another through other relationships known in the art, such as more complex family tree relationships, including, inter alia, nibling relationships and cousin relationships.

System 900 also includes an event notification ascertainer (ENA) 916, ascertaining which of data elements 903 being monitored has an event notification 917 associated therewith. An example of a suitable ENA 916 is an ENA described in U.S. Pat. No. 11,030,307. For simplicity, DEM 902 and ENA 916 are shown in FIGS. 9A & 9B as being part of a single block 918.

Preferably, DEM 902 identifies all data elements 903 that have recently undergone an event, such as, inter alia, a creation or a change as discussed hereinabove, subsequent to a previous output of block 918, and associates each of those data elements 903 with an event notification 917. As a result, all data elements 903 that have undergone a recent event are each associated with an event notification 917, and all data elements 903 that have not undergone a recent event are not associated with an event notification 917. As used herein, a recent event is an event that occurred subsequent to a previous output of block 918 to a difference reporter 920. Examples of events and event notifications 917 are further described hereinbelow with reference to FIGS. 15A-18D.

In a preferred embodiment of the present invention, event notification 917 is at least one of a notification of a change in data element content 906 and a change in data element information 907. A change in data element information 907 may include, inter alia, an actual access to a data element 903; a change in an access permission to a data element 903, such as a change in at least one of a read permission, a write permission and a delete permission; a change in metadata associated with data element 903; and a change in classification rule indications associated with data element 903, such as a change in a rule-based indication of whether or not data element 903 includes sensitive data element content 906.

An output of block 918 provides identification of those data elements 903 stored in data element database 904 which have a recent event notification 917 associated therewith. As used herein, a recent event notification 917 is an event notification 917 that was generated subsequent to a previous output of block 918 to difference reporter 920.

Difference reporter 920 reports, for those data elements 903 stored in data element database 904 which have a recent event notification 917 associated therewith, a difference between data element information 907, which is post-event data element information, and corresponding data representation information 908, which is pre-event data representation information. As described hereinabove, when no data representation information 908 exists for a particular data element 903, for example, when a new data element 903 is created, system 900 typically assigns a default data representation 905 to that data element 903.

System 900 preferably further includes a local data representation storage 922, which contains stored data representations 905. In the embodiment of FIGS. 9A & 9B, data representation information 908, which is pre-event data representation information, may be located in local data representation storage 922, more particularly in a stored data representation 905 already associated with a corresponding data element 903 being monitored which has an event notification 917 associated therewith.

In the embodiment of FIGS. 9A & 9B, data element information 907, which is post-event data element information, and data element content 906, which is post-event data element content, are received by difference reporter 920 from data element database 904. In this embodiment, for each data element 903 having an event notification 917 associated therewith, difference reporter 920 provides to local data representation storage 922 an output which represents a difference between data element information 907, which is post-event data element information, and corresponding data representation information 908, which is pre-event data representation information, received from local data representation storage 922 or a collective data representation storage 925, or default data representation information 908 received from a Data Representation Information Generator (DRIG) 924. This allows data element representation 905 to be updated in accordance with the event, preferably by difference reporter 920, without having to transmit the entirety of post-event information 907 to local data representation storage 922. In an alternative embodiment of the present invention, difference reporter 920 provides to collective data representation storage 925 an output which represents a difference between data element information 907, which is post-event data element information, and corresponding data representation information 908, which is pre-event data representation information. Both embodiments are indicated by dashed arrows on FIGS. 9A & 9B

As distinct from the embodiment of FIGS. 1A & 1B, described above, in the embodiment of FIGS. 9A & 9B, when no stored data representation 905 exists, such as when a new data element 903 is created, a default data representation 905, including default data representation information 908, which represents pre-event data representation information, is preferably received from DRIG 924 and may be partially or entirely based on one or more stored data representations 905 not already associated with the corresponding data element 903 being monitored which has an event notification 917 associated therewith. These stored data representations 905 may be associated, for example, with data elements 903 having a family-tree type relationship with the corresponding data element 903 being monitored which has an event notification 917 associated therewith in a hierarchical data base 904, such as a parent-child relationship 910 or a sibling relationship 912.

DRIG 924 preferably receives input from difference reporter 920. The input received by DRIG 924 preferably includes corresponding data element information 907, which is post-event data element information, for data element 903 stored in data element database 904 which has an event notification 917 associated therewith. Additionally or alternatively, the input received by DRIG 924 includes data element content 906 for data element 903 stored in data element database 904 which has an event notification 917 associated therewith. This then enables DRIG 924 to obtain stored data representations 905, that are associated with other data elements 903 that are related to that data element 903 being monitored which has an event notification 917 associated therewith in hierarchical data base 904, from local data representation storage 922 and/or data representation storage 925 for use in providing the default data representation information 908, as described hereinbelow.

In a preferred embodiment of the present invention, other data elements 903 that are analogous to and/or related to that data element 903 being monitored which has an event notification 917 associated therewith are associated with data representations 905 which are analogous to that data element 903 being monitored which has an event notification 917 associated therewith. Preferably, the at least one analogous data representation 905 has at least some similarity to that data element 903 being monitored which has an event notification 917 associated therewith. In one embodiment of the present invention, the similarity between the at least one analogous data representation 905 having at least some similarity to that data element 903 being monitored which has an event notification 917 associated therewith, is a similarity in data representation information 908 and that data element 903 being monitored which has an event notification 917 associated therewith. Additionally or alternatively, the similarity between the at least one analogous data representation 905 having at least some similarity to that data element 903 being monitored which has an event notification 917 associated therewith, is a similarity in data element content 906 of the data element 903 with which that data representation 905 is associated and that data element 903 being monitored which has an event notification 917 associated therewith.

For example, as described hereinabove, an analogous data representation 905, stored in data representation storage 925, could be similar to that data element 903 being monitored, which has an event notification 917 associated therewith, in that the analogous data representation 905 and the data element 903 being monitored, which has an event notification 917 associated therewith a family-tree type relationship. Additionally or alternatively, an analogous data representation 905, stored in local data representation storage 922 and/or in other client environments 950 and/or in data representation storage 925, could be similar to that data element 903 being monitored, which has an event notification 917 associated therewith, in that the analogous data representation 905 and the data element 903 being monitored, which has an event notification 917 associated therewith share, for example, a common data element creator or common keywords. Preferably, the first data representation 905, which is analogous to and/or is related to that data element 903 being monitored which has an event notification 917 associated therewith, found by DRIG 924 is sent to difference reporter 920.

As distinct from the embodiments of FIGS. 2A-3B, DRIG 924 is located outside of a physical client environment, here designated by reference numeral 950, and communicates with data representation storage 925 relating to multiple client environments 950, which are typically physically remote from each other. When no previous data representation information 908 exists for a data element 903, DRIG 924 typically generates a default data representation 905, including default data representation information 908, which represents pre-event data representation information, based on data representations 905 from analogous data elements 903 stored in local data representation storage 922 and/or data representation storage 925 related to various client environments 950. Alternatively, DRIG 924 may provide difference reporter 920 with a blank default data representation 905, including blank data representation information 908. It is appreciated that DRIG 924 is outlined in dashed lines in FIG. 9B, indicating that DRIG 924 is preferably not included in local client environment 950.

As distinct from the embodiments of FIGS. 1A-5B, DRIG 924 preferably communicates with collective data representation storage 925, which preferably includes stored data representations 905 corresponding to data elements 903 from database 904 and from other databases 904 which may be at various client environments 950. Preferably, for data elements 903 stored in database 904 having an event notification 917 associated therewith, collective data representation storage 925 receives an input from difference reporter 920 of a difference between data element information 907, which is post-event data element information, and corresponding data representation information 908, which is pre-event data representation information. Collective data representation storage 925 also receives inputs from difference reporters 920 at different client environments 950 of a difference between data element information 907, which is post-event data element information, and corresponding data representation information 908, which is pre-event data representation information, for data representations 905 stored in corresponding data representation storage 925 at such other client environments 950. It is appreciated that additionally or alternatively, DRIG 924 may access database 904 while retrieving similar data element 903 which provides pre-event data representation information 908. It is appreciated that data representation storage 925 is outlined in dashed lines in FIG. 9B, indicating that data representation storage 925 is preferably not included in local client environment 950.

As distinct from the embodiments of FIGS. 6A-7B, in the embodiment of FIGS. 9A & 9B, there is provided local data representation storage 922 at client environment 950. Local data representation storage 922 provides an output, preferably representing a periodic transfer of changes occurring in the contents of local data representation storage 922, to collective data representation storage 925. In a preferred embodiment of the present invention, local data representation storage 922 outputs to collective data representation storage 925 only changes to data representation information 908 which occurred subsequent to a previous output from local data representation storage 922 to collective data representation storage 925.

Preferably, as will be described hereinbelow, difference reporter 920 also includes a classification rule applicability determiner which indicates whether data element content 906 of data element 903 is subject to any classification rules. As described hereinbelow, in a preferred embodiment of the present invention, the classification rule applicability determiner checks data elements 903 for data element content 906 that is subject to particular rules, such as stringent privacy measures. Examples of classification rules and their applicability are described hereinbelow with reference to FIGS. 15A-18D. Preferably, difference reporter 920 provides classification rules of data elements 903 to local data representation storage 922, but difference reporter 920 does not provide data element content 906 itself to local data representation storage 922.

System 900 preferably further presents to at least one human user a visually sensible indication of output from difference reporter 920 following an identification by DEM 902 and ENA 916 of those of multiplicity of data elements 903 that have recently undergone a change and accordingly an update by difference reporter 920 of data representations 905. The indication is typically generated upon a user accessing local data representation storage 922 or data representation storage 925, whereupon updated data representations 905 including, but not limited to, changes made since the previous execution of elements within system 900 are accessible to the user and preferably displayed. In a preferred embodiment of the present invention, the indication is presented by an output generator (not shown) included in system 900.

System 900 preferably further includes data representation analytics 960, which preferably accesses the output of collective data representation storage 925. As represented in FIG. 9A by an arrow 962, data representation analytics 960 provides notifications and action outputs, such as security alarms, analyses of user behavior and analyses of system behavior. It is appreciated that in prior art systems having multiple copies of computerized data stored in multiple locations, the prior art system must communicate large amounts of data between data storage locations to ensure that records of data are kept updated, leading to problems with speed and cost. In contrast, system 900 preferably communicates between data storage locations only changes made to data records. Thus, system 900 communicates significantly less data than prior art systems, leading to improved technical performance of system 900 relative to prior art systems, such as improved speed and cost. Additionally, system 900 allows users, such as managers and strategists, to access and view up-to-date information as data elements 903 are edited in database 904 by at least one user, ensuring the accuracy of performance reviews or security surveillance monitoring which users have relating to particular ones of data elements 903.

Output of data representation analytics 960 may be automatic or in response to an input from an analysis trigger 970, such as a query. Inputs to data representation analytics 960 from analysis trigger 970 may be manual, such as a user report request, or automatic, such as scheduled time-based queries or rule-based queries.

In a preferred embodiment of the present invention, data representation analytics 960 is a utilization subsystem of system 900, and data representation analytics 960 employs post-event data representation information 908 contained in updated data representations 905.

It is a particular feature of an embodiment of the present invention, exemplified by FIGS. 9A & 9B, that the bandwidth requirements for communication between the various client environments 950 and data representation storage 925 are relatively low, due to the fact that only the differences between data element information 907 and corresponding data representation information 908 are communicated, thereby providing greater latency and lower cost than that of prior art systems, which transmit all data element information and/or data element content for all data elements in a database, whether or not the data elements have been changed.

It is appreciated that system 900 may be operative to monitor enterprise-wide data systems which may include one billion data elements 903. It is further appreciated that system 900 is operative to enable updating of all data elements 903 being monitored in near-real time, typically in less than one minute.

It is appreciated that, similarly to the embodiments of FIGS. 1A-5B, 8A & 8B, the embodiment of FIGS. 9A & 9B includes local data representation storage 922 inside local client environment 950. However, similarly to the embodiments of FIGS. 6A-8B, the embodiment of FIGS. 9A & 9B also includes data representation storage 925 located outside of local client environment 950, and system 900 updates both local data representation storage 922 and data representation storage 925. The embodiment of FIGS. 9A & 9B is similar to the embodiments of FIGS. 4A-8B in that the embodiment of FIGS. 9A & 9B includes DRIG 924 located outside of local client environment 950, and which accesses data representation storages 922 in other client environments 950.

As in the embodiments of FIGS. 2A-8B, the embodiment of FIGS. 9A & 9B is distinct from the embodiment of FIGS. 1A & 1B due to the inclusion of DRIG 924. The embodiments of FIGS. 2A-9B have the advantage of reduced bandwidth requirement, faster speed and lower cost compared with the embodiment of FIGS. 1A & 1B.

The embodiment of FIGS. 9A & 9B is similar to the embodiments of FIGS. 3A, 3B, 5A, 5B, 7A & 7B while distinct from the embodiments of FIGS. 2A, 2B, 4A, 4B, 6A, 6B, 8A & 8B in the retrieval of post-event data element 903. Namely, post-event data element 903 is obtained by DRIG 924 from difference reporter 920, which itself obtains post-event data element 903 from database 904. DRIG 924 may access database 904 while retrieving similar data element 903 which provides pre-event data representation information 908.

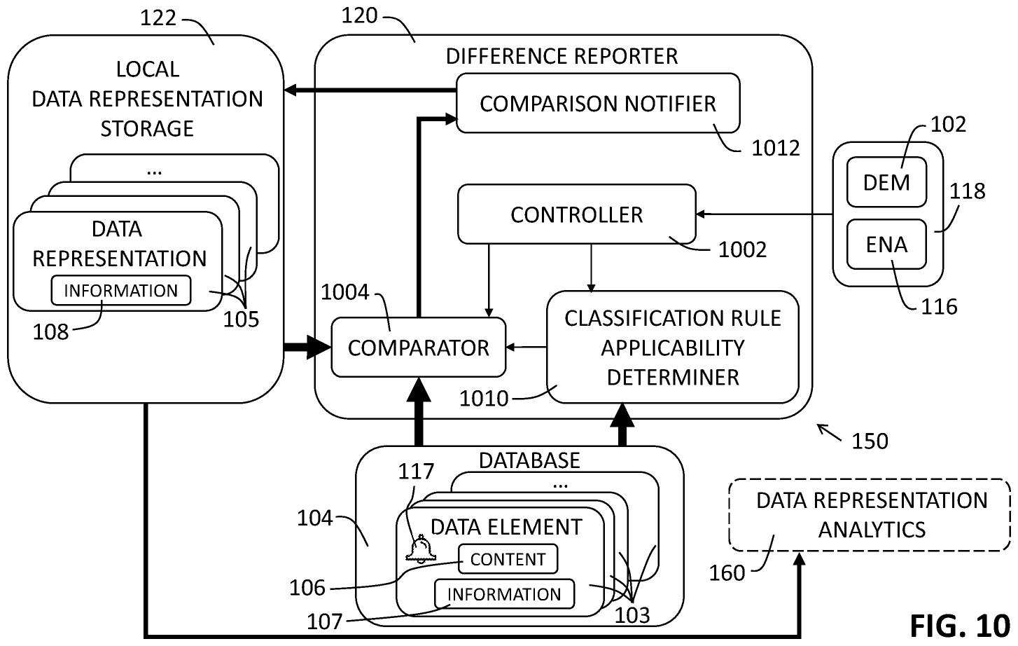

Reference is now made to FIG. 10, which is a simplified functional block diagram of a portion of system 100 in client environment 150 of FIGS. 1A & 1B, showing particularly details of difference reporter 120 thereof.

As seen in FIG. 10, difference reporter 120 includes a controller 1002, which receives an input from DEM 102 and ENA 116, collectively designated as block 118, and which identifies those data elements 103 stored in data element database 104 which have a recent event notification 117 associated therewith.

Controller 1002 provides a trigger output to a comparator 1004, preferably causing comparator 1004 to perform comparison functions only on data elements 103 stored in data element database 104, which have a recent event notification 117 associated therewith.

Comparator 1004 also preferably receives an input from data element database 104, which preferably includes corresponding data element information 107, which is post-event data element information, for each data element 103 stored in data element database 104 which has an event notification 117 associated therewith.

Preferably, difference reporter 120 also includes a classification rule applicability determiner 1010, which indicates whether data element content 106 of data element 103 is subject to any classification rules. As described hereinbelow, in a preferred embodiment of the present invention, classification rule applicability determiner 1010 checks data elements 103 for data element content 106 that is subject to particular rules, such as stringent privacy measures. Examples of classification rules and their applicability are described hereinbelow with reference to FIGS. 15A-18D.

Classification rule applicability determiner 1010 receives a trigger output from controller 1002, which indicates which of data elements 103 being monitored has an event notification 117 associated therewith, and also receives, from data element database 104, data element content 106, which is post-event data element content, for each data element 103 being monitored which has an event notification 117 associated therewith. Classification rule applicability determiner 1010 preferably provides an output to comparator 1004 indicating which, if any, classification rules apply to post-event data element content 106. In a preferred embodiment of the present invention, classification rules are included in data element information 107, which is post-event data element information, and thus, the output provided by classification rule applicability determiner 1010 to comparator 1004 is part of data element information 107, which is post-event data element information.

Comparator 1004 additionally preferably receives an input of data representation information 108, which is pre-event data representation information, from local data representation storage 122, which includes stored data representation information 108 taken from a stored data representation 105 already associated with each corresponding data element 103 being monitored, which has an event notification 117 associated therewith, which is stored in local data representation storage 122. As described hereinabove with reference to FIGS. 1A & 1B, when no data representation information 108 exists for a particular data element 103, for example, when a new data element 103 is created, system 100 typically assigns a default data representation 105 to that data element 103.

For each data element 103 being monitored which has an event notification 117 associated therewith, comparator 1004 is preferably operative to provide to a comparison notifier 1012 an output indicating a difference between data element information 107, which is post-event data element information, including data element information 107 provided both by database 104 and by classification rule applicability determiner 1010, and corresponding data representation information 108, which is pre-event data representation information or default data representation information.

Comparison notifier 1012 of difference reporter 120 preferably provides an output to local data representation storage 122, indicating a difference between data element information 107, which is post-event data element information, and corresponding data representation information 108, which is pre-event data representation information or default data representation information, thereby updating local data representation storage 122 based on the output received by comparison notifier 1012 from comparator 1004. Local data representation storage 122 in turn provides an output to data representation analytics 160. In a preferred embodiment of the present invention, the output provided by local data representation storage 122 to data representation analytics 160 includes all or substantially all of data element information 107, which is post-event data element information. In another embodiment of the present invention, the output provided by local data representation storage 122 to data representation analytics 160 indicates a difference between data element information 107, which is post-event data element information, and corresponding data representation information 108, which is pre-event data representation information or default data representation information. It is appreciated that data representation analytics 160 is outlined in dashed lines in FIG. 10, indicating that data representation analytics 160 is preferably not included in local client environment 150.

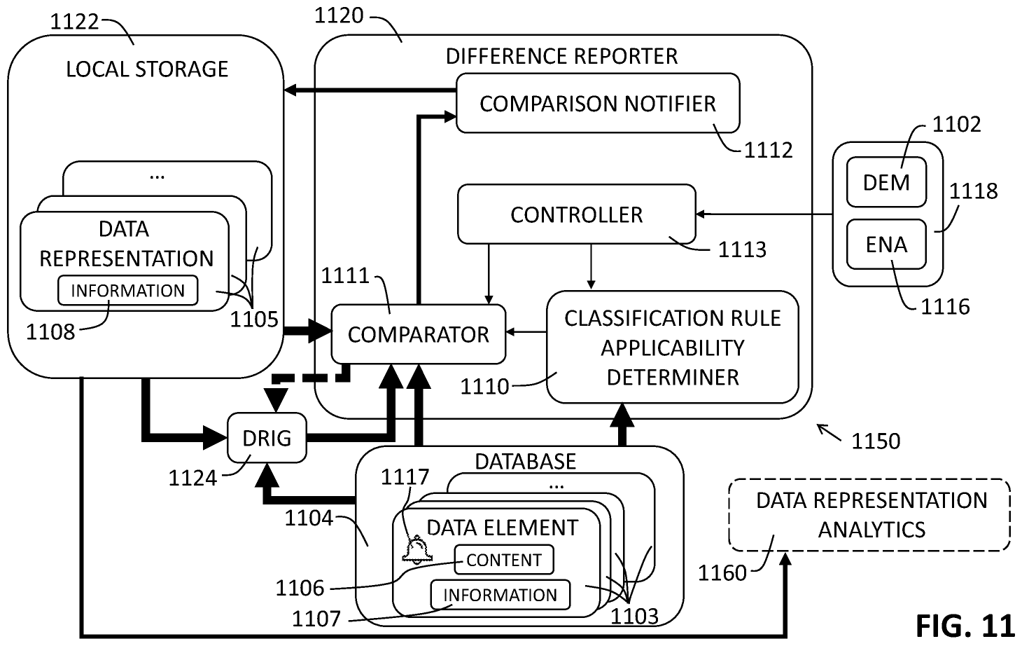

Reference is now made to FIG. 11, which is a simplified functional block diagram of a portion of respective systems 200 & 300 of FIGS. 2A & 2B and 3A & 3B, showing particularly details of difference reporter 220 and difference reporter 320 thereof, respectively.

In FIG. 11, a difference reporter 1120, such as difference reporter 220 or difference reporter 320, includes a controller 1113 which receives an input from a data element monitor (DEM) 1102, such as DEM 202 or DEM 302, and an event notification ascertainer (ENA) 1116, such as ENA 216 or ENA 316. DEM 1102 and ENA 1116 are collectively designated as a block 1118, much like DEM 202 and ENA 216 or DEM 302 and ENA 316 are collectively designated as block 218 and 318 respectively. Block 1118 monitors a plurality of data elements 1103, such as data elements 203 or data elements 303, in a database 1104, such as database 204 or database 304. Block 1118 identifies those data elements 1103 stored in data element database 1104 which have a recent event notification 1117 associated therewith, such as event notifications 217 or 317. Recent event notification 1117 is an event notification 1117 that was generated subsequent to a previous output of block 1118 to difference reporter 1120.

Controller 1113 provides a trigger output to a comparator 1111, preferably causing comparator 1111 to perform comparison functions only on data elements 1103 stored in data element database 1104 which have a recent event notification 1117 associated therewith.

Each data element 1103 in database 1104 has associated data element information 1107, such as data element information 207 or data element information 307, and associated data element content 1106, such as data element content 206 or data element content 306. Comparator 1111 also preferably receives an input from data element database 1104, which preferably includes corresponding data element information 1107. This input received by comparator 1111 is post-event data element information for each data element 1103 stored in data element database 1104 which has an event notification 1117 associated therewith.

Preferably, difference reporter 1120 also includes a classification rule applicability determiner 1110, which indicates whether data element content 1106 is subject to any classification rules. As described hereinbelow, in a preferred embodiment of the present invention, classification rule applicability determiner 1110 checks data elements 1103 for data element content 1106 that is subject to particular rules, such as stringent privacy measures. Examples of classification rules and their applicability are described hereinbelow with reference to FIGS. 15A-18D.

Classification rule applicability determiner 1110 receives a trigger output from controller 1113, which indicates which of data elements 1103 being monitored has an event notification 1117 associated therewith, and also receives, from data element database 1104, data element content 1106, which is post-event data element content, for each data element 1103 being monitored, which has an event notification 1117 associated therewith. Classification rule applicability determiner 1110 preferably provides an output to comparator 1111 indicating which, if any, classification rules apply to data element content 1106, which is post-event data element content. In a preferred embodiment of the present invention, classification rules are included in data element information 1107, which is post-event data information, and thus, the output provided by classification rule applicability determiner 1110 to comparator 1111 is part of data element information 1107, which is post-event data element information.

Comparator 1111 additionally preferably receives an input from a local data representation storage 1122, such as local data representation storage 222 or local data representation storage 322. Local data representation storage 1122 includes a plurality of data representations 1105, such as data representations 205 or data representations 305, each containing corresponding data representation information 1108, such as data representation information 208 or data representation information 308. This input received by comparator 1111 is pre-event data representation information to be associated with each corresponding data element 1103 being monitored, which has an event notification 1117 associated therewith. As described hereinabove with reference to FIGS. 2A-3B, when data element 1103 being monitored has no associated data representation information 1108, comparator 1111 preferably receives default data representation information 1108 generated from a data representation information generator (DRIG) 1124, such as DRIG 224 or DRIG 324. DRIG 1124 itself receives input either from database 1104, or comparator 1111 as described hereinabove and shown by a dashed arrow in FIG. 11.

For each data element 1103 being monitored which has an event notification 1117 associated therewith, comparator 1111 is preferably operative to provide to a comparison notifier 1112 an output indicating a difference between data element information 1107, which is post-event data element information, including data element information 1107 provided both by database 1104 and by classification rule applicability determiner 1110, and corresponding data representation information 1108, which is pre-event data representation information, or default data representation information, which represents pre-event data representation information.

Comparison notifier 1112 of difference reporter 1120 preferably provides an output to local data representation storage 1122, indicating a difference between data element information 1107, which is post-event data element information, and corresponding data representation information 1108, which is pre-event data representation information or default data representation information, thereby updating local data representation storage 1122 based on the output received by comparison notifier 1112 from comparator 1111. Local data representation storage 1122 in turn provides an output to a data representation analytics 1160, such as data representation analytics 260 or data representation analytics 360. In a preferred embodiment of the present invention, the output provided by local data representation storage 1122 to data representation analytics 1160 includes all or substantially all of data element information 1107, which is post-event data element information. In another embodiment of the present invention, the output provided by local data representation storage 1122 to data representation analytics 1160 indicates a difference between data element information 1107, which is post-event data element information, and corresponding data representation information 1108, which is pre-event data representation information or default data representation information. It is appreciated that data representation analytics 1160 is outlined in dashed lines in FIG. 11, indicating that data representation analytics 1160 is preferably not included in local client environment 1150.

It is appreciated that the embodiment of FIG. 11 differs from the embodiment of FIG. 10 in that the embodiment of FIG. 11 includes DRIG 1124. In a case where data element 1103 has a corresponding data representation 1105 prior to an event, the embodiment of FIG. 11 preferably functions in the same way as the embodiment of FIG. 10.

Otherwise, in a case where data element 1103 does not have a corresponding data representation 1105 prior to an event, DRIG 1124 obtains a data representation 1105, which is associated with another data element 1103 that is similar to data element 1103 which had no corresponding data representation 1105 prior to the event. Comparator 1111 receives data representation 1105 from DRIG 1124 and provides the difference between data representation 1105 and post-event data element 1103 to comparison notifier 1112. The rest of the operation of the embodiment of FIG. 11 is preferably identical to that of the embodiment of FIG. 10.

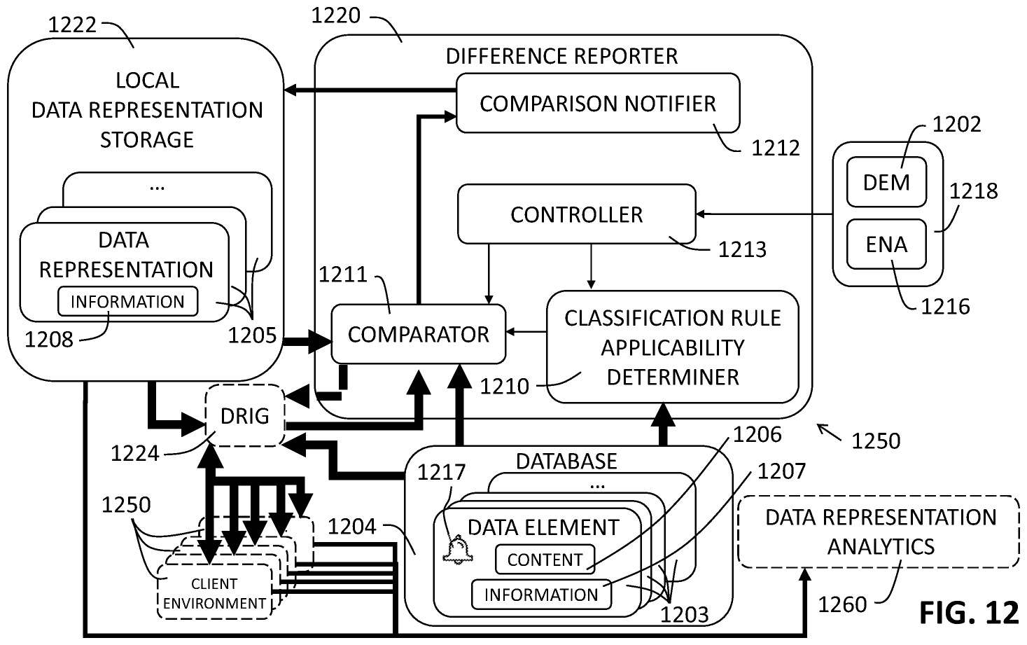

Reference is now made to FIG. 12, which is a simplified functional block diagram of a portion of respective systems 400 & 500 of FIGS. 4A & 4B and 5A & 5B, showing particularly details of difference reporter 420 and difference reporter 520 thereof, respectively.

In FIG. 12, a difference reporter 1220, such as difference reporter 420 or difference reporter 520, includes a controller 1213 which receives an input from a data element monitor (DEM) 1202, such as DEM 402 or DEM 502, and an event notification ascertainer (ENA) 1216, such as ENA 416 or ENA 516. DEM 1202 and ENA 1216 are collectively designated as a block 1218, much like DEM 402 and ENA 416 or DEM 502 and ENA 516 are collectively designated as block 418 and 518 respectively. Block 1218 monitors a plurality of data elements 1203, such as data elements 403 or data elements 503, in a database 1204, such as database 404 or database 504. Block 1218 identifies those data elements 1203 stored in data element database 1204 which have a recent event notification 1217 associated therewith, such as event notifications 417 or 517. Recent event notification 1217 is an event notification 1217 that was generated subsequent to a previous output of block 1218 to difference reporter 1220.

Controller 1213 provides a trigger output to a comparator 1211, preferably causing comparator 1211 to perform comparison functions only on data elements 1203 stored in data element database 1204 which have a recent event notification 1217 associated therewith.

Each data element 1203 in database 1204 has associated data element information 1207, such as data element information 407 or data element information 507, and associated data element content 1206, such as data element content 406 or data element content 506. Comparator 1211 also preferably receives an input from data element database 1204, which preferably includes corresponding data element information 1207. This input received by comparator 1211 is post-event data element information, for each data element 1203 stored in data element database 1204 which has an event notification 1217 associated therewith.

Preferably, difference reporter 1220 also includes a classification rule applicability determiner 1210, which indicates whether data element content 1206 of data element 1203 is subject to any classification rules. As described hereinbelow, in a preferred embodiment of the present invention, classification rule applicability determiner 1210 checks data elements 1203 for data element content 1206 that is subject to particular rules, such as stringent privacy measures. Examples of classification rules and their applicability are described hereinbelow with reference to FIGS. 15A-18D.

Classification rule applicability determiner 1210 receives a trigger output from controller 1213, which indicates which of data elements 1203 being monitored has an event notification 1217 associated therewith, and also receives, from data element database 1204, data element content 1206, which is post-event data element content, for each data element 1203 being monitored, which has an event notification 1217 associated therewith. Classification rule applicability determiner 1210 preferably provides an output to comparator 1211 indicating which, if any, classification rules apply to data element content 1206, which is post-event data element content. In a preferred embodiment of the present invention, classification rules are included in data element information 1207, which is post-event data information, and thus, the output provided by classification rule applicability determiner 1210 to comparator 1211 is part of data element information 1207, which is post-event data element information.

Comparator 1211 additionally preferably receives an input from a local data representation storage 1222, such as local data representation storage 422 or local data representation storage 522. Local data representation storage 1222 includes a plurality of data representations 1205, such as data representations 405 or data representations 505, each containing corresponding data representation information 1208, such as data representation information 408 or data representation information 508. This input received by comparator 1211 is pre-event data representation information, to be associated with each corresponding data element 1203 being monitored, which has an event notification 1217 associated therewith. As described hereinabove with reference to FIGS. 4A-5B, when data element 1203 being monitored has no associated data representation information 1208, comparator 1211 preferably receives default data representation information 1208 generated from a data representation information generator (DRIG) 1224, such as DRIG 424 or DRIG 524, outside of local client environment 1250. DRIG 1224 itself receives input either from database 1204, or comparator 1211 as described hereinabove and shown by a dashed arrow in FIG. 12. It is appreciated that DRIG 1224 and other client environments 1250 are outlined in dashed lines in FIG. 12, indicating that DRIG 1224 and other client environments 1250 are preferably not included in local client environment 1250.

For each data element 1203 being monitored which has an event notification 1217 associated therewith, comparator 1211 is preferably operative to provide to a comparison notifier 1212 an output indicating a difference between data element information 1207, which is post-event data element information, including data element information 1207 provided both by database 1204 and by classification rule applicability determiner 1210, and corresponding data representation information 1208, which is pre-event data representation information, or default data representation information, which represents pre-event data representation information.

Comparison notifier 1212 of difference reporter 1220 preferably provides an output to local data representation storage 1222, indicating a difference between data element information 1207, which is post-event data element information, and corresponding data representation information 1208, which is pre-event data representation information or default data representation information, thereby updating local data representation storage 1222 based on the output received by comparison notifier 1212 from comparator 1211. Local data representation storage 1222 in turn provides an output to a data representation analytics 1260, such as data representation analytics 460 or data representation analytics 560. In a preferred embodiment of the present invention, the output provided by local data representation storage 1222 to data representation analytics 1260 includes all or substantially all of data element information 1207, which is post-event data element information. In another embodiment of the present invention, the output provided by local data representation storage 1222 to data representation analytics 1260 indicates a difference between data element information 1207, which is post-event data element information, and corresponding data representation information 1208, which is pre-event data representation information or default data representation information. It is appreciated that data representation analytics 1260 is outlined in dashed lines in FIG. 12, indicating that data representation analytics 1260 is preferably not included in local client environment 1250.

It is appreciated that the embodiment of FIG. 12 differs from the embodiment of FIG. 10 in that the embodiment of FIG. 12 includes DRIG 1224.

The embodiment of FIG. 12 differs from the embodiment of FIG. 11 in that DRIG 1224 is located outside of local environment 1250 and accesses databases 1204 and data representation storages 1222 found in a plurality of client environments 1250. As described hereinabove, this provides DRIG 1224 with more data representations 1205 to choose from, when compared to DRIG 1124 of the embodiment of FIG. 11, thus increasing the chances of DRIG 1224 finding a data representation 1205 similar to a data element 1203 having no pre-event data representation 1205, nor any similar data element 1203, exists locally.

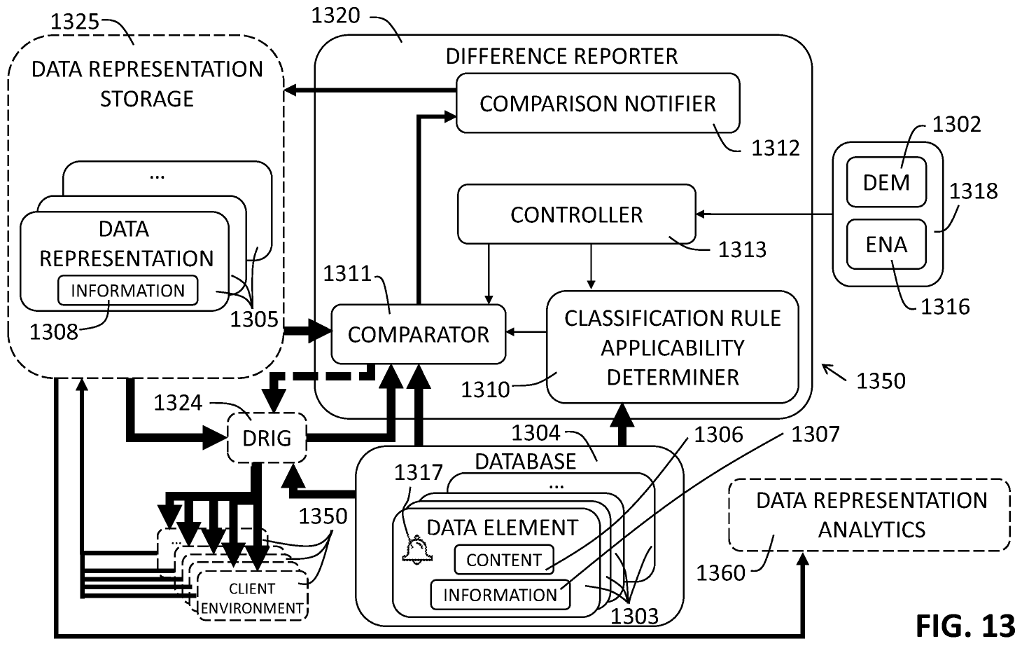

Reference is now made to FIG. 13, which is a simplified functional block diagram of a portion of respective systems 600 & 700 of FIGS. 6A & 6B and 7A & 7B, showing particularly details of difference reporter 620 and difference reporter 720 thereof, respectively.

In FIG. 13, a difference reporter 1320, such as difference reporter 620 or difference reporter 720, includes a controller 1313 which receives an input from a data element monitor (DEM) 1302, such as DEM 602 or DEM 702, and an event notification ascertainer (ENA) 1316, such as ENA 616 or ENA 716. DEM 1302 and ENA 1316 are collectively designated as a block 1318, much like DEM 602 and ENA 616 or DEM 702 and ENA 716 are collectively designated as block 618 and 718 respectively. Block 1318 monitors a plurality of data elements 1303, such as data elements 603 or data elements 703, in a database 1304, such as database 604 or database 704. Block 1318 identifies those data elements 1303 stored in data element database 1304 which have a recent event notification 1317 associated therewith, such as event notifications 617 or 717. Recent event notification 1317 is an event notification 1317 that was generated subsequent to a previous output of block 1318 to difference reporter 1320.

Controller 1313 provides a trigger output to a comparator 1311, preferably causing comparator 1311 to perform comparison functions only on data elements 1303 stored in data element database 1304 which have a recent event notification 1317 associated therewith.

Each data element 1303 in database 1304 has associated data element information 1307, such as data element information 607 or data element information 707, and associated data element content 1306, such as data element content 606 or data element content 706. Comparator 1311 also preferably receives an input from data element database 1304, which preferably includes corresponding data element information 1307, which is post-event data element information, for each data element 1303 stored in data element database 1304 which has an event notification 1317 associated therewith.

Preferably, difference reporter 1320 also includes a classification rule applicability determiner 1310, which indicates whether data element content 1306 of data element 1303 is subject to any classification rules. As described hereinbelow, in a preferred embodiment of the present invention, classification rule applicability determiner 1310 checks data elements 1303 for data element content 1306 that is subject to particular rules, such as stringent privacy measures. Examples of classification rules and their applicability are described hereinbelow with reference to FIGS. 15A-18D.

Classification rule applicability determiner 1310 receives a trigger output from controller 1313, which indicates which of data elements 1303 being monitored has an event notification 1317 associated therewith, and also receives, from data element database 1304, data element content 1306, which is post-event data element content, for each data element 1303 being monitored, which has an event notification 1317 associated therewith. Classification rule applicability determiner 1310 preferably provides an output to comparator 1311 indicating which, if any, classification rules apply to post-event data element content 1306. In a preferred embodiment of the present invention, classification rules are included in data element information 1307, which is post-event data element information, and thus, the output provided by classification rule applicability determiner 1310 to comparator 1311 is part of data element information 1307, which is post-event data element information.

Comparator 1311 additionally preferably receives an input from a data representation storage 1325, such as data representation storage 625 or data representation storage 725. Data representation storage 1325 includes a plurality of data representations 1305, such as data representations 605 or data representations 705, each containing corresponding data representation information 1308, such as data representation information 608 or data representation information 708. This input received by comparator 1311 is pre-event data element information, to be associated with each corresponding data element 1303 being monitored, which has an event notification 1317 associated therewith. As described hereinabove with reference to FIGS. 6A-7B, when data element 1303 being monitored has no associated data representation information 1308, comparator 1311 preferably receives default data representation information 1308 generated from a data representation information generator (DRIG) 1324, such as DRIG 624 or DRIG 724, outside of local client environment 1350. DRIG 1324 itself receives input either from database 1304, or comparator 1311 as described hereinabove and shown by a dashed arrow FIG. 13. It is appreciated that DRIG 1324, data representation storage 1325 and other client environments 1350 are outlined in dashed lines in FIG. 13, indicating that DRIG 1324, data representation storage 1325 and other client environments 1350 are preferably not included in local client environment 1350.

For each data element 1303 being monitored which has an event notification 1317 associated therewith, comparator 1311 is preferably operative to provide to a comparison notifier 1312 an output indicating a difference between data element information 1307, which is post-event data element information, including data element information 107 provided both by database 1304 and by classification rule applicability determiner 1310, and corresponding data representation information, which is pre-event data representation information or default data representation information.

Comparison notifier 1312 of difference reporter 1320 preferably provides an output to data representation storage 1325, indicating a difference between data element information 1307, which is post-event data element information, and corresponding data representation information 1308, which is pre-event data representation information, or default data representation information thereby updating data representation storage 1325 based on the output received by comparison notifier 1312 from comparator 1311. Data representation storage 1325 in turn provides an output to a data representation analytics 1360, such as data representation analytics 660 or data representation analytics 760. In a preferred embodiment of the present invention, the output provided by data representation storage 1325 to data representation analytics 1360 includes all or substantially all of data element information 1307, which is post-event data element information. In another embodiment of the present invention, the output provided by data representation storage 1325 to data representation analytics 1360 indicates a difference between data element information 1307, which is post-event data element information, and corresponding data representation information 1308, which is pre-event data representation information or default data representation information. It is appreciated that data representation analytics 1360 is outlined in dashed lines in FIG. 13, indicating that data representation analytics 1360 is preferably not included in local client environment 1350.

It is appreciated that the embodiment of FIG. 13 differs from the embodiment of FIG. 10 in that the embodiment of FIG. 13 includes DRIG 1324. In a case where data element 1303 has a corresponding data representation 1305 prior to an event, the embodiment of FIG. 13 preferably functions in the same way as does the embodiment of FIG. 10.

The embodiment of FIG. 13 differs from the embodiment of FIGS. 11 and 12 in that neither of DRIG 1324 and data representation storage 1325 is located within local client environment 1350.

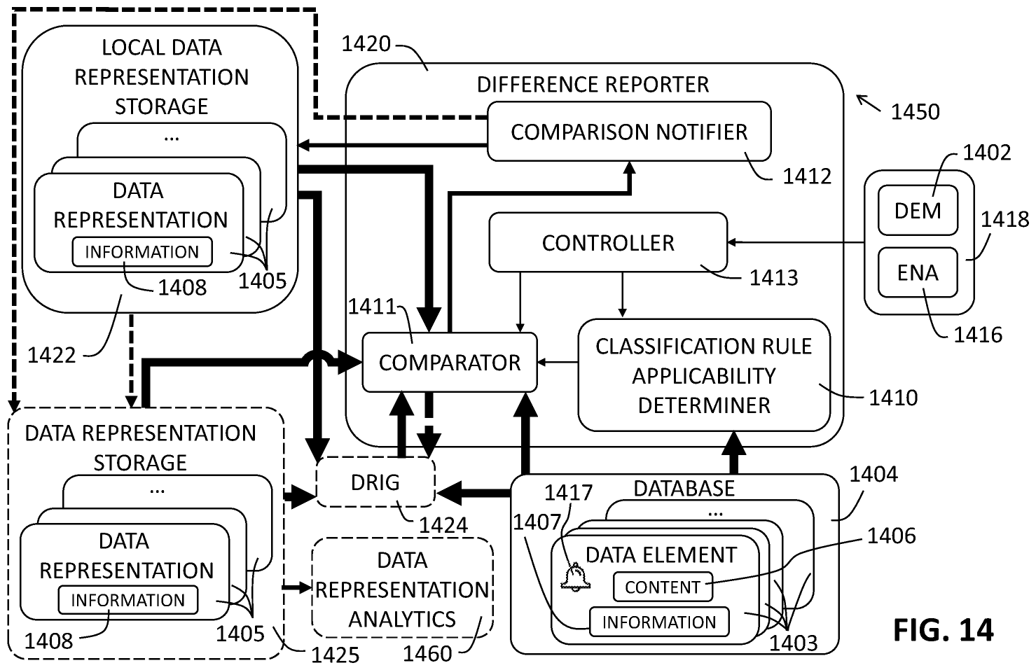

Reference is now made to FIG. 14, which is a simplified functional block diagram of a portion of respective systems 800 & 900 of FIGS. 8A & 8B and 9A & 9B, showing particularly details of difference reporter 820 and difference reporter 920 thereof, respectively.

In FIG. 14, a difference reporter 1420, such as difference reporter 820 or difference reporter 920, includes a controller 1413 which receives an input from a data element monitor (DEM) 1402, such as DEM 802 or DEM 902, and an event notification ascertainer (ENA) 1416, such as ENA 816 or ENA 916. DEM 1402 and ENA 1416 are collectively designated as a block 1418, much like DEM 802 and ENA 816 or DEM 902 and ENA 916 are collectively designated as block 818 and 918 respectively. Block 1418 monitors a plurality of data elements 1403, such as data elements 803 or data elements 903, in a database 1404, such as database 804 or database 904. Block 1418 identifies those data elements 1403 stored in data element database 1404 which have a recent event notification 1417 associated therewith, such as event notifications 817 or 917. Recent event notification 1417 is an event notification 1417 that was generated subsequent to a previous output of block 1418 to difference reporter 1420.

Controller 1413 provides a trigger output to a comparator 1411, preferably causing comparator 1411 to perform comparison functions only on data elements 1403 stored in data element database 1404 which have a recent event notification 1417 associated therewith.

Each data element 1403 in database 1404 has associated data element information 1407, such as data element information 807 or data element information 907, and associated data element content 1406, such as data element content 806 or data element content 906. Comparator 1411 also preferably receives an input from data element database 1404, which preferably includes corresponding data element information 1407, which is post-event data element information, for each data element 1403 stored in data element database 1404 which has an event notification 1417 associated therewith.

Preferably, difference reporter 1420 also includes a classification rule applicability determiner 1410, which indicates whether data element content 1406 of data element 1403 is subject to any classification rules. As described hereinbelow, in a preferred embodiment of the present invention, classification rule applicability determiner 1410 checks data elements 1403 for data element content 1406 that is subject to particular rules, such as stringent privacy measures. Examples of classification rules and their applicability are described hereinbelow with reference to FIGS. 15A-18D.

Classification rule applicability determiner 1410 receives a trigger output from controller 1413, which indicates which of data elements 1403 being monitored has an event notification 1417 associated therewith, and also receives, from data element database 1404, data element content 1406, which is post-event data element content, for each data element 1403 being monitored, which has an event notification 1417 associated therewith. Classification rule applicability determiner 1410 preferably provides an output to comparator 1411 indicating which, if any, classification rules apply to post-event data element content 1406. In a preferred embodiment of the present invention, classification rules are included in data element information 1407, which is post-event data element information, and thus, the output provided by classification rule applicability determiner 1410 to comparator 1411 is part of data element information 1407, which is post-event data element information.

Comparator 1411 additionally preferably receives an input from a local data representation storage 1422, such as local data representation storage 822 or local data representation storage 922, or alternatively receives an input from a data representation storage 1425, such as data representation storage 825 or data representation storage 925. Both data representation storages 1422 and 1425 consist of a plurality of data representations 1405, such as data representations 805 or data representations 905, each containing corresponding data representation information 1408, such as data representation information 808 or data representation information 908. This input received by comparator 1411 is pre-event data representation information, to be associated with each corresponding data element 1403 being monitored, which has an event notification 1417 associated therewith. As described hereinabove with reference to FIGS. 8A-9B, when data element 1403 being monitored has no associated data representation information 1408, comparator 1411 preferably receives default data representation information 1408 generated from a data representation information generator (DRIG) 1424, such as DRIG 824 or DRIG 924, outside of local client environment 1450, which itself receives input either from database 1404, or comparator 1411 as described hereinabove and shown by a dashed arrow in FIG. 14. It is appreciated that DRIG 1424 and data representation storage 1425 are outlined in dashed lines in FIG. 14, indicating that DRIG 1424 and data representation storage 1425 are preferably not included in local client environment 1450.

For each data element 1403 being monitored which has an event notification 1417 associated therewith, comparator 1411 is preferably operative to provide to a comparison notifier 1412 an output indicating a difference between data element information 1407, which is post-event data element information, including data element information 1407 provided both by database 1404 and by classification rule applicability determiner 1410, and corresponding data representation information 1408, which is pre-event data representation information or default data representation information.

Comparison notifier 1412 of difference reporter 1420 preferably provides an output to local data representation storage 1422, indicating a difference between data element information 1407, which is post-event data element information, and corresponding data representation information 1408, which is pre-event data representation information or default data representation information, thereby updating local data representation storage 1422 based on the output received by comparison notifier 1412 from comparator 1411. Local data representation storage 1422 in turn preferably provides an output to collective data representation storage 1425, which then preferably provides an output to a data representation analytics 1460, such as data representation analytics 860 or data representation analytics 960. In a preferred embodiment of the present invention, the output provided by data representation storage 1425 to data representation analytics 1460 includes all or substantially all of data element information 1407, which is post-event data element information. In another embodiment of the present invention, the output provided by data representation storage 1425 to data representation analytics 1460 indicates a difference between data element information 1407, which is post-event data element information, and corresponding data representation information 1408, which is pre-event data representation information or default data representation information. It is appreciated that data representation analytics 1460 in outlined in dashed lines in FIG. 14, indicating that data representation analytics 1460 is preferably not included in local client environment 1450.

Thus, in a preferred embodiment of the present invention, upon being updated by comparison notifier 1412, local data representation storage 1422 updates collective data representation storage 1425. Alternatively, comparison notifier 1412 of difference reporter 1420 updates collective data representation storage 1425 directly, based on the output received by comparison notifier 1412 from comparator 1411. Both of these alternative embodiments are shown in FIG. 14 by dashed arrows.

It is appreciated that the embodiment of FIG. 14 differs from the embodiment of FIG. 10 in that the embodiment of FIG. 14 includes DRIG 1424. In a case where data element 1403 has a corresponding data representation 1405 prior to an event, the embodiment of FIG. 14 preferably functions in the same way as does the embodiment of FIG. 10.

Like the embodiment of FIG. 12, and unlike the embodiment of FIG. 13, the embodiment of FIG. 14 includes local storage 1422, which may provide DRIG 1424 with pre-event data representation information 1408 and is updated by comparison notifier 1412.

Like the embodiment of FIG. 13, and unlike the embodiment of FIG. 12, the embodiment of FIG. 14 includes external data representation storage 1425, which may provide DRIG 1424 with pre-event data representation information 1408 and can be updated by comparison notifier 1412.

Reference is now made to FIG. 15A, which is a simplified flow chart illustrating operation of system 100 of FIGS. 1A, 1B & 6 in an exemplary use case, and to FIG. 15B, which is a simplified flow chart showing a portion of the flow chart of FIG. 15A.

As seen particularly in FIG. 15A, Andy, an executive assistant to the president of XYZ University in Washington, D.C. USA, has a prepared draft of a graduation speech to be delivered by Frank Stein, the president of XYZ University. It is noted that Andy prepared the draft of the graduation speech prior to the beginning of the example of FIGS. 15A & 15B. The graduation speech is stored as a data element, such as a data element 103 (FIGS. 1A, 1B & 6), on an enterprise server of XYZ University at 13:35:42 on May 1, 2020. The enterprise server of XYZ University is an example of a client environment 150 of FIGS. 1A, 1B & 6.

As is typical of data elements 103 shown in FIGS. 1A, 1B & 6, which have both data element content 106 and data element information 107, the data element of the draft graduation speech has both content 106, embodied as the text of the graduation speech, and information 107, such as, for example, permissions, metadata, and classification rules. The stored data element 103 of the draft graduation speech has a stored data representation 105 having data representation information 108, embodied in the example of FIGS. 15A & 15B as a version A of data representation data table 1904, which is an example of data element information 108 of a data representation 105 (FIGS. 1A, 1B & 6).

An exemplary version A of data representation data table 1904 for the stored data representation appears in FIGS. 15A & 15B. As seen particularly in FIG. 15B, version A of data representation data table 1904 typically includes multiple sub-tables, including a Permissions Data Table 1A, containing full access permissions of Andy, Frank and a system administrator. Version A of data representation data table 1904 preferably also includes a Metadata Data Table 2A, indicating the name of the creator, Andy, the time of creation, the subject and typical tags. Version A of data representation data table 1904 also typically includes a Classification Rules Data Table 3A, which indicates that Content Classification rules, such as those applying to Social Security Numbers, Credit Card Numbers, Bank Account Numbers and Trade Secrets, are not applicable to the content 106 of the graduation speech.

As seen particularly in FIG. 15A, Andy later accesses the prepared draft of the graduation speech and in the graduation speech content 106, updates only the date of the graduation. In the graduation speech information 107, Andy adds access permissions to John Smith, a newly appointed Vice President of Alumni Affairs at XYZ University. These actions are indicated in a Block 1912 in FIG. 15A as event 1.

The actions of event 1 change stored data element 103 of the graduation speech into a first changed data element 103 of the graduation speech (FIGS. 1A, 1B & 6), including updated data element content 106 and updated data element information 107. Subsequently, as described further hereinbelow, system 100 is operative to update data representation 105 corresponding to data element 103 by updating data representation information 108 with first changed data representation information 108, such as a corresponding first changed data representation data table, appearing in FIGS. 15A & 15B as a version B of data representation data table 1914. As can be seen by comparing version B of data representation data table 1914 with version A of data representation data table 1904, the only change between version A and version B of the data representation data table is the addition of full access permissions to John Smith.

In accordance with a preferred embodiment of the present invention, illustrated in FIGS. 1A, 1B & 6, difference reporter 120 (FIGS. 1A, 1B & 6) provides an output to local data representation storage 122 which represents the difference between data element information 107, which is post-event data element information, and corresponding data representation information 108, which is pre-event data representation information, for each data element 103 having an event notification 117 associated therewith. The difference between post-event 1 data element information 107 and corresponding pre-event 1 data representation information 108 for the first changed data element 103 is indicated in a Block 1916 in FIG. 15A. It is appreciated that difference generator 120 generates the data in block 1916 from a comparison of pre-event 1 data representation information 108 for the first changed data element 103, which is embodied as version A of data representation data table 1904, and post-event 1 data element information 107 for the first changed data element 103, which is embodied as version B of data representation data table 1914.

As seen in Block 1916, the difference communicated to local data representation storage 122 (FIGS. 1A, 1B & 6) represents only the change between data representation data tables 1904 and 1914, namely the addition of full access permissions to John Smith.

John Smith subsequently adds to Andy's draft an appeal for donations to XYZ University and adds, to the content 106 of the graduation speech, a Bank Account Number for receiving donations. He also adds a tag “best speech ever.” John Smith saves this draft on the enterprise server. These actions are indicated in a Block 1922 in FIG. 15A as event 2.

The actions of event 2 change stored data element 103 of the graduation speech into a second changed data element 103 of the graduation speech (FIGS. 1A, 1B & 6), including updated data element content 106 and updated data element information 107. Subsequently, as described further hereinbelow, system 100 is operative to update data representation 105 corresponding to data element 103 by updating data representation information 108 with second changed data representation information 108, such as a corresponding second changed data representation data table, appearing in FIGS. 15A & 15B as a version C of data representation data table 1924. As can be seen by comparing version C of data representation data table 1924 with version B of data representation data table 1914, the addition of a bank account number to the content 106 of the graduation speech invokes an applicability of a bank account number classification rule, changing information 107 associated with the graduation speech. As can be seen by comparing version C of data representation data table 1924 with version B of data representation data table 1914, the only changes between version B and version C of the data representation data table are the addition of a metadata tag and an indication of applicability of the bank account number classification rule.

In accordance with a preferred embodiment of the present invention, illustrated in FIGS. 1A, 1B & 6, difference reporter 120 (FIGS. 1A, 1B & 6) provides an output to local data representation storage 122 which represents the difference between data element information 107, which is post-event data element information, and corresponding data representation information 108, which is pre-event data representation information, for each data element 103 having an event notification 117 associated therewith. The difference between post-event 2 data element information 107 and corresponding pre-event 2 data representation information 108 for the second changed data element 103 is indicated in a block 1926 in FIG. 15A. It is appreciated that difference generator 120 generates the data in block 1926 from a comparison of pre-event 2 data representation information 108 for the second changed data element 103, which is embodied as version B of data representation data table 1914, and post-event 2 data element information 107 for the second changed data element 103, which is embodied as version C of data representation data table 1924.

As seen in block 1926, the difference communicated to local data representation storage 122 (FIGS. 1A, 1B & 6) represents only the change between data representation data tables 1914 and 1924, namely the addition of a metadata tag and an indication of applicability of the bank account number classification rule.

Frank Stein subsequently reviews John Smith's additions to Andy's draft and removes the appeal for donations to XYZ University and removes the bank account number for receiving donations. He also removes all access permissions to John Smith and adds read-only access permissions to his personal assistant Rachel Green. Frank Stein saves his draft on the enterprise server. These actions are indicated in Block 1932 in FIG. 15A as event 3.

The actions of event 3 change stored data element 103 (FIGS. 1A, 1B & 6) into a third changed data element 103, including updated data element content 106 and updated data element information 107. Subsequently, as described further hereinbelow, system 100 is operative to update-data representation 105 corresponding to data element 103 by updating data representation information 108 with third changed data representation information 108, such as a corresponding third changed data representation data table, appearing in FIGS. 15A & 15B as a version D of data representation data table 1934. As can be seen by comparing version D of data representation data table 1934 with version C of data representation data table 1924, the removal of the bank account number revokes applicability of the bank account number classification rule. The only changes in the data representation data tables between version C and version D are the removal of John Smith's access permissions, the addition of read-only access permissions for Rachel Green and an indication of non-applicability of the bank account number classification rule.

In accordance with a preferred embodiment of the present invention, illustrated in FIGS. 1A, 1B & 6, difference reporter 120 (FIGS. 1A, 1B & 6) provides an output to local data representation storage 122 which represents the difference between data element information 107, which is post-event data element information and corresponding data representation information 108, which is pre-event data representation information, for each data element 103 having an event notification 117 associated therewith. The differences between post-event 3 data element information 107 and corresponding pre-event 3 data representation information 108 for the third changed data element 103 are indicated in a Block 1936 in FIG. 15A. It is appreciated that difference generator 120 generates the data in block 1936 from a comparison of pre-event 3 data representation information 108 for the third changed data element 103, which is embodied as version C of data representation data table 1924, and post-event 3 data element information 107 for the third changed data element 103, which is embodied as version D of data representation data table 1934.

As seen in Block 1936, the differences communicated to local data representation storage 122 (FIGS. 1A, 1B & 6) represents only the changes between data representation data tables 1924 and 1934, namely the removal of John Smith's access permissions, the addition of read-only access permissions for Rachel Green and an indication of non-applicability of the bank account number classification rule.

Reference is now made to FIGS. 16A & 16B, which together are a simplified flow chart illustrating operation of system 100 of FIGS. 1A, 1B & 6 in another exemplary use case, and to FIGS. 16C & 16D, which together are a simplified flow chart showing a portion of the flow chart of FIGS. 16A & 16B.

As seen particularly in FIG. 16A, Andy, the executive assistant to the president of XYZ University in Washington, D.C. USA, prepares a draft of a graduation speech to be delivered by Frank Stein, the president of XYZ University.

In contrast to the use case of FIGS. 15A & 15B, described hereinabove, the draft prepared by Andy is a first draft of a speech and there is no earlier stored data element 103 on the enterprise server of XYZ University and no corresponding stored data representation 105 for the draft prepared by Andy. The enterprise server of XYZ University is an example of a client environment 150 of FIGS. 1A, 1B & 6. The creation of the graduation speech is indicated in a Block 2002 in FIG. 16A as event 1.

When Andy saves the draft of the graduation speech on the enterprise server of XYZ University as a stored data element 103 (FIGS. 1A, 1B & 6), system 100 confirms that there exists no populated data representation 105 for data element 103 and associates with the graduation speech stored data element 103 a blank default data representation 105, typically including a non-populated data representation data table, such as a non-populated data representation data table 2004 shown in in FIGS. 16A & 16C.

As seen particularly in FIG. 16C, exemplary non-populated data representation data table 2004 typically includes multiple sub-tables, including a Permissions Data Table 1 and a Metadata Data Table 2, indicating the name of the creator, the time of creation, the subject and typical tags. Exemplary non-populated data representation data table 2004 also typically includes a Classification Rules Data Table 3, which indicates whether Content Classification rules are applicable, such as those applying to Social Security Numbers, Credit Card Numbers, Bank Account Numbers and Trade Secrets.

In the use case of FIGS. 16A-16D, Permissions Data Table 1, Metadata Data Table 2 and Classification Rules Data Table 3 in non-populated data representation data table 2004 are populated either automatically in accordance with enterprise policies or manually by the creator of data element 103 (FIGS. 1A, 1B & 6). As seen particularly in FIG. 16A, the population of non-populated data representation data table 2004 preferably occurs as part of Event 1, and transforms non-populated data table 2004 into a version A of data representation data table 2006 preferably based at least partially on corresponding data element information 107 of data element 103.

Version A of data representation data table 2006 is stored as data element information 108 of a data representation 105 (FIGS. 1A, 1B & 6) associated with data element 103 of the draft graduation speech. As seen particularly in FIG. 16C, version A of data representation data table 2006 typically includes multiple sub-tables, including a Permissions Data Table 1A, containing full access permissions of Andy, Frank and a system administrator. Version A of data representation data table 2006 preferably also includes a Metadata Data Table 2A, indicating the name of the creator, Andy, the time of creation, the subject and typical tags. Version A of data representation data table 2006 also typically includes a Classification Rules Data Table 3A, which indicates that Content Classification rules, such as those applying to Social Security Numbers, Credit Card Numbers, Bank Account Numbers and Trade Secrets, are not applicable to the content 106 of the graduation speech.

It is appreciated that as is typical of data elements 103 shown in FIGS. 1A, 1B & 6, which have both data element content 106 and data element information 107, the data element of the graduation speech has both data element content 106, embodied as the text of the graduation speech, and data element information 107, such as, for example, permissions, metadata, and classification rules. The stored data element 103 created at event 1 also has a stored data representation 105 having data element information 108, embodied in the example of FIGS. 16A-16D as version A of data representation data table 2006, which is an example of data element information 108 of a data representation 105.

As seen particularly in FIG. 16A at a block 2008, difference reporter 120 (FIGS. 1A, 1B & 6) preferably provides an output to local data representation storage 122 which represents a difference between data element information 107, which is post-event data element information associated with the graduation speech data element 103, which at block 2008 is embodied as data representation data table 2006, and the corresponding data representation element 108, which is pre-event 1 version of data representation information 108 associated with the draft graduation speech data element 103, which at block 2008 is embodied as data representation data table 2004, which is null. In the example illustrated in FIGS. 16A-16D, the graduation speech data element 103 and the associated data representation 105 thereof are created at event 1. Therefore, the difference communicated to local data representation storage 122 preferably represents the entirety of version A of data representation data table 2006, including sub-tables, field names, and field values of data representation data table 2006.

The remainder of the use case of FIGS. 16A-16D may be identical to the use case described hereinabove with reference to FIGS. 15A & 15B, with corresponding changed indications of blocks, events and differences. For clarity, the full use case of FIGS. 16A-16D is illustrated in FIGS. 16A-16D and is described below.

As seen particularly in FIG. 16A, subsequent to event 1, Andy accesses the prepared draft of the graduation speech and in the graduation speech content 106, updates only the date of the graduation. In the graduation speech information 107, Andy adds access permissions to John Smith, a newly appointed Vice President of Alumni Affairs at XYZ University. These actions are indicated in a Block 2012 in FIG. 16A as event 2.

The actions of event 2 change stored data element 103 of the graduation speech into a first changed data element 103 of the graduation speech (FIGS. 1A, 1B & 6), including updated data element content 106 and updated data element information 107. Subsequently, as described further hereinbelow, system 100 is operative to update data representation 105 corresponding to data element 103 by updating data representation information 108 with first changed data representation information 108, such as a corresponding first changed data representation data table, appearing in FIGS. 16A, 16B & 16C as a version B of data representation data table 2014. As can be seen by comparing version B of data representation data table 2014 with version A of data representation data table 2006, the only change between version A and version B of the data representation data table is the addition of full access permissions to John Smith.

In accordance with a preferred embodiment of the present invention, illustrated in FIGS. 1A, 1B & 6, difference reporter 120 provides an output to local data representation storage 122 which represents the difference between data element information 107, which is post-event data element information, and corresponding data representation information 108, which is pre-event data representation information, for each data element 103 having an event notification 117 associated therewith. The difference between post-event 2 data element information 107 and corresponding pre-event 2 data representation information 108 for the first changed data element 103 is indicated in a block 2016 in FIG. 16A. It is appreciated that difference generator 120 generates the data in block 2016 from a comparison of pre-event 2 data representation information 108 for the first changed data element 103, which is embodied as version A of data representation data table 2006, and post-event 2 data element information 107 for the first changed data element 103, which is embodied as version B of data representation data table 2014.

As seen in block 2016, the difference communicated to local data representation storage 122 represents only the change between data representation data tables 2014 and 2006, namely the addition of full access permissions to John Smith.

As seen particularly in FIG. 16B, John Smith subsequently adds to Andy's draft an appeal for donations to XYZ University and adds, to the content 106 of the graduation speech, a Bank Account Number for receiving donations. He also adds a tag “best speech ever.” John Smith saves this draft on the enterprise server. These actions are indicated in a Block 2022 in FIG. 16B as event 3.

The actions of event 3 change stored data element 103 of the graduation speech into a second changed data element 103 of the graduation speech (FIGS. 1A, 1B & 6), including updated data element content 106 and updated data element information 107. Subsequently, as described further hereinbelow, system 100 is operative to update data representation 105 (FIGS. 1A, 1B & 6) corresponding to data element 103 by updating data representation information 108 with second changed data representation information 108, such as a corresponding second changed data representation data table, appearing in FIGS. 16A & 16B as a version C of data representation data table 2024. As can be seen by comparing version C of data representation data table 2024 with version B of data representation data table 2014, the addition of a bank account number to the content 106 of the graduation speech invokes an applicability of a bank account number classification rule, changing information 107 associated with the graduation speech. As can be seen by comparing version C of data representation data table 2024 with version B of data representation data table 2014, the only changes between version B and version C of the data representation data table are the addition of a metadata tag and an indication of applicability of the bank account number classification rule.

In accordance with a preferred embodiment of the present invention, illustrated in FIGS. 1A, 1B & 6, difference reporter 120 provides an output to local data representation storage 122 which represents the difference between data element information 107, which is post-event data element information, and corresponding data representation information 108, which is pre-event data representation information, for each data element 103 having an event notification 117 associated therewith. The difference between post-event 3 data element information 107 and corresponding pre-event 3 data representation information 108 for the second changed data element 103 (FIGS. 1A, 1B & 6) is indicated in a block 2026 in FIG. 16B. It is appreciated that difference generator 120 generates the data in block 2026 from a comparison of pre-event 3 data representation information 108 for the second changed data element 103, which is embodied as version B of data representation data table 2014, and post-event 3 data element information 107 for the second changed data element 103, which is embodied as version C of data representation data table 2024.

As seen in block 2026, the difference communicated to local data representation storage 122 (FIGS. 1A, 1B & 6) represents only the change between data representation data tables 2014 and 2024, namely the addition of a metadata tag and an indication of applicability of the bank account number classification rule.

Frank Stein subsequently reviews John Smith's additions to Andy's draft and removes the appeal for donations to XYZ University and removes the bank account number for receiving donations. He also removes all access permissions to John Smith and adds read-only access permissions to his personal assistant Rachel Green. Frank Stein saves his draft on the enterprise server. These actions are indicated in a Block 2032 in FIG. 16B as event 4.

The actions of event 4 change stored data element 103 (FIGS. 1A, 1B & 6) into a third changed data element 103 (FIGS. 1A, 1B & 6), including updated data element content 106 and updated data element information 107. Subsequently, as described further hereinbelow, system 100 is operative to update data representation 105 (FIGS. 1A, 1B & 6) corresponding to data element 103 by updating data representation information 108 with third changed data representation information 108, having a corresponding third changed data representation data table, appearing in FIGS. 16B & 16D as a version D of data representation data table 2034. As can be seen by comparing version D of data representation data table 2034 with version C of data representation data table 2024, the removal of the bank account number revokes applicability of the bank account number classification rule. The only changes in the data representation data table between version C and version D are the removal of John Smith's access permissions, the addition of read-only access permissions for Rachel Green and an indication of non-applicability of the bank account number classification rule.

In accordance with a preferred embodiment of the present invention, illustrated in FIGS. 1A, 1B & 6, difference reporter 120 (FIGS. 1A, 1B & 6) provides an output to local data representation storage 122 (FIGS. 1A, 1B & 6) which represents the difference between data element information 107, which is post-event data element information, and corresponding data representation information 108, which is pre-event data representation information, for each data element 103 having an event notification 117 associated therewith. The differences between post-event 4 data element information 107 and corresponding pre-event 4 data representation information 108 for the third changed data element 103 are indicated in a block 2036 in FIG. 16B. It is appreciated that difference generator 120 generates the data in block 2036 from a comparison of pre-event 4 data representation information 108 for the third changed data element 103, which is embodied as version C of data representation data table 2024, and post-event 4 data element information 107 for the third changed data element 103, which is embodied as version D of data representation data table 2034.

As seen in block 2036, the differences communicated to local data representation storage 122 (FIGS. 1A, 1B & 6) represents only the changes between data representation data tables 2024 and 2034, namely the removal of John Smith's access permissions, the addition of read-only access permissions for Rachel Green and an indication of non-applicability of the bank account number classification rule.

Reference is now made to FIGS. 17A & 17B, which together are a simplified flow chart illustrating operation of systems 200, 300, 400, 500, 600, 700, 800 or 900 (FIGS. 2A-9B & 11-14) in yet another exemplary use case, and to FIGS. 17C & 17D, which together are a simplified flow chart showing a portion of the flow chart of FIGS. 17A & 17B. For the sake of conciseness, systems 200, 300, 400, 500, 600, 700, 800 and/or 900 are referred to hereinafter as “system ′00.”

As seen particularly in FIG. 17A, Andy, the executive assistant to the president of XYZ University in Washington, D.C. USA, prepares a draft of a graduation speech to be delivered by Frank Stein, the president of XYZ University. The creation of the graduation speech is indicated in a Block 2102 in FIG. 17A as event 1.

In contrast to the use case of FIGS. 15A &15B and similarly to the use case of FIGS. 16A-16D, both described hereinabove, the draft prepared by Andy is a first draft of a speech and there is no earlier stored data element on the enterprise server of XYZ University and no corresponding stored data representation. The enterprise server of XYZ University is an example of a client environment 250, 350, 450, 550, 650, 750, 850 or 950 of FIGS. 2A-9B & 11-14. For the sake of conciseness, client environments 250, 350, 450, 550, 650, 750, 850 and/or 950 are referred to hereinafter as “client environment ′50.”

Andy saves the draft of the graduation speech on the enterprise server of XYZ University as a stored data element 203, 303, 403, 503, 603, 703, 803 or 903 (FIGS. 2A-9B & 11-14), referred to hereinafter as “data element ′03,” and system ′00 confirms that there exists no populated data representation for data element ′03.

In contrast to the use cases of FIGS. 15A-16D, in the use case shown in FIGS. 17A-17D, system ′00 imports a stored data representation 205, 305, 405, 505, 605, 705, 805 or 905, such as a similarity-based or otherwise analogous default data representation data table, also designated as a default data representation or a pre-event data representation data table, such as a pre-event 1 data representation data table 2104 shown in FIGS. 17A & 17C. For the sake of conciseness, stored data representations 205, 305, 405, 505, 605, 705, 805 or 905, are referred to hereinafter as “stored data representation ′05” or “data representation ′05.” The default data representation data table is preferably provided by DRIG 224, 324, 424, 524, 624, 724, 824 or 924, (FIGS. 2A-9B & 11-14). Alternatively, as described hereinabove, DRIG 224, 324, 424, 524, 624, 724, 824 or 924 (FIGS. 2A-9B & 11-14) may provide a blank default data representation, similar to the non-populated data representation data table 1104 shown particularly in FIG. 16C.

As described hereinabove in detail with respect to FIGS. 2A-9B & 11-14, analogous default data representation data table 2104 corresponds to an analogous data element ′03, which may be stored in any enterprise server ′50 accessible to system ′00. For example, in a situation where data elements ′03 are arranged in a hierarchical data structure, analogous default data representation data table 2104 may be associated, for example, with data elements ′03 having a parent-child relationship or a sibling relationship with the data element ′03 affected by event 1.

As seen particularly in FIG. 17C, similarity-based or otherwise analogous data representation data table 2104 typically includes multiple sub-tables, including a Permissions Data Table 1 and a Metadata Data Table 2, indicating the name of the creator, the time of creation, the subject and typical tags. Exemplary analogous data representation data table 2104 also typically includes a Classification Rules Data Table 3, which indicates whether Content Classification rules are applicable, such as those applying to Social Security Numbers, Credit Card Numbers, Bank Account Numbers and Trade Secrets.

In the use case of FIGS. 17A-17D, Permissions Data Table 1, Metadata Data Table 2 and Classification Rules Data Table 3 in analogous default data representation data table 2104 are modified in accordance with information relevant to the newly-created draft graduation speech. The modification of Permissions Data Table 1, Metadata Data Table 2 and Classification Rules Data Table 3 occurs either automatically in accordance with enterprise policies or manually by the creator of data element ′03. As seen particularly in FIG. 17A, the creation of analogous default data representation data tables 2104 and modification thereof into a version A of data representation data table 2106 preferably both occur as part of Event 1.

Version A of data representation data table 2106 is stored as stored data representation information 208, 308, 408, 508, 608, 708, 808 or 908 (FIGS. 2A-9B & 11-14) of a data representation ′05 associated with data element ′03 of the draft graduation speech. For the sake of conciseness, stored data representation information 208, 308, 408, 508, 608, 708, 808 or 908 is referred to hereinafter as “stored data representation information ′08,” “data representation information ′08” or “information ′08.”

As seen particularly in FIG. 17C, version A of data representation data table 2106 typically includes multiple sub-tables, including a Permissions Data Table 1A containing full access permissions of Andy, Frank and a system administrator. Version A of data representation data table 2106 preferably also includes a Metadata Data Table 2A, indicating the name of the creator, Andy, the time of creation, the subject and typical tags. Version A of data representation data table 2106 also typically includes a Classification Rules Data Table 3A, which indicates that Content Classification rules, such as those applying to Social Security Numbers, Credit Card Numbers, Bank Account Numbers and Trade Secrets, are not applicable to the content 206, 306, 406, 506, 606, 706, 806 or 906 of the graduation speech. For the sake of conciseness, content 206, 306, 406, 506, 606, 706, 806 or 906 is referred to hereinafter as “content ′06.”

It is appreciated that as is typical of data elements ′03, which have both data element content ′06 and data element information 207, 307, 407, 507, 607, 707, 807 or 907, referred to hereinafter as “data element information ′07” or “information ′07,” the data element ′03 of the graduation speech has both content ′06, embodied as the text of the graduation speech, and information ′07, such as, for example, permissions, metadata, and classification rules. The stored data element ′03 created at event 1 also has a stored data representation ′05 having data element information ′08, embodied in the example of FIGS. 17A-17D as version A of data representation data table 2106, which is an example of data element information ′08 of a data representation ′05.

For the sake of conciseness, difference reporters 220, 320, 420, 520, 620, 720, 820 or 920 (FIGS. 2A-9B & 11-14) are referred to hereinafter as “difference reporter ′20.” Similarly, local data representation storage 222, 322, 422, 522, 822 and/or 922 is referred to hereinafter as “local data representation storage ′22” or “data representation storage ′22,” and collective data representation storage 625, 725, 825 and/or 925 is referred to hereinafter as “collective data representation storage ′25” or “data representation storage ′25.”

As seen particularly in FIG. 17A at a block 2108, difference reporter ′20 preferably provides an output to local data representation storage ′22 and/or data representation storage ′25 which represents a difference between data element information ′07, which is post-event 1 data element information associated with the graduation speech data element ′03, which at block 2108 is embodied as version A of data representation data table 2106, and the corresponding data representation information ′08, which is pre-event 1 version of data representation information associated with the draft graduation speech data element ′03, which at block 2108 has typically been populated with data representation information from a data element related to or similar to data element ′03, as seen in data representation data table 2104.

The remainder of the use case of FIGS. 17A-17D may be identical to the use cases described hereinabove with reference to FIGS. 15A-16D, with corresponding changed indications of blocks, events and differences. For clarity, the full use case of FIGS. 17A-17D is illustrated in FIGS. 17A-17D and is described below.

As seen particularly in FIG. 17A, subsequent to event 1, Andy accesses the prepared draft of the graduation speech and in the graduation speech content ′06, updates only the date of the graduation. In the graduation speech information ′07, Andy adds access permissions to John Smith, a newly appointed Vice President of Alumni Affairs at XYZ University. These actions are indicated in a Block 2112 in FIG. 17A as event 2.

The actions of event 2 change stored data element ′03 of the graduation speech into a first changed data element ′03 of the graduation speech, including updated data element content ′06 and updated data element information ′07. Subsequently, as described further hereinbelow, system ′00 is operative to update data representation ′05 corresponding to data element ′03 by updating data representation information ′08 with first changed data representation information ′08, such as a corresponding first changed data representation data table, appearing in FIGS. 17A, 17B & 17C as a version B of data representation data table 2114. As can be seen by comparing version B of data representation data table 2114 with version A of data representation data table 2106, the only change between version A and version B of the data representation data table is the addition of full access permissions to John Smith.

In accordance with a preferred embodiment of the present invention, illustrated in FIGS. 2A-9B & 11-14, difference reporter ′20 provides an output to data representation storage ′22 and/or ′25 which represents the difference between data element information ′07, which is post-event data element information, and corresponding data representation information ′08, which is pre-event data representation information, for each data element ′03 having an event notification 217, 317, 417, 517, 617, 717, 817 or 917 (hereinafter “event notification ′17”) associated therewith. The difference between post-event 2 data element information ′07 and corresponding pre-event 2 data representation information ′08 for the first changed data element ′03 is indicated in a block 2116 in FIG. 17A. It is appreciated that difference generator ′20 generates the data in block 2116 from a comparison of pre-event 2 data representation information ′08 for the first changed data element ′03, which is embodied as version A of data representation data table 2106, and post-event 2 data element information ′07 for the first changed data element ′03, which is embodied as version B of data representation data table 2114.

As seen in block 2116, the difference communicated to data representation storage ′22 and/or ′25 represents only the change between data representation data tables 2114 and 2106, namely the addition of full access permissions to John Smith.

As seen particularly in FIG. 17B, John Smith subsequently adds to Andy's draft an appeal for donations to XYZ University and adds, to the content ′06 of the graduation speech, a Bank Account Number for receiving donations. He also adds a tag “best speech ever.” He saves this draft on the enterprise server. These actions are indicated in a Block 2122 in FIG. 17B as event 3.

The actions of event 3 change stored data element ′03 of the graduation speech into a second changed data element ′03 of the graduation speech, including updated data element content ′06 and updated data element information ′07. Subsequently, as described further hereinbelow, system 100 is operative to update data representation ′05 corresponding to data element ′03 by updating data representation information ′08 with second changed data representation information ′08, such as a corresponding second changed data representation data table, appearing in FIGS. 17B & 17D as a version C of data representation data table 2124. As can be seen by comparing version C of data representation data table 2124 with version B of data representation data table 2114, the addition of a bank account number to the content ′06 of the graduation speech invokes an applicability of a bank account number classification rule, changing information ′07 associated with the graduation speech. As can be seen by comparing version C of data representation data table 2124 with version B of data representation data table 2114, the only changes between version B and version C of the data representation data tables are the addition of a metadata tag and an indication of applicability of the bank account number classification rule.

In accordance with a preferred embodiment of the present invention, illustrated in FIGS. 2A-9B & 11-14, difference reporter ′20 provides an output to data representation storage ′22 and/or ′25 which represents the difference between data element information ′07, which is post-event data element information, and corresponding data representation information ′08, which is pre-event data representation information, for each data element ′03 having an event notification ′17 associated therewith. The difference between post-event 3 data element information ′07 and corresponding pre-event 3 data representation information ′08 for the second changed data element ′03 is indicated in a block 2126 in FIG. 17B. It is appreciated that difference generator ′20 generates the data in block 2126 from a comparison of pre-event 3 data representation information ′08 for the second changed data element ′03, which is embodied as version B of data representation data table 2114, and post-event 3 data element information ′07 for the second changed data element ′03, which is embodied as version C of data representation data table 2124.

As seen in block 2126, the difference communicated to data representation storage ′22 and/or ′25 represents only the change between data representation data tables 2114 and 2124, namely the addition of a metadata tag and an indication of applicability of the bank account number classification rule.

Frank Stein subsequently reviews John Smith's additions to Andy's draft and removes the appeal for donations to XYZ University and removes the bank account number for receiving donations. He also removes all access permissions to John Smith and adds read-only access permissions to his personal assistant Rachel Green. Frank Stein saves his draft on the enterprise server. These actions are indicated in a Block 2132 in FIG. 17B as event 4.

The actions of event 4 change stored data element ′03 into a third changed data element ′03, including updated data element content ′06 and updated data element information ′07. Subsequently, as described further hereinbelow, system ′00 is operative to update data representation ′05 corresponding to data element ′03 by updating data representation information ′08 with third changed data representation information ′08, having a corresponding third changed data representation data table, appearing in FIGS. 17B & 17D as a version D of data representation data table 2134. As can be seen by comparing version D of data representation data table 2134 with version C of data representation data table 2124, the removal of the bank account number revokes applicability of the bank account number classification rule. The only changes in the data representation data table between version C and version D are the removal of John Smith's access permissions, the addition of read-only access permissions for Rachel Green and an indication of non-applicability of the bank account number classification rule.

In accordance with a preferred embodiment of the present invention, illustrated in FIGS. 2A-9B & 11-14, difference reporter ′20 provides an output to data representation storage ′22 and/or ′25 which represents the difference between data element information ′07, which is post-event data element information, and corresponding data representation information ′08, which is pre-event data representation information, for each data element ′03 having an event notification ′17 associated therewith. The differences between post-event 4 data element information ′07 and corresponding pre-event 4 data representation information ′08 for the third changed data element ′03 are indicated in a block 2136 in FIG. 17B. It is appreciated that difference generator ′20 generates the data in block 2136 from a comparison of pre-event 4 data representation information ′08 for the third changed data element ′03, which is embodied as version C of data representation data table 2124, and post-event 4 data element information ′07 for the third changed data element ′03, which is embodied as version D of data representation data table 2134.

As seen in block 2136, the differences communicated to data representation storage ′22 and/or ′25 are only the changes between data representation data tables 2124 and 2134, namely the removal of John Smith's access permissions, the addition of read-only access permissions for Rachel Green and an indication of non-applicability of the bank account number classification rule.

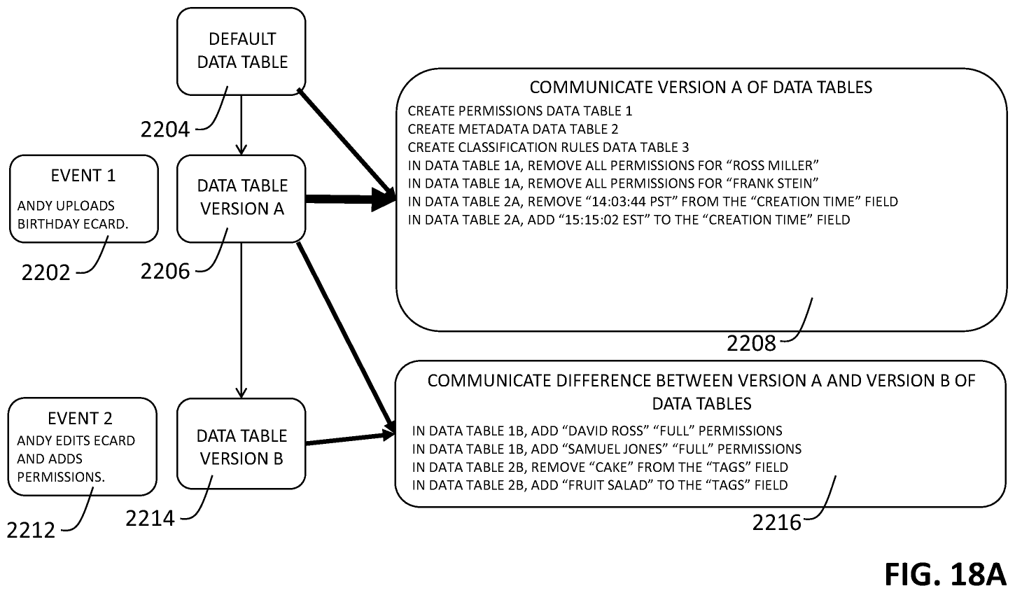

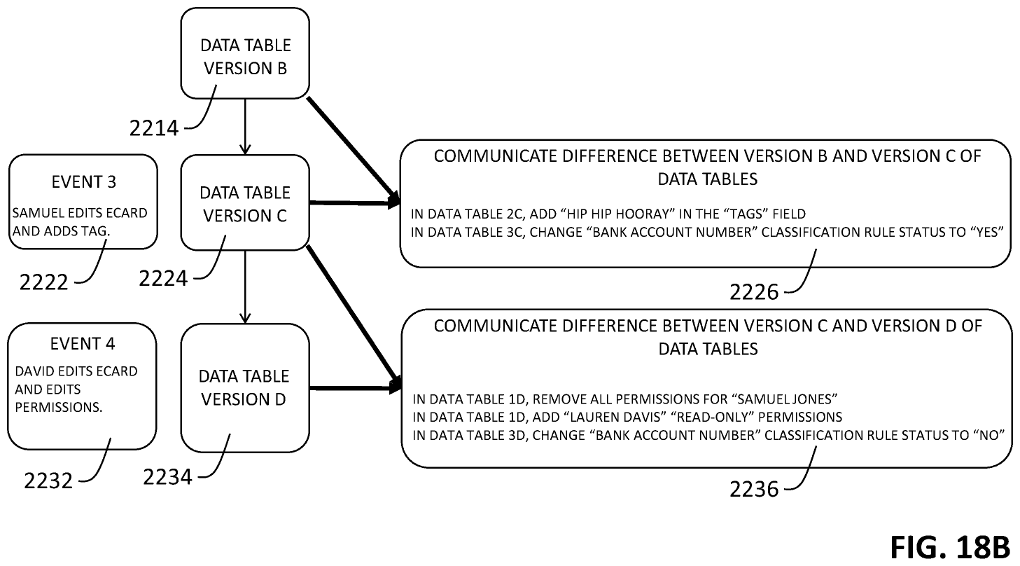

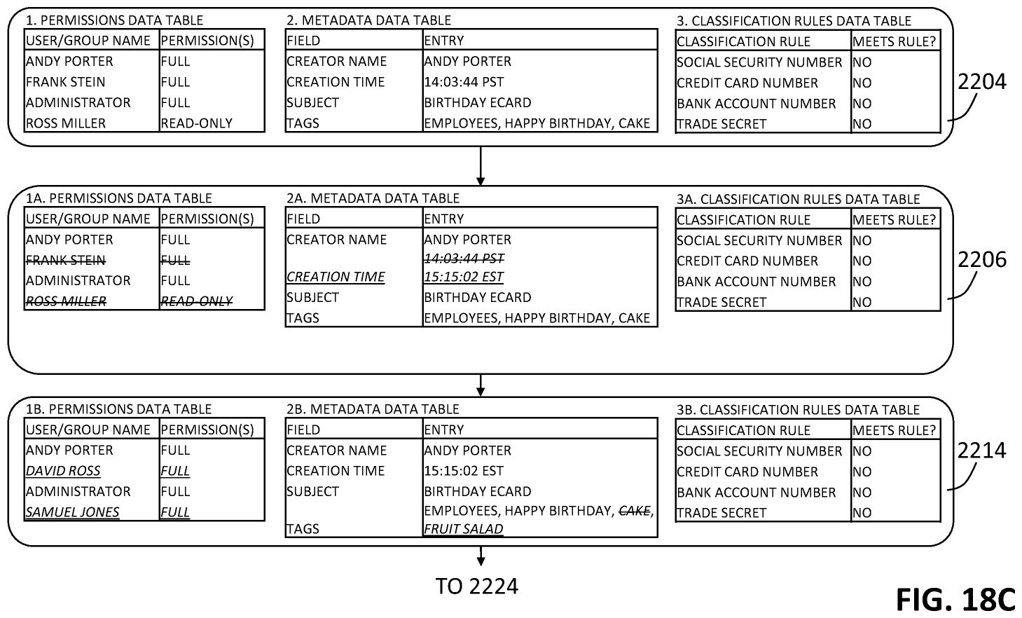

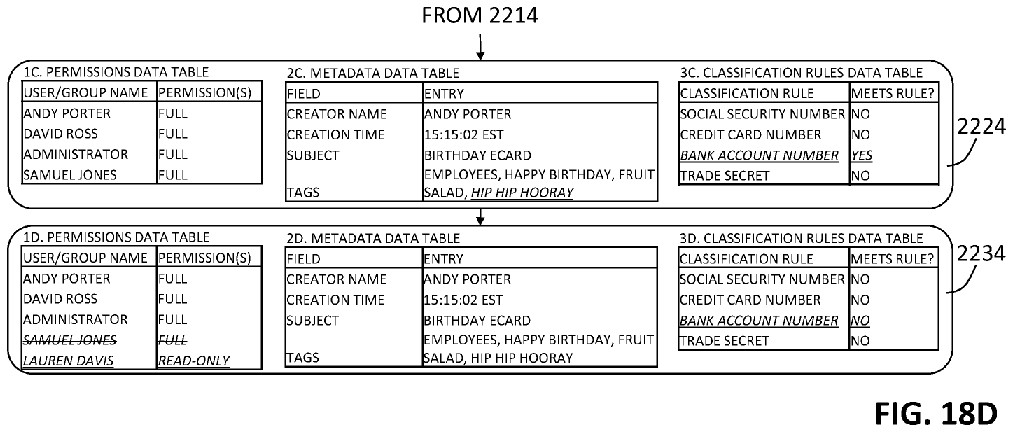

Reference is now made to FIGS. 18A & 18B, which together are a simplified flow chart illustrating operation of systems 400, 500, 600, 700, 800 or 900 (FIGS. 4A-9B & 12-14) in still another exemplary use case, and to FIGS. 18C & 18D, which together are a simplified flow chart showing a portion of the flow chart of FIGS. 18A & 18B. For the sake of conciseness, systems 400, 500, 600, 700, 800 and/or 900 are referred to hereinafter as “system X00.”

As seen particularly in FIG. 18A, Andy, the executive assistant to the president of XYZ University in Washington, D.C. USA, prepares a program to send a birthday ecard to all students of ABC University in Washington, D.C. USA on their respective birthdays, based on an already existing program used by XYZ University in Washington, D.C. USA. The creation of the birthday ecard program is indicated in a Block 2202 in FIG. 18A as event 1.

In contrast to the use case of FIGS. 15A &15B and similarly to the use cases of FIGS. 16A-17D, both described hereinabove, the ecard prepared by Andy has no earlier stored data element on the enterprise server of ABC University and no corresponding stored data representation. In contrast to the use cases of FIGS. 16A-17D, there is no stored data element on the enterprise server of ABC University that shares any similarity to Andy's birthday ecard program data element. The enterprise server of ABC University is an example of a client environment 450, 550, 650, 750, 850 or 950 of FIGS. 4A-9B & 12-14. For the sake of conciseness, client environments 450, 550, 650, 750, 850 and/or 950 are referred to hereinafter as “client environment X50.”

Andy saves the birthday ecard program on the enterprise server of ABC University as a stored data element 403, 503, 603, 703, 803 or 903 (FIGS. 4A-9B & 12-14), referred to hereinafter as “data element X03,” and system X00 confirms that there exists no populated data representation for data element X03.

In contrast to the use case of FIGS. 16A-16D and similarly to the use case of FIGS. 17A-17D, both described hereinabove, in the case shown in FIGS. 18A-18D, system X00 imports a stored data representation 405, 505, 605, 705, 805 or 905, such as a similarity-based or otherwise analogous default data representation data table, also designated as a default data representation or a pre-event data representation data table, such as a pre-event 1 data representation data table 2204 shown in FIGS. 18A & 18C. For the sake of conciseness, stored data representations 405, 505, 605, 705, 805 or 905, are referred to hereinafter as “stored data representation X05” or “data representation X05.” The default data representation data table is provided by DRIG 424, 524, 624, 724, 824 or 924, (FIGS. 4A-9B & 12-14). Alternatively, as described hereinabove, DRIG 424, 524, 624, 724, 824 or 924 (FIGS. 4A-9B & 12-14) may provide a blank default data representation, similar to the non-populated data representation data table 1104 shown in FIG. 16C.

As described hereinabove in detail with respect to FIGS. 4A-9B & 12-14, analogous default data representation data table 2204 corresponds to an analogous stored data representation X05, which may be stored in any enterprise server X50 accessible to system X00. For example, analogous data representations X05 may have the same creator or keywords as the data element X03 affected by event 1, and this similarity allows analogous data representation X05 to provide a meaningful template for analogous default data representation data table 2204 associated with data elements X03 found in enterprise server X50 accessible to system X00 but not associated with the data element X03 affected by event 1.

As seen particularly in FIG. 18C, similarity-based or otherwise analogous data representation data table 2204 typically includes multiple sub-tables, including a Permissions Data Table 1 and a Metadata Data Table 2, indicating the name of the creator, the time of creation, the subject and typical tags. Exemplary analogous data representation data table 2204 also typically includes a Classification Rules Data Table 3, which indicates whether Content Classification rules are applicable, such as those applying to Social Security Numbers, Credit Card Numbers, Bank Account Numbers and Trade Secrets.

In the use case of FIGS. 18A-18D, Permissions Data Table 1, Metadata Data Table 2 and Classification Rules Data Table 3 in analogous default data representation data table 2204 are modified in accordance with information relevant to the newly-created birthday ecard program. The modification of Permissions Data Table 1, Metadata Data Table 2 and Classification Rules Data Table 3 occurs either automatically in accordance with enterprise policies or manually by the creator of data element X03. As seen particularly in FIG. 18A, the creation of analogous default data representation data tables 2204 and modification thereof into a version A of data representation data table 2206 preferably both occur as part of Event 1.

Version A of data representation data table 2206 is stored as stored data representation information 408, 508, 608, 708, 808 or 908 (FIGS. 4A-9B & 12-14) of a data representation X05 associated with data element X03 of the birthday ecard program. For the sake of conciseness, stored data representation information 408, 508, 608, 708, 808 or 908 is referred to hereinafter as “stored data representation information X08,” “data representation information X08” or “information X08.”

As seen particularly in FIG. 18C, version A of data representation data table 2206 typically includes multiple sub-tables, including a Permissions Data Table 1A containing full access permissions of Andy and a system administrator. Version A of data representation data table 2206 preferably also includes a Metadata Data Table 2A, indicating the name of the creator, Andy, the time of creation, the subject and typical tags. Version A of data representation data table 2206 also typically includes a Classification Rules Data Table 3A, which indicates that Content Classification rules, such as those applying to Social Security Numbers, Credit Card Numbers, Bank Account Numbers and Trade Secrets, are not applicable to the content 406, 506, 606, 706, 806 or 906 of the birthday ecard program. For the sake of conciseness, content 406, 506, 606, 706, 806 or 906 is referred to hereinafter as “content X06.”

It is appreciated that as is typical of data elements X03, which have both data element content X06 and data element information 407, 507, 607, 707, 807 or 907, referred to hereinafter as “data element information X07” or “information X07,” the data element X03 of the birthday ecard program has both content X06, embodied as, inter alia, the text and graphics of the birthday ecard to be sent out by the birthday ecard program, and information X07, such as, for example, permissions, metadata, and classification rules. The stored data element X03 created at event 1 also has a stored data representation X05 having data element information X08, embodied in the example of FIGS. 18A-18D as version A of data representation data table 2206, which is an example of data element information X08 of a data representation X05.

For the sake of conciseness, difference reporters 420, 520, 620, 720, 820 or 920 (FIGS. 4A-9B & 12-14) are referred to hereinafter as “difference reporter X20.” Similarly, local data representation storage 422, 522, 822 and/or 922 is referred to hereinafter as “local data representation storage X22” or “data representation storage X22,” and collective data representation storage 625, 725, 825 and/or 925 is referred to hereinafter as “collective data representation storage X25” or “data representation storage X25.”

As seen particularly in FIG. 18A at a block 2208, difference reporter X20 preferably provides an output to local data representation storage X22 and/or data representation storage X25 which represents a difference between data element information X07, which is post-event 1 data element information associated with the birthday ecard program data element X03, which at block 2208 is embodied as version A of data representation data table 2206, and the corresponding data representation information X08, which is pre-event 1 version of data representation information associated with the birthday ecard program data element X03, which at block 2208 has typically been populated with data representation information from a data element related to or similar to data element X03.

The remainder of the use case of FIGS. 18A-18D may be structurally almost identical to the use cases described hereinabove with reference to FIGS. 15A-17D, though the steps in the use case of FIGS. 18A-18D contain different events and details than the use cases of FIGS. 15A-17D. For clarity, the full use case of FIGS. 18A-18D is illustrated in FIGS. 18A-18D and is described below.

As seen particularly in FIG. 18A, subsequent to event 1, Andy accesses the prepared birthday ecard program and in the birthday ecard program information X07 adds access permissions to David Ross and Samuel Jones, newly appointed Vice Presidents of Alumni Affairs at ABC University. In the birthday ecard program content X06, Andy updates the design and the tags of the ecard. Andy changes an image of a cake to an image of a fruit salad in the design and changes the tag “CAKE” to “FRUIT SALAD”. These actions are indicated in a Block 2212 in FIG. 18A as event 2.

The actions of event 2 change stored data element X03 of the birthday ecard program into a first changed data element X03 of the birthday ecard program, including updated data element content X06 and updated data element information X07. Subsequently, as described further hereinbelow, system X00 is operative to update data representation X05 corresponding to data element X03 by updating data representation information X08 with first changed data representation information X08, such as a corresponding first changed data representation data table, appearing in FIGS. 18A, 18B & 18C as a version B of data representation data table 2214. As can be seen by comparing version B of data representation data table 2214 with version A of data representation data table 2206, the only changes between version A and version B of the data representation data table are the addition of full access permissions to David Ross and Samuel Jones and replacing the tag “CAKE” with the tag “FRUIT SALAD.”

In accordance with a preferred embodiment of the present invention, illustrated in FIGS. 4A-9B & 12-14, difference reporter X20 provides an output to data representation storage X22 and/or X25 which represents the difference between data element information X07, which is post-event data element information, and corresponding data representation information X08, which is pre-event data representation information, for each data element X03 having an event notification 417, 517, 617, 717, 817 or 917 (hereinafter “event notification X17”) associated therewith. The difference between post-event 2 data element information X07 and corresponding pre-event 2 data representation information X08 for the first changed data element X03 is indicated in a block 2216 in FIG. 18A. It is appreciated that difference generator X20 generates the data in block 2216 from a comparison of pre-event 2 data representation information X08 for the first changed data element X03, which is embodied as version A of data representation data table 2206, and post-event 2 data element information X07 for the first changed data element X03, which is embodied as version B of data representation data table 2214.

As seen in block 2216, the difference communicated to data representation storage X22 and/or X25 represents only the change between data representation data tables 2214 and 2206, namely the addition of full access permissions to David Ross and Samuel Jones, the removal of a tag “CAKE” and the addition of a tag “FRUIT SALAD.”

As seen particularly in FIG. 18B, Samuel Jones subsequently adds to Andy's ecard an appeal for donations to ABC University and adds, to the content X06 of the birthday ecard program, a Bank Account Number for receiving donations. He also adds a tag “HIP HIP HOORAY.” Samuel Jones saves this draft on the enterprise server. These actions are indicated in a Block 2222 in FIG. 18B as event 3.

The actions of event 3 change stored data element X03 of the birthday ecard program into a second changed data element X03 of the birthday ecard program, including updated data element content X06 and updated data element information X07. Subsequently, as described further hereinbelow, system X00 is operative to update data representation X05 corresponding to data element X03 by updating data representation information X08 with second changed data representation information X08, such as a corresponding second changed data representation data table, appearing in FIGS. 18A & 18B as a version C of data representation data table 2224. As can be seen by comparing version C of data representation data table 2224 with version B of data representation data table 2214, the addition of a bank account number to the content X06 of the birthday ecard program invokes an applicability of a bank account number classification rule, changing information X07 associated with the birthday ecard program. As can be seen by comparing version C of data representation data table 2224 with version B of data representation data table 2214, the only changes between version B and version C of the data representation data tables are the addition of a metadata tag and an indication of applicability of the bank account number classification rule.

In accordance with a preferred embodiment of the present invention, illustrated in FIGS. 4A-9B & 12-14, difference reporter X20 provides an output to data representation storage X22 and/or X25 which represents the difference between data element information X07, which is post-event data element information, and corresponding data representation information X08, which is pre-event data representation information, for each data element X03 having an event notification X17 associated therewith. The difference between post-event 3 data element information X07 and corresponding pre-event 3 data representation information X08 for the second changed data element X03 is indicated in a block 2226 in FIG. 18B. It is appreciated that difference generator X20 generates the data in block 2226 from a comparison of pre-event 3 data representation information X08 for the second changed data element X03, which is embodied as version B of data representation data table 2214, and post-event 3 data element information X07 for the second changed data element X03, which is embodied as version C of data representation data table 2224.

As seen in block 2226, the difference communicated to data representation storage X22 and/or X25 represents only the change between data representation data tables 2214 and 2224, namely the addition of a metadata tag and an indication of applicability of the bank account number classification rule.

David Ross subsequently reviews Samuel Jones's additions to Andy's program and removes the appeal for donations to ABC University and removes the bank account number for receiving donations. He also removes all access permissions to Samuel Jones and adds read-only access permissions to his personal assistant Lauren Davis. David Ross saves his draft on the enterprise server. These actions are indicated in a Block 2232 in FIG. 18B as event 4.

The actions of event 4 change stored data element X03 into a third changed data element X03, including updated data element content X06 and updated data element information X07. Subsequently, as described further hereinbelow, system X00 is operative to update data representation X05 corresponding to data element X03 by updating data representation information X08 with third changed data representation information X08, having a corresponding third changed data representation data table, appearing in FIGS. 18B & 18D as a version D of data representation data table 2234. As can be seen by comparing version D of data representation data table 2234 with version C of data representation data table 2224, the removal of the bank account number revokes applicability of the bank account number classification rule. The only changes in the data representation data table between version C and version D are the removal of Samuel Jones's access permissions, the addition of read-only access permissions for Lauren Davis and an indication of non-applicability of the bank account number classification rule.

In accordance with a preferred embodiment of the present invention, illustrated in FIGS. 4A-9B & 12-14, difference reporter X20 provides an output to data representation storage X22 and/or X25 which represents the difference between data element information X07, which is post-event data element information, and corresponding data representation information X08, which is pre-event data representation information, for each data element X03 having an event notification X17 associated therewith. The differences between post-event 4 data element information X07 and corresponding pre-event 4 data representation information X08 for the third changed data element X03 are indicated in a block 2236 in FIG. 18B. It is appreciated that difference generator X20 generates the data in block 2236 from a comparison of pre-event 4 data representation information X08 for the third changed data element X03, which is embodied as version C of data representation data table 2224, and post-event 4 data element information X07 for the third changed data element X03, which is embodied as version D of data representation data table 2234.

As seen in block 2236, the differences communicated to data representation storage X22 and/or X25 are only the changes between data representation data tables 2224 and 2234, namely the removal of Samuel Jones's access permissions, the addition of read-only access permissions for Lauren Davis and an indication of non-applicability of the bank account number classification rule.

It will be appreciated by persons skilled in the art that the present invention is not limited to what has been particularly shown and described hereinabove. The scope of the present invention includes both combinations and subcombinations of various features described hereinabove as well as modifications thereof, all of which are not in the prior art.

1. A system for monitoring data elements comprising:
a data element monitor (DEM), monitoring a multiplicity of data elements, some of which having associated therewith a data representation, each of said multiplicity of data elements comprising data element content and data element information, and each of said data representations comprising data representation information corresponding to at least a subset of said data element information;
an event notification ascertainer (ENA), ascertaining which of said multiplicity of said data elements being monitored has an event notification associated therewith; and
a difference reporter, reporting a difference between said data representation information in a data representation associated with one of said multiplicity of data elements being monitored, which has an event notification associated therewith, and corresponding data element information of that one of said multiplicity of said data elements being monitored.

2. A system for monitoring data elements according to claim 1 and wherein:
said difference reporter is also operative for updating said data representation information associated with said one of said multiplicity of data elements being monitored, which has an event notification associated therewith, to reflect said difference.

3-4. (canceled)

5. A system for monitoring data elements according to claim 1 and wherein:
said data representation information associated with one of said multiplicity of data elements being monitored, which has an event notification associated therewith, is associated with said one of said multiplicity of data elements prior to said event notification.

6. A system for monitoring data elements according to claim 1 and wherein:
said data representation information associated with one of said multiplicity of data elements being monitored, which has an event notification associated therewith, is associated with said one of said multiplicity of data elements subsequent to said event notification, and is generated based on at least one data representation associated with at least one analogous data element.

7-9. (canceled)

10. A system for monitoring data elements according to claim 6 and also comprising:
a data representation information generator (DRIG) receiving at least one stored data representation of at least one data element other than that one of said multiplicity of said data elements being monitored which has an event notification associated therewith and providing pre-event data representation information to said difference reporter.

11-15. (canceled)

16. A system for monitoring data elements according to claim 1 and wherein said difference reporter comprises a classification rule applicability determiner for ascertaining whether one or more classification rules are applicable to said content of said data element being monitored, which has an event notification associated therewith.

17. A system for monitoring data elements according to claim 1 and wherein said difference reporter comprises:
a comparator, comparing said data representation information stored in said data representation associated with that one of said multiplicity of data elements being monitored, which has an event notification associated therewith, and post-event data element information of said one of said multiplicity of said data elements being monitored; and
a comparison notifier, updating said data representation information associated with that one of said multiplicity of data elements being monitored, which has an event notification associated therewith, based on said comparing, to reflect said difference.

18-19. (canceled)

20. A system for monitoring data elements according to claim 1 and wherein said event notification is a notification of at least one of:
an actual access to that one of said multiplicity of said data elements being monitored which has an event notification associated therewith;
a change in an access permission that one of said multiplicity of said data elements being monitored which has an event notification associated therewith, such as a change in at least one of a read permission, a write permission and a delete permission;
a change in said data element content of that one of said multiplicity of said data elements being monitored which has an event notification associated therewith; and
a change in data element information of that one of said multiplicity of said data elements being monitored which has an event notification associated therewith.

21-25. (canceled)

26. A system for monitoring data elements according to claim 1 and wherein:
said multiplicity of data elements comprises at least one billion data elements; and
said DEM, said ENA and said difference reporter are operative to update said multiplicity of data elements in less than one minute.

27. A system for monitoring data elements according to claim 1 and also comprising a utilization subsystem, employing information contained in updated data representations.

28. A method for monitoring data elements comprising:
monitoring a multiplicity of data elements, some of which having associated therewith a data representation, each of said multiplicity of data elements comprising data element content and data element information and each of said data representations comprising data representation information corresponding to at least a subset of said data element information;
ascertaining which of said multiplicity of said data elements being monitored has an event notification associated therewith; and
reporting a difference between said data representation information in a data representation associated with one of said multiplicity of data elements being monitored, which has an event notification associated therewith, and corresponding data element information of that one of said multiplicity of said data elements being monitored.

29. A method for monitoring data elements according to claim 28 and also comprising updating said data representation information associated with said one of said multiplicity of data elements being monitored, which has an event notification associated therewith, to reflect said difference.

30-31. (canceled)

32. A method for monitoring data elements according to claim 28 and also comprising associating said data representation information associated with one of said multiplicity of data elements being monitored, which has an event notification associated therewith, with said one of said multiplicity of data elements prior to said event notification.

33. A method for monitoring data elements according to claim 28 and also comprising:
generating said data representation information based on at least one data representation associated with at least one analogous data element; and
associating said data representation information, associated with one of said multiplicity of data elements being monitored, which has an event notification associated therewith, with said one of said multiplicity of data elements being monitored subsequent to said event notification.

34-36. (canceled)

37. A method for monitoring data elements according to claim 33 and also comprising:
receiving at least one stored data representation of at least one data element other than that one of said multiplicity of said data elements being monitored which has an event notification associated therewith and providing pre-event data representation information to be compared with post-event data element information of that one of said multiplicity of said data elements being monitored.

38-42. (canceled)

43. A method for monitoring data elements according to claim 28 and also comprising ascertaining whether one or more classification rules are applicable to said content of said data element being monitored which has an event notification associated therewith.

44. A method for monitoring data elements according to claim 28 and also comprising:
comparing said data representation information stored in said data representation associated with that one of said multiplicity of data elements being monitored, which has an event notification associated therewith, and post-event data element information of said one of said multiplicity of said data elements being monitored; and
updating said data representation information associated with that one of said multiplicity of data elements being monitored, which has an event notification associated therewith, based on said comparing, to reflect said difference.

45-46. (canceled)

47. A method for monitoring data elements according to claim 28 and wherein said event notification is a notification of at least one of:
an actual access to that one of said multiplicity of said data elements being monitored which has an event notification associated therewith;
a change in an access permission to that one of said multiplicity of said data elements being monitored which has an event notification associated therewith, such as a change in at least one of a read permission, a write permission and a delete permission;
a change in said data element content of that one of said multiplicity of said data elements being monitored which has an event notification associated therewith; and
a change in data element information of that one of said multiplicity of said data elements being monitored which has an event notification associated therewith.

48-52. (canceled)

53. A method for monitoring data elements according to claim 28 and wherein:
said multiplicity of data elements comprises at least one billion data elements; and
said method is operative to update said multiplicity of data elements in less than one minute.

54. A method for monitoring data elements according to claim 28 and also comprising utilizing information contained in updated data representations.
